(19) United States
(12) Patent Application Publication
(10) Pub. No.: US 2023/0267426 A1
(43) Pub. Date: Aug. 24, 2023

(54) PAYMENT SYSTEM, COIN REGISTER, PARTICIPANT UNIT, TRANSACTION REGISTER, MONITORING REGISTER AND METHOD FOR PAYMENT WITH ELECTRONIC COIN DATA SETS

(71) Applicant: GIESECKE+DEVRIENT ADVANCE52 GMBH, Munchen (DE)

(72) Inventors: Wolfram SEIDEMANN, Munchen (DE); Raoul-Thomas HERBORG, Worthsee (DE)

(21) Appl. No.: 18/015,028

(22) PCT Filed: Jun. 30, 2021
(86) PCT No.: PCT/EP2021/068059

§ 371 Date: Jan. 6, 2023

(30) Foreign Application Priority Data
Jul. 8, 2020 (DE) 10 2020 004 122.1

(51) Int. Cl. G06Q 20/06; G06Q 20/38

(52) U.S. Cl. CPC G06Q 20/065; G06Q 20/383

(57) ABSTRACT

A payment system is provided for making a payment using electronic coin data sets, having a coin register which is designed to register the electronic coin data sets; participating units which are designed to carry out payment transactions by transmitting the electronic coin data sets and to transmit status and registration requests relating to the electronic coin data sets to the coin register; and a monitoring register which is designed to analyze monitoring data sets relating to the payment transactions. A monitoring data set includes at least one register data set and at least one transaction data set in the monitoring register. The at least one register data set is provided by the coin register, and the at least one transaction data set is provided by a transaction data set source and/or the coin register.

### TECHNICAL FIELD OF THE INVENTION

The invention relates to a payment system, a coin register, a participant unit, a transaction register, a monitoring register and a method for payment with electronic coin data sets.

### TECHNICAL BACKGROUND OF THE INVENTION

Protection of privacy is an important value for society, especially when very sensitive data, such as payment information, is involved. Security of payment transactions and associated payment transaction data means both protecting the confidentiality of the data exchanged; and protecting the integrity of the data exchanged; and protecting the availability of the data exchanged.

For electronic coin data sets, it must be possible to provide proof of basic control functions, in particular (1) the detection of multiple spending methods, also known as double spending, and (2) the detection of uncovered payments. In case (1) someone tries to spend the same coin data set several times and in case (2) someone tries to spend a coin data set although he has no credit (anymore).

To illustrate case (1), FIG. 1a and FIG. 1b show a payment system in which it is possible to exchange a monetary amount in the form of electronic coin data sets C directly between terminals M in the payment system. When transmitting directly between terminals M, no central instances of the payment system, for example a coin register 2 or monitoring register, are needed. In FIG. 1a, a terminal M1 splits a coin data set Ca to obtain a coin data set C_{b}. The terminal M1 passes the coin data set C_{b} to terminals M2 and M3 simultaneously in an unauthorised manner.

In the payment system of FIG. 1a, the terminal M2 shares the coin data set C_{b} and obtains the coin data set C_{c}, which is then directly shared with the terminal M4. Terminal M4 passes the coin data set C_{c} directly to terminal M6. Terminal M6 passes the coin data set C_{c} directly to terminal M8. The unsuspecting subscriber with terminal M3 passes the coin data set C_{b} directly to terminal M5. Terminal M3 forwards coin data set C_{b} directly to terminal M5. Terminal M5 passes the coin data set C_{b} directly to terminal M7. Thus, both coin data sets C_{b} and C_{c} change hands frequently without a coin register 2 of the payment system being aware of this. If—as shown in FIG. 1b—the terminal M7 registers the coin data set C_{b} in a coin register 2 of the payment system (=switching), the coin data set C_{b} becomes invalid (shown by crossing out the coin data set) and a coin data set Ca becomes valid. Now, if the terminal M8 also wants to register the coin data set C_{c} as the coin data set Cₑ with the coin register 2, the coin register 2 determines that the coin data set C_{b} is already invalid. The attack or fraud by M1 is only now detected. As a result, the coin register 2 accepts neither the coin data set C_{c} nor the coin data set Cₑ, which could financially harm the respective owners of the terminals M7 and M8.

In addition, due to the large number of transactions of an electronic coin data set and also due to the advancing life span, the risk of manipulation(s) being carried out on the electronic coin data set increases.

In the future, it should be possible to dispense with cash (banknotes and analogue coins) altogether, or at least with analogue coins.

U.S. Pat. No. 5,872,844 A describes an electronic payment system. Electronic coin data sets (assets) are issued in the system by a central institution. The electronic coin data sets are transmitted from a payer's terminal (wallet) to a payee's terminal. The payee's terminal routinely submits the transmitted coin data sets for possible verification. A fraud detection system samples the coin data sets submitted for verification to detect “bad” coin data sets that have been used fraudulently. Upon such detection, the fraud detection system identifies the terminal that used the bad coin data set and flags them as a ‘bad terminal’. The fraud detection system compiles a list of such bad terminals and distributes the list to warn other terminals of the bad terminals. If a bad terminal subsequently attempts to issue coin data sets (whether fraudulently or not), the intended recipient will check the list of bad terminals and will not execute a payment transaction with the bad terminal.

This known system is not anonymous because a participant generates a pseudonym from an identity number that must be used both for the payment transactions to the other participant and when the electronic coin data sets are generated and issued by the Institution. The issued electronic coin data sets also necessarily contain a signature chain, which increases the storage requirement of the electronic coin data set per payment transaction, i.e. the electronic coin data set grows. Terminals that are not trustworthy are not admitted to the system at all. It is therefore the task of the present invention to create a method and a system in which a payment transaction between participants in a public payment system is designed to be secure, flexible and simple. In particular, a direct and anonymous payment between the participants of the payment system is to be created. The exchanged electronic coin data sets shall be confidential to other system participants, but allow each system participant to perform basic checks on the electronic coin data set, namely (1) detecting multiple spending attempts; (2) detecting attempts to pay with non-existent monetary amounts; and (3) detecting return criteria for already spent coin data sets, for example that an electronic coin data set is to expire.

This anonymous payment system should—especially for control purposes or when unknown anonymous participants participate—be scalably pseudonymisable or even personalisable (non-anonymous, identity- or amount-open) to ensure that this public payment system is not abused.

Anonymous participants or non-trusted participants should therefore be allowed to participate in the payment system without jeopardising security. An electronic coin data set should always consume the same amount of storage space regardless of its age or the transactions associated with it.

### SUMMARY OF THE INVENTION

The problem is solved in particular by a payment system for payment with electronic coin data sets. The payment system has a coin register which is arranged for registering the electronic coin data sets. The payment system further comprises participant units arranged for executing payment transactions by transmitting the electronic coin data sets and sending status and registration requests concerning the electronic coin data sets to the coin register. The payment system also has a monitoring register arranged to evaluate monitoring data sets relating to the payment transactions. A monitoring data set is thereby formed in the monitoring register from at least one register data set and at least one transaction data set, wherein the at least one register data set is provided by the coin register and wherein the at least one transaction data set is provided by a transaction data set source and/or the coin register.

Thus, a three-layer system architecture for a payment system is proposed. These three layers comprise an anonymous direct transaction layer (=first layer, payment transaction layer), in which the participant units transmit (exchange) electronic coin data sets among themselves. These three layers comprise a registration layer (=second layer, verification layer) consisting of a coin register and a monitoring register, in which the status and validity regarding the electronic coin data sets are registered in a verifiable manner for each participant. These three layers comprise a verification layer (=third layer, audit layer), consisting of the coin register and a transaction register, which is used under certain (system) conditions or when certain participant units (in particular anonymous participant units) participate or according to predefined patterns/parameters.

Through this three-layer structure, a paradox—namely obtaining anonymity and at the same time maintaining trustworthiness—can be resolved. The respective payment transaction thus continues to be fundamentally anonymous in an advantageous manner, but can be scalably pseudonymous or even personalised through corresponding parameterisation of a corresponding register data set or a transaction data set. This increases participant acceptance, as the freedom to pay directly, i.e. without a checking instance, is taken into account and at the same time fulfils the trustworthiness requirement of an issuing instance, a central bank or a commercial bank, namely to ensure that the payment system is not abused.

An electronic coin data set is in particular an electronic data set that represents a monetary amount and is also colloquially referred to as a “digital coin” or “electronic coin”. This monetary amount can change from a first terminal to another terminal in the method. In the following, a monetary amount (asset) is understood as a digital amount that can be credited to an account of a financial institution, for example, or can be exchanged for another means of payment. An electronic coin data set thus represents cash in electronic form.

An electronic coin data set for transmitting monetary amounts differs substantially from the electronic data set for data exchange or data transmission, for example a register data set or a transaction data set, since a classical data transaction takes place, for example, on the basis of a question-answer principle or on an intercommunication between the data transmission partners, for example the participant unit and one of the register instances (coin register, monitoring register, transaction register). In the course of authentication, identification data can be exchanged which can lead to conclusions about a participant identifier and/or an identification number of a natural person as a user (participant) of the payment system. This means that anonymous payment is not possible. In contrast, an electronic coin data set is anonymous, unique and unambiguous and is used in the context of a security concept. In principle, an electronic coin data set contains all the data elements needed for a receiving instance. In contrast to the copying of electronic data sets, i.e. the duplication of digital data, a valid electronic coin data set may only exist once in the payment system. This system requirement must be observed in particular when transmitting electronic coin data sets.

In an advantageous embodiment, the electronic coin data set has as a data element a monetary amount, i.e. a date representing a monetary value of the electronic coin data set, and as a data element an obfuscation amount, for example a random number. The obfuscation amount is only known in the first layer. The obfuscation amount is not known to any of the payment system instances in the second or third layer, for example one of the registers, such as coin register, monitoring register, transaction register, person register, except for the issuing instance. The obfuscation amount is—except in the first layer (direct transaction layer)—a secret data element. The obfuscation amount is secret for the coin register and the monitoring register. An electronic coin data set is uniquely represented by these at least two data elements (monetary amount, obfuscation amount). Anyone accessing these data elements of an electronic coin data set can use this electronic coin data set for payment in a payment transaction. Knowing these two data elements (monetary amount, obfuscation amount) is therefore equivalent to owning the digital money. This electronic coin data set can be transmitted directly between two participant units. Only the transmitting of the monetary amount and the obfuscation amount is necessary to exchange digital money (=payment transaction).

In one embodiment, each electronic coin data set also has at least one check value as a data element, so that it then consists of at least three data (monetary amount, obfuscation amount, check value). The check value is incremented when transmitting the electronic coin data set directly between two participant units. The function of the check value of the electronic coin data set is explained later. In addition, a status (valid/non-valid) of an electronic coin data set may be present as a data element in the electronic coin data set. In one embodiment, the status may not be attached to the electronic coin data set and, in this embodiment, is known and maintained only by the participant unit (security element) itself and/or the coin register.

In one embodiment, each electronic coin data set may have a coin identifier as a data element, the coin identifier preferably being used to identify a register data set relating to the electronic coin data set and a transaction data set relating to the electronic coin data set. A coin identifier, similar to a transaction identifier in the transaction data set, is a data element for uniquely associating the electronic coin data set in the payment system. This coin identifier is preferably a random number. The coin identifier (if traceable) provides information about the life cycle of an electronic coin data set.

In addition, the electronic coin data set may have other data elements, such as which currency the monetary amount represents, by which issuing instance it was generated and/or a signature of an issuing instance.

In order to make a transmission protocol secure, the electronic coin data sets are managed by respective participant units, for example by security elements integrated therein, and are also transmitted by them. In a preferred embodiment, the security element is inserted into the participant unit ready for use. In this case, the participant unit can contain an application through which a user (=participant) controls a payment process and accesses electronic coin data sets of the security element in this payment process.

The participant unit can be, for example, a mobile terminal such as a smartphone, a tablet computer, a computer, a server or a machine. A transmitting of the electronic coin data set from the (first) security element of a first participant unit takes place, for example, to the (second) security element of another participant unit. A participant unit-to participant unit transmission path can be set up, via which, for example, a secure channel is set up between the two security elements, via which the transmitting of the electronic coin data set then takes place. An application (installed) inserted on the participant unit ready for use can initiating and controlling the transmitting of the coin data set by using input and/or output means of the respective participant unit. For example, electronic coin data set amounts can be displayed and the transmission process can be monitored.

A transaction data set source—as part of the third layer—is a data source that provides transaction data sets. The transaction data set comprises the information needed to uniquely identify the transmission of the coin data set between two participant units of the payment system in the totality of the transmissions (payment transactions). The transaction data set comprises, in particular, the participant units participating in the transmitting and information regarding the coin data set to be transmitted. With a transaction data set, the transmitting of the electronic coin data set can be reconstructed unambiguously or at least pseudonymised with respect to the participating participant units.

In one embodiment, this transaction data source may be a participant unit, in particular a participant unit transmitting or sending the coin data set. In this embodiment, the participant unit creates the transaction data set and provides it—as a transaction data source—to the monitoring register. A communication channel between the participant unit and the coin register can also be used; the communication between the participant unit and the monitoring instance is preferably cryptographically secured and cannot be viewed by any intermediate instances (such as the coin register).

In one embodiment, this transaction data source may be a transaction register, preferably a transaction register of the payment system. This transaction register preferably provides the transaction data set provided by a participant unit, in particular a participant unit sending or that transmitted the electronic coin data set, to the transaction register, in particular in a modified anonymity level, for example as an anonymised and/or pseudonymised transaction data set.

The initial generating of a transaction data set can also take place here in a participant unit. This transaction data set can be changed in its anonymity level by means of a transaction register and is provided by the transaction register—as the transaction data set source—to the monitoring register. An explanation of the anonymity level and how it is set or changed is given later. In this embodiment, the transaction register modifies the transaction data set generated by the participant unit and provides it—as the transaction data set source—to the monitoring register. A communication channel between a participant unit and the coin register can be used. In this embodiment, the communication for transmitting the transaction data set between the transaction register and the monitoring register is preferably cryptographically secured and cannot be viewed or verified by any intervening instances, for example a coin register or a participant unit.

In certain circumstances, it may be desirable to further restrict privacy according to a proper method, for example if criminal activity is suspected or high privacy is desired by the user. This participant (=user) should not be denied access to this payment system. In one embodiment of the method, access to confidential information is allowed to a defined (determined) group of persons, in particular law enforcement authorities in law enforcement, in order to prevent or prosecute crimes. In order to secure legitimate access, a complex encryption procedure can be applied. The transaction data generated in the participant unit is immediately encrypted with a cryptographic key after generation. This key is composed of several partial keys from remote instances. In order to be able to decrypt the encrypted transaction data set so that it is evaluable by the monitoring register, several (at least two) partial keys from different remote instances are necessary. This further preserves the confidentiality and also the data integrity of the payment system.

In the following description, the communication process with transaction and/or register data sets (=sending) is conceptually separated from the communication process with coin data sets (transmitting). A transaction data set preferably originates in and is generated by one of the participant units. Further processes, such as adjusting an anonymity level, are then performed by a transaction register. A register data set preferably originates from and is generated by one of the participant units or the coin register. Further processes, such as adjusting an anonymity level, are then performed by, for example, the coin register.

In an alternative embodiment, the transaction data sets and/or the register data sets are not generated by the participant unit. In this case, communications between the participant units and the associated status and/or registration requests are logged and/or evaluated by the transaction register (in the case of a transaction data set) and/or the coin register (in the case of a register data set) and used to generate and provide the respective transaction data set and/or register data set.

An electronic coin data set, unlike a transaction data set and/or a register data set, cannot be generated by a participant unit or the transaction register or the coin register or the monitoring register. The generating of an electronic coin data set (and also its destruction or deletion) is done by an issuing instance of the payment system, preferably exclusively by the issuing instance of the payment system.

In a preferred embodiment, the transaction data set has at least one participant identifier or address of a first participant unit (=sender), i.e. a data element with which this security element can be uniquely identified in the payment system. In addition, the transaction data set has at least one participant identifier or address of a second participant unit (=receiver), i.e. a data element with which this security element can be uniquely identified in the payment system. In addition, the transaction data set has, for example, a monetary amount of the electronic coin data set.

In a further preferred embodiment, the transaction data set has a transaction number as a data element. This transaction number is, for example, a random number generated before the generating step. Preferably, a random number generator of the participant unit or the security element is used for this purpose. Alternatively or additionally, the transaction number is an identification number of the transaction that is unique to the transmitting participant unit. Additionally, the transaction number may be an identification of the transaction in the payment system.

In a further preferred embodiment, the transaction data set further comprises a masked electronic coin data set corresponding to the electronic coin data set to be transmitted, preferably in place of the monetary amount of the electronic coin data set or in place of the electronic coin data set. Masking is explained later. The non-introduction of the electronic coin data set enables the retention of two system requirements, namely firstly that the electronic coin data set is only present once in the system (and is precisely not present in copy in the transaction data set), and secondly that possession of the electronic coin data set entitles the holder to payment, i.e. a transaction data set which has not yet been encrypted (if necessary transmitted to the second participant unit) or a decrypted transaction data set would contain electronic coin data sets potentially usable for payment transactions, thus increasing the risk of fraud.

In a further preferred embodiment, the transaction data set has a transaction time. For this purpose, a timestamp is generated and appended to the transaction data set. The timestamp is preferably unique throughout the payment system.

In a preferred embodiment, the participant unit appends a transaction time to the encrypted transaction data set (in plain text), for example as a metadate. Thus, this transaction time can be in the transaction register as an input parameter for calculating a deletion time of the encrypted transaction data set. For example, in the context of data retention, the encrypted transaction data set could be automatically deleted from a transaction register after a set storage time, for example X months or Y years, has elapsed. This is advantageous in the case that the transaction data set is temporally transmitted to the transaction register much later after the coin data set has been transmitted, in order not to prolong the storage (possibly in an illegal way).

A participant identifier or the transaction number of the transaction data set could also be appended in plain text as a further metadata.

In a further preferred embodiment, the transaction data set has an acknowledgement of receipt from the second participant unit. The receipt serves as proof or acknowledgement of proper receiving of the electronic coin data set in the second participant unit, and possession of the receipt in the first participant unit proves proper transmitting of the electronic coin data set.

This transaction data set initially contradicts the desire for anonymity for the payment transactions of the payment system. In one embodiment, the transaction data set is therefore encrypted in the participant unit. Encrypting the transaction data set is preferably done immediately after generating it, more preferably generating and encrypting is done as one atomic operation. Encrypting is done with a cryptographic key. This means that the transaction data set cannot be viewed by an uninvolved third party and its content is hidden from this uninvolved third party. This ensures that an attack on the participant identity module to spy out unencrypted transaction data is unsuccessful.

This cryptographic key is composed of at least two partial keys. Each partial key originates from a (single) remote instance. The remote instances are independent of each other. A remote instance has knowledge and possession of only one (own) partial key. In particular, a remote instance has no knowledge of and is not in possession of a partial key of another remote instance. Composing the cryptographic key also includes deriving a public key part of a PKI key infrastructure to be used for encrypting, which may have been generated using a composed private key part.

By remote instance is meant here that this instance is not a (local) instance of a participant unit. The remote instance is preferably not the coin register of the payment system, not the transaction register of the payment system and also not the monitoring register of the payment system, so that in order to maintain anonymity and neutrality in the payment system, an independence the register instances of the payment system cannot decrypt the encrypted transaction data set or cannot contribute a partial key for decrypting.

This means that the transaction data set can preferably be stored in encrypted form in a trusted location, the transaction register. As a result of a court ruling, this encrypted transaction data set can be decrypted by authorised parties as the remote instances. These authorised parties could be, for example, a law enforcement agency, a notary public, the Ministry of Justice, a central bank, a payment process issuing instance, a judicial body or others.

In a preferred embodiment, the cryptographic partial keys are each from a law enforcement instance; a notary instance; a ministry of justice instance; a central issuing instance of the payment system; or a commercial bank instance of the payment system.

In a preferred embodiment, the cryptographic key for encrypting the transaction data set is a public key part of an asymmetric key infrastructure (Public-Key-Infrastructure, abbreviated PKI), whereby the corresponding private key part for decrypting the encrypted transaction data set is composed by an addition operation or a bitwise XOR operation from all cryptographic key parts of the different remote instances.

In a preferred embodiment, the cryptographic key for encrypting the transaction data set is a public key part of an asymmetric key infrastructure (PKI), wherein the corresponding private key part for decrypting the encrypted transaction data set is composed of a predefined number of cryptographic partial keys of different remote instances, said predefined number being less than the total number of different remote instances having a partial key.

All remote instances have only one partial key of the decrypting key each, i.e. all remote instances or a subset of the remote instances are always required to jointly decrypt the encrypted transaction data set. This improves security against misuse, as multiple instances are needed to perform a data access, which is a significant extra effort in an attack scenario.

The partial keys are combined into a common (private) decryption key. This combining is done, for example, in the transaction register. Alternatively, the combining is done in the first participant unit. This combining is done, for example, by addition or by bitwise XORing, which no remote instance can obtain on its own in mere knowledge of the partial key(s). This shared (private) decryption key is then used to decrypt the encrypted transaction data set.

The corresponding public key part of this common private decryption key is used in the first participant unit for encrypting the generated transaction data set. For this purpose, this public key part is preferably sent from the transaction register to the participant unit and received there.

In an alternative embodiment, the cryptographic key for encrypting is a symmetric key, whereby the corresponding private key part for decrypting the transaction data set is composed of at least two cryptographic key parts by an addition operation or a bitwise XOR operation.

This key concept guarantees that no remote instance could bypass all others to decrypt data on its own. In one embodiment, threshold cryptography is used to allow that not all remote instances necessarily have to contribute their partial key, but that a subset of the instances is sufficient to compose the decryption key. The rule is that at least the number of the subset must contribute their respective partial key. If the subset is smaller than a predefined minimum number of remote instances, decryption is not possible.

The encryption methods described here are transparent to ensure user acceptance.

The (encrypted) transaction data set is sent to a transaction register. A common communication protocol, such as TCP/IP or a mobile communication, can be used. In the case of a security element as generating instance of the transaction data set, for example, a proactive command is sent to the participant unit.

The transaction register is preferably an instance of the payment system and is used to archive the (encrypted) transaction data set. This (encrypted) transaction data set can be decrypted there, in particular after a request by the authorities, for example by means of composed (combined) partial keys of the remote instances, and subsequently viewed by the requesting instance (judicial authority, etc.). An inspection for control purposes of each transmitted electronic coin data set in the payment system and/or of each register data set, for example of a modification to be registered or of a registered modification of an electronic coin data set in the payment system, is thus possible, but can only be technically implemented under very strict conditions if complex encryption is used.

The official request, for example a court order, contains a participant unit identifier and queries all transaction data sets of this identifier within a determining time period or at a determining time. The transaction data set metadata then facilitates the response to this request to the transaction register.

The transaction register can be, for example, a non-public database of the payment system. The encrypted transaction data sets are stored in this database—for possible later verification. The transaction register is designed, for example, as a centrally managed database in the form of a data memory or service server of the payment system.

In a preferred embodiment, a security element is inserted in a participant unit ready for use. This ensures that the transaction data sets are generated and encrypted without manipulation and, if necessary, also sent. In one embodiment, the transaction data set is created in the security element and then encrypted by the participant unit.

A security element is a technical resource-constrained device. For example, a security element is a special computer program product, in particular in the form of a secured runtime environment within an operating system of a terminal, Trusted Execution Environments, TEE, or eSIM software, stored on a data memory, for example a participant unit, such as a (mobile) terminal, a machine or an ATM. Alternatively or additionally, the security element is designed, for example, as special hardware, in particular in the form of a secure hardware platform module, Trusted Platform Module, TPM, or as a smart card or an embedded security module, eUICC, eSIM. The security element provides a trusted environment and thus has a higher level of trust than a terminal in which the security element may be integrated ready for use.

The transmitting of an electronic coin data set is preferably done between two security elements to create a trusted environment. In this case, the logical transmission of the electronic coin data set is direct, whereas a physical transmission may involve one or more intermediate instances, for example one or more participant units to make the security element(s) operational and/or a remote data storage service where a wallet application containing electronic coin data sets is physically stored.

Security elements can transmit electronic coin data sets between each other and then re-use them directly—without register check(s)—especially if the payment system assumes that electronic coin data sets of security elements are per se considered valid.

One or more electronic coin data sets may be securely stored in a participant unit or security element, for example, a plurality of electronic coin data sets may be securely stored in a data memory exclusively associated with a participant unit or security element. The data memory then represents, for example, an electronic purse application. This data memory can, for example, be internal, external or virtual to the security element.

The first security element could also have obtained electronic coin data sets from less trusted instances, such as participant units, i.e. a terminal or a machine, for example via an import/export function of the security element. Such obtained electronic coin data sets that were not obtained directly from another security element are considered less trustworthy. It could be a requirement of the payment system to check such electronic coin data sets for validity by means of the coin register or by an action (modification) by the receiving security element to transmit the electronic coin data set to the receiving security element before it is allowed to be passed on.

Transmitting the electronic coin data set between the first and second security elements may be integrated into a transmission protocol between two participant units and/or integrated into a secure channel between two applications of the respective participant unit. In addition, the transmission may involve an internet data connection to an external data memory, such as an online memory.

The electronic coin data set (to be transmitted or modified) is registered in a coin register of the payment system. Thus, for example, for registering the electronic coin data set, a communication link establishment to the coin register is provided. This communication link does not necessarily have to be present during the transmission process (payment process). Preferably, the coin register is provided for managing and checking masked electronic coin data sets. The coin register can additionally manage and check other (non-payment) transactions between participant units.

The coin register—as part of the second layer—is for example a database in which a register data set is generated and/or stored. The coin register is arranged to provide at least one register data set to the monitoring register. A register data set is a data set that enables the validity, status, history and/or whereabouts of an electronic coin data set to be known and/or verified. A register data set is preferably uniquely associated with an electronic coin data set. The register data set is for verification purposes only and cannot be used to replace the electronic coin data set for payment transactions.

A register data set shall have one or more of the following data elements: an electronic coin data set signature; an electronic coin data set range identifier; an electronic coin data set check value; an electronic coin data set check value; an electronic coin data set counter value; a participant identifier of a participant unit sending the register data set; a masked electronic coin data set; and/or a monetary amount of the electronic coin data set. All of these data elements and their function are defined at the appropriate locations.

In a preferred embodiment, the coin register provides a register data set. For example, the register data set has as a data element a masked electronic coin data set corresponding to an electronic coin data set. The masked electronic coin data set has been provided, for example, by a participant unit or an issuing instance. Possession of a masked electronic coin data set does not allow disclosure of data elements of the (corresponding) electronic coin data set, making such a register data set with (only) masked coin data sets anonymous with respect to a participant identifier (this is also referred to below as identity anonymous) and also anonymous with respect to a monetary amount of the electronic coin data set (this is also referred to below as amount anonymous). Masking will be explained later.

In a further embodiment, the register data set has, for example, as data elements a masked electronic coin data set (corresponding to an electronic coin data set) and an amount category relating to a monetary amount of the electronic coin data set corresponding to the masked electronic coin data set. Such a register data set with masked coin data set is identity anonymous and amount pseudonymous. Masking and also the use of amount categories will be explained later.

In a further embodiment, the register data set has, for example, as data elements a coin identifier of an electronic coin data set, a check value of the electronic coin data set and a pseudonym of the participant identifier. Such a register data set is identity pseudonymous and amount anonymous. For example, masked electronic coin data sets are provided as a data element in the register data set or as the register data set. These masked electronic coin data sets are registered with their corresponding processing in the coin register. Masking will be explained later. In a preferred embodiment, a validity status of the (masked) electronic coin data set can be derived therefrom. Preferably, the validity of the (masked) electronic coin data set is noted (registered) in the coin register. Modifications, such as switching, splitting or combining, to the individual electronic coin data sets are registered in the coin register.

Preferably, modifications requested or made or to be made also cause a transaction data set to be provided (and encrypted, if necessary) as described above. In this way, the transaction data source, for example a transaction register, also serves to archive modifications to an electronic coin data set. This information in the payment system, which may be redundant to the information in the coin register or monitoring register, increases the stability and security of the payment system.

In one embodiment of the payment system, the registration of the processing or processing steps for a respective modification in the coin register may also concern the registration of check results and intermediate check results concerning the validity of an electronic coin data set in the coin register, in particular the determining of check values and counter values of corresponding electronic coin data sets. If a processing is final, this is displayed, for example, by corresponding flags or a derived overall mark in the coin register. Final processing then determines whether an electronic coin data set is valid or invalid.

In a preferred embodiment of the payment system, the registration of check results and intermediate check results concerning a respective modification or transmission operation between participant units or their security elements and concerning the validity (in particular for display) of an electronic coin data set, in particular the determining of check values and counter values of corresponding electronic coin data sets, is not performed in the coin register of the payment system but in a monitoring register of the payment system.

In a preferred embodiment, a register data set concerning the electronic coin data set is replaced in the coin register by a registering data set to be registered concerning the electronic coin data set or the modified electronic coin data set. Thus, (only) current coin data sets—existing in the payment system—are maintained as a register data set in the coin register. Any previous versions or earlier modifications are then maintained, for example, in the monitoring register (as a monitoring data set) and, for this purpose, are provided by the coin register to the monitoring register during the replacement process and are saved there. This allows the history of the electronic coin data set to be logged by the monitoring register. This makes the coin register data set optimised (=memory optimised) and reacts faster to register or status requests from participant units and/or the monitoring register.

In a preferred embodiment of the payment system, the monitoring register is arranged to store monitoring data sets. A monitoring data set is formed from at least one transaction data set and at least one register data set in the monitoring register.

In one embodiment, a monitoring data set corresponds to exactly one electronic coin data set and is formed from exactly one transaction data set (also corresponding to the electronic coin data set) and exactly one register data set (also corresponding to the electronic coin data set) in the monitoring register. This formation takes place after the transaction data source and/or coin register have provided it. A monitoring data set then relates to exactly one payment transaction.

In an alternative embodiment, a monitoring data set may also concern a plurality of electronic coin data sets, for example electronic coin data sets sent by a participant unit, preferably within a predefined time period. In this context, a monitoring data set is formed, for example, from several transaction data sets concerning this participant unit, preferably also concerning this transaction time period. In addition, the monitoring data set is formed, for example, from a plurality of register data sets concerning modifications to coin data sets initiated and/or requested and/or status-checked by the participant unit, preferably also concerning this transaction time period. Next, a monitoring data set concerns a plurality of transaction data sets (corresponding to respective electronic coin data sets of this participant unit, preferably in this transaction time period) and at least one, preferably several register data sets (also corresponding to the respective electronic coin data sets of this participant unit, preferably in this transaction time period) formed in the monitoring register. This formation is preferably done after the transaction data source and/or coin register has provided it. A monitoring data set then concerns several payment transactions of this participant unit, preferably within a predefined time period.

After the respective monitoring data set has been formed, an evaluation of the monitoring data set can be performed by the monitoring register. This evaluating concerns checking for double spending of the electronic coin data sets or unauthorised generation of monetary amounts by a participant unit and/or also checking for ageing of electronic coin data sets. By forming and evaluating in the monitoring register, it can be determined, for example, that a participant unit has issued a coin data set twice or has changed a monetary amount. In addition, it can be detected that a coin data set has not been used for a predefined period of time and this is communicated to the participant or an automatic return to the issuing instance is initiated.

Due to set anonymity levels, it is ensured that the payment system is still anonymous or pseudonymous, but that a reliable validity check is made by monitoring the transactions.

For example, this is done for each transaction, so that it is guaranteed that fraud attempts can be detected at a later date.

The monitoring data sets formed from (anonymised and/or pseudonymised) transaction data sets and register data sets enable the monitoring of transactions during the ongoing operation of the payment system. The monitoring register is a separate instance of the same payment system from the coin register. By splitting the coin register and the monitoring register within a payment system, the coin register can be less complex and map a superficial validity check, while the monitoring register checks the correctness of transmission processes, a possibly required deanonymisation of a participant unit and/or the check of count values or check values of electronic coin data sets.

Both the coin register and the monitoring register can be decentralised public databases, for example. This database makes it possible in a simple manner to check electronic coin data sets with regard to their validity and to prevent “double spending”, i.e. multiple issues, without the transmitting itself being registered or logged. The database, for example a distributed ledger technology, DLT, describes a technique for networked computers to come to an agreement on the order of determining transactions and that these transactions update data. It is equivalent to a decentralised management system or database.

Alternatively, the coin register is a centrally managed database, for example in the form of a publicly accessible data memory or a hybrid of a centralised and decentralised database. For example, the coin register and the monitoring register are designed as a service server of the payment system.

The coin register is preferably ready for use in at least two different modes. In a first mode, only register data sets are provided and in a second mode, the register data sets and the transaction data sets are provided from the coin register to the monitoring register. The mode is preferably selected on the basis of anonymity of the participant unit. Typically, participant identifiers authenticate themselves to the coin register to register an electronic coin data set (register request) or to request a status of an electronic coin data set (status request). As part of this authentication, the authenticating participant unit transmits a participant identifier or a pseudonym of the participant identifier, resulting in the successful authentication of the participant unit to the coin register.

The second mode in the coin register is only set when a participant unit has successfully authenticated itself at the coin register. By authenticating in this second mode, the coin register knows the participant unit. All related register and status requests are not (any longer) anonymous to the coin register. Due to the combination of authentication of the participant unit and the requests from the participant unit, the coin register can (automatically) provide both register data sets and transaction data sets to the monitoring register. There, these register data sets and transaction data sets are formed into monitoring data sets. Alternatively, the transaction data generated by the participant unit (instead of a transaction register) is provided directly to the coin register and from there to the monitoring register.

The first mode is set whenever a participant unit does not identify itself to the coin register, i.e. does not authenticate itself or fails a requested authentication. This may be desired on the subscriber unit side, for example if the corresponding subscriber wishes to remain anonymous in the payment system. In this case, the coin register cannot provide transaction data sets associated with a register data set because it is not possible to identify the sending participant unit. In this case, the transaction data sets are provided by the transaction register to the monitoring register or otherwise directly from the participant unit to the monitoring register. There, these register data sets and transaction data sets are formed into monitoring data sets.

The mode can be set, for example, based on a topology of the participant unit. For example, security elements (trusted wallets) as participant units can have a high trustworthiness and then the second mode is automatically selected. Alternatively, unknown terminals (non-trusted wallets) could cause the coin register to automatically operate in the first mode due to lack of trustworthiness, a possibly successful authentication of this unknown terminal is preferably not trusted in the coin register.

In a preferred embodiment, the coin register is also arranged to register modified electronic coin data sets, whereby the status and/or register requests of the participant units may furthermore concern the modified electronic coin data sets. Thus, any modification of a coin data set—planned or carried out by a participant unit—also leads to the generating of register data sets and transaction data sets, which are formed into monitoring data sets in the monitoring register and evaluated. Thus, modifications to the coin data set are also archived and verifiable in the monitoring register.

In a preferred embodiment, the first participant unit sending the electronic coin data set sends the (encrypted) transaction data set to the transaction register. Subsequently, the first participant unit can locally delete the transaction data set to save storage space.

In a preferred embodiment, the transaction data set is sent in a cryptographically secure manner. For example, mutual authentication is used between the participant unit and the transaction register. A key exchange is either negotiated in advance as a session key or issued in advance. This additional transport security prevents an attacker from learning that a transaction data set is now being transmitted. This increases the security when transmitting the transaction data set.

In a preferred embodiment, the encrypted transaction data set is sent from the first security element to the transaction register. This keeps the transaction register up to date with regard to transmitted/scheduled transmissions and promptly archives recent transactions in the transaction register. Furthermore, the sending is prioritised in case no connection to the transaction register was available at the time of transmitting the coin data set and the participant unit or its security element is instructed to promptly send the encrypted transaction data set to the transaction register if a communication link is (detected) available.

In a preferred embodiment, the electronic coin data set is transmitted from the first participant unit to the second participant unit. The transmitting occurs, for example, immediately before the transaction data set is generated. For example, transmitting takes place immediately after the generating step, so that transmitting could be a part of the atomic operation described above and only the whole chain of generating-transmitting(-encrypting) can be executed. This avoids differences between the generated transaction data set and the actual transmitted coin data set.

For transmitting the electronic coin data set to the second participant unit, a data connection to other instances of the payment system is not mandatory. In order to make a transmission protocol secure, the electronic coin data sets are, for example, managed by security elements within the respective participant units and also transmitted through them. In an (offline) transmission environment, it is important that transmission errors or conflicts can be resolved without intermediary central instances of a payment system, such as the coin register or monitoring register. A transmission protocol can ensure that a transmission process (payment process), although executed asynchronously, is trusted by checking the presence of a receive message and using security elements. A two-step transmitting (sending, then deleting) is preferred to ensure that monetary amounts are not destroyed nor duplicated while active.

In a preferred embodiment, the generated transaction data set is stored, preferably non-volatile, in the first participant unit. The storage may be a temporary storage as long as the electronic coin data set has not been successfully transmitted to the second participant unit. In this case, the storage is local. The transaction data set can be used to repeat the transmission process between the participant units in case of a faulty transmission. No changes have to be made to the coin data set or the transaction data set itself. The stored transaction data set thus serves for a necessary repetition (RETRY) of the transmission in case of connection errors or authentication problems during the transmission.

In addition or alternatively, the stored transaction data set is used for reversal (ROLLBACK) in case of failed transmission of the coin data set. Thus, the method provides both a settlement procedure and a retry procedure to be able to reverse or retry the transaction in case of a transmission error event where the transmitting of the coin data set was not completed.

This completes or completely undoes the transmitting in the event of a retransmission.

In a preferred embodiment, in a transmission error event, the stored transaction data set is used to resend the electronic coin data set. It is assumed that the transmitting of the electronic coin data set has failed, but the transmitting process is still to be completed. The transmitting of the electronic coin data set is promptly repeated. The electronic coin data set to be retransmitted is the same as the electronic coin data set that had a transmission error event during transmission. Therefore, no changes to the coin data set are required for the resend. In one embodiment, another transaction data set is generated for logging purposes.

A transmission error event is assumed, for example, if a confirmation of receipt has not been received in the first security element within a predefined period of time. For this purpose, for example, a timer is started, preferably the timer is started during the sending step of the electronic coin data set.

The transmission error event can alternatively or additionally be displayed by an error message of the first or the second security element. This explicitly displays the error case. The transmission error event can also be assumed by a detected connectivity failure (connectivity failure). This implicitly displays the error case.

The transmission error event can also occur due to authentication failure (connectivity failure).

The transmission error event can also occur due to the shutdown of a terminal (device shutdown) in which one of the security elements is inserted ready for use, or due to exceeding the transmission distance (exceeded distance) due to a movement of a subscriber.

The transmission error event can also occur due to an internal error in the first or second security element, in an application of the terminal, or in the respective terminal.

In a preferred embodiment, the first participant unit, preferably the first security element, queries the second participant unit, preferably the second security element, at predefined periodic time intervals and actively requests an acknowledgement of receipt, alternatively also when a time value of a timer is exceeded.

In a preferred embodiment, after the transmitting step, a successful transmitting is displayed in the first participant unit. A user display can be updated or the monetary amount can be deleted from a list of available monetary amounts. This display indicates to a participant (user) in the payment system that the transmission was successful. In addition or alternatively, an available monetary amount is updated, in particular reduced according to the transmitted monetary amount.

In a preferred embodiment, the electronic coin data set is evaluated as an input parameter of an application of the first participant unit in the display step. The transaction data of this electronic coin data set thus actively controls the transmission process regardless of an application that is inserted executably in the first participant unit. Changes to the electronic coin data set are visualised for a user by the application on the first participant unit, the user thus obtaining prompt feedback on the validity/status of the electronic coin data set to be transmitted/the transmitted electronic coin data set.

In a preferred embodiment, the executing step is executed only when a checking step determines that a check value for a number of transmissions to the second participant unit or to one or more other participant units is below or equal to a predefined threshold value in the event of a failed communication link establishment to the transaction register or a failed transmission of the (encrypted) transaction data set to the transaction register or the monitoring register. This limits the number of transmissions of coin data sets from the first participant unit to a maximum value if no transmitting of the respective transaction data set to the transaction register has occurred or could occur in the meantime. This forces the first participant unit to always check whether a threshold value, for example 100, more preferably 50, more preferably 10 transmissions, ideally 5 transmissions, has been reached.

In a preferred embodiment, if a predefined threshold value of a check value for a number of transmissions to the second participant unit or to one or more further participant units is exceeded in the event of a failed communication link establishment to the transaction register or the monitoring register, respectively, or a failed transmission to the second participant unit or to one or more further participant units, the encrypted transaction data record and/or a stored transaction data record must be sent to the transaction register or the monitoring register, respectively. The number of transmissions to the second subscriber unit or to one or more other subscriber units in the event of a failed communication link establishment to the transaction register or the monitoring register, respectively, or a failed transmission of the encrypted transaction data set to the transaction register or the monitoring register, respectively, is reduced by transmitting the encrypted transaction data set and/or a stored transaction data set to the transaction register or the monitoring register, respectively, prior to transmitting the electronic coin data set. This limits the number of transmissions of coin data sets from the first participant unit to a maximum value if no transmitting of the respective transaction data sets to the transaction register or monitoring register has taken place or could take place in the meantime. This forces the first participant unit to send the encrypted transaction data sets. Transmission of coin data sets is prevented until the transaction data sets have been successfully sent. The threshold value is for example 100, more preferably 50, more preferably 10 transmissions, ideally 5 transmissions.

In a preferred embodiment, if the electronic coin data set is successfully transmitted and the communication link establishment to the transaction register fails or the encrypted transaction data set is sent to the transaction register, a check value is incremented in the first participant unit. In this way, the check value to be checked is always up-to-date with respect to transmitted coin data sets whose corresponding transaction data set has not yet been transmitted from the participant unit to the transaction register.

In a preferred embodiment, the further steps are executed in the payment system: Masking the electronic coin data set by applying a homomorphic one-way function to the electronic coin data set to obtain a masked electronic coin data set and registering the masked electronic coin data set in a coin register of the payment system, the registering preferably being for switching, splitting or connecting masked electronic coin data sets. This allows modifications to the coin data set to be tracked and documented in the coin register without removing anonymity in the payment system. Masking will be explained later.

In a preferred embodiment, storing in the transaction register is limited in time to a predefined period of time. This time period starts, for example, at the time of receiving the encrypted transaction data set in the transaction register or is started by a transaction time attached as a metadata to the encrypted transaction data set. This time period is, for example, a legal requirement, i.e. a minimum or maximum time period for saving the transaction data set, for example in the context of a data retention, for example X months or Y years, such as 6 months or 2 years.

In a preferred embodiment, the method comprises the further step of decrypting the encrypted transaction data set with a cryptographic key, wherein the key for decrypting the encrypted transaction data set is composed of at least two cryptographic partial keys of respective different remote instances in the transaction register.

In a preferred embodiment, the composing is performed by an addition operation or a bitwise XOR operation.

In a preferred embodiment, the cryptographic key for decrypting the encrypted transaction data set is composed of a predefined number of cryptographic partial keys of different remote instances, the predefined number being less than the total number of different instances.

In a preferred embodiment, decryption is performed only upon external request. This request may be the result of an investigative process to verify whether a transaction has actually occurred.

In a preferred embodiment, the transaction register has a hardware security module, HSM for short, whereby the hardware security module is a secure key store in which different generations of the partial keys of the respective remote instances are saved. In this way, partial keys of individual remote instances can be renewed or exchanged without having to re-encrypt the encrypted transaction data sets stored up to that point or even having to remain undecryptable in the transaction register. The key generations are preferably kept up to date by an HSM of the transaction registry. In a preferred embodiment, the transaction register has a hardware security module to which the various instances authenticate themselves before decrypting the stored encrypted transaction data set. The HSM can thus fulfil various functions; it is primarily a secure key store and a secure processing unit. For example, the HSM module may contain different key generations of the partial keys, with the remote instances authenticating themselves to the HSM to enable decryption with all generations.

In a preferred embodiment, after receiving the encrypted transaction data set from the first participant unit, the encrypted transaction data set is re-encrypted. This means that the encrypted transaction data set is always re-encrypted (i.e. decrypted and newly encrypted) when it is received, thus avoiding transaction data sets being stored in the transaction register in different encrypted form. This simplifies the administration of the encrypted transaction data sets in the transaction register.

Alternatively, after receiving an updated partial key from one of the instances, the encrypted transaction data set is re-encrypted. This prevents transaction data sets from being stored in the transaction register in different encrypted form when the key of an instance is changed.

In a preferred embodiment, after receiving the encrypted transaction data set from the first participant unit, the encrypted transaction data set is decrypted.

In a preferred embodiment, an identifier of a (first and/or second) participant unit is replaced by a pseudonym in the transaction data set and/or the register data set in order to obtain a pseudonymised transaction data set (=identity pseudonymised transaction data set) and/or a pseudonymised register data set (=identity pseudonymised register data set). In one embodiment of the method, storing the received encrypted transaction data set is unaffected.

In a preferred embodiment, the payment system has a person register, wherein in the person register natural persons are assigned to respective participant identifiers of participant units of the payment system and/or to respective pseudonyms of participant units. Thus, an identifier of a participant unit (for example, the participant ID of a terminal) in the payment system is uniquely assigned to a natural person. This personal allocation is carried out by an issuing instance of the payment system or a bank instance of the payment system, for example, and may also be managed there. This person assignment can also be managed by a service instance, for example an instance that provides a wallet application for the terminal or that provides online access to a cloud wallet. This assignment of person to identifier is only carried out by the respective instance after the person has been successfully identified, for example by presenting an official identification document such as an identity card or passport.

In a preferred embodiment, after receiving the transaction data set and/or the register data set, a monetary amount of an electronic coin data set is replaced by one or more amount categories in the transaction data set in order to obtain an amount-categorised transaction data set (=amount pseudonymous transaction data set) and/or an amount-categorised register data set (=amount pseudonymous register data set). An amount category is, for example, an amount range (from-to) in which the monetary amount of the coin data set lies. For example, an amount category is a rounded amount value of the monetary amount, either up or down. In one embodiment of the method, storing the received encrypted transaction data set is unaffected.

In a preferred embodiment, the pseudonymised or amount-categorised transaction data set is sent to a monitoring register of the payment system and stored there. Anonymised or pseudonymised transaction data sets can thus be stored in the monitoring register, enabling monitoring of transactions during operation.

A pseudonymised transaction data set can be amount pseudonymised and/or identity pseudonymised. An anonymised transaction data set may be amount-anonymous and/or identity-anonymous.

In a preferred embodiment, the pseudonymised register data set is sent to the monitoring register of the payment system and stored there. Anonymised or pseudonymised register data sets can thus be stored in the monitoring register, enabling monitoring of transactions during operation.

A pseudonymised register data set can be amount pseudonymised and/or identity pseudonymised. An anonymised register data set may be amount-anonymous and/or identity-anonymous.

With the creation of pseudonymised or anonymised transaction or register data sets, an anonymity level for the respective transaction data set is changed. The pseudonymised or anonymised transaction or register data set always has a higher level of anonymity than the (non-pseudonymised) transaction or register data set. With this higher anonymity level, the pseudonymised transaction or register data set—in a default of the payment system—can also be stored unencrypted in the register instances (coin register, monitoring register, transaction register) and used for further validity checks in the payment system. This could improve the detection of cases of fraud or manipulation in the payment system by the payment system itself; a request by the authorities (court order) may then not be necessary.

An anonymity level of a data set reflects a degree of anonymity of the (coin or transaction or register) data set, i.e. a possibility of assigning a constant identity, such as participant identifier, ID number, natural person, etc., to a data set. Preferably, a distinction is made between several levels, for example 3 levels, in the method: fully-anonymous (level 1), pseudonymous (level 2) or non-anonymous (level 3). The aim of the payment system is to transmit monetary amounts anonymously (level 1), i.e. it should not be possible for a participant in the payment system—similar to analogue cash—to infer the constant identity of the participant on the basis of a received electronic coin data set. For the participation of anonymous (non-trustworthy) participants and/or for law enforcement, however, it is important to be able to assign a constant identity to an electronic coin data set beyond doubt. Therefore, the generated transaction or register data sets are non-anonymous (level 3), i.e. they are unambiguously assigned to a constant identity, for example a participant identifier, which can lead to a natural persons via a person assignment.

A mixed form of both levels 1 and 3 is level 2, namely the use of a pseudonym (level 2). This is the temporary or permanent assignment of a derived identity to a data record. The derivation is generated, for example, in a trusted instance such as a monitoring register.

A participant identifier in the encrypted transaction or register data set preferably has a level 3 anonymity, so that (decrypting the) transaction or register data set displays the constant participant identifier.

A monetary amount in the transaction or register data set preferably has a level 3 anonymity such that (decrypting the) transaction or register data set displays the exact amount.

In a preferred embodiment, the anonymity level of a participant identifier in the transaction or register data set is different from an anonymity level of an amount category, so that mixed forms (different levels) may be present in a pseudonymised or anonymised transaction or register data set. In a preferred embodiment, a register data set has one of different anonymity levels, wherein the coin register is arranged to set the anonymity level of the register data set before providing it to the monitoring register.

In a further preferred embodiment, a transaction data set has one of different anonymity levels, wherein the transaction data set source is arranged to set the anonymity level of the transaction data set prior to providing it to the monitoring register.

Preferably, a participant identifier of a participant unit is pseudonymised or anonymised (=identity pseudonym or identity anonym) for setting the anonymity level.

Preferably, a monetary amount of an electronic coin data set is pseudonymised or anonymised (=amount pseudonym or amount anonym) for setting the anonymity level.

Preferably, the anonymity level of a monetary amount of an electronic coin data set in a register data set is different from the anonymity level of a participant identifier of a participant unit in the register data set.

Preferably, the anonymity level of a monetary amount of an electronic coin data set in a transaction data set is different from the anonymity level of a participant identifier of a participant unit in the transaction data set.

Preferably, the anonymity level of a monetary amount of an electronic coin data set in a transaction data set is different from the anonymity level of a monetary amount of an electronic coin data set in a register data set (corresponding to the transaction data set).

Preferably, the anonymity level of a participant identifier of a participant unit in a transaction data set is different from the anonymity level of a participant identifier of a participant unit in the register data set (corresponding to the transaction data set).

Preferably, the anonymity level of a register data set is lower than the anonymity level of a transaction data set (corresponding to the register data set).

Preferably, the setting of the anonymity level is changed by replacing an identifier of a participant unit with a pseudonym in the transaction data set or in the register data set (corresponding to the transaction data set). Preferably, the setting of the anonymity level is changed by replacing a monetary amount of an electronic coin data set with an amount category in the transaction data set or in the register data set (corresponding to the transaction data set).

The setting of the anonymity level in the payment system may be subject to different system requirements. One system requirement may be that a transmission must be amount anonymous, i.e. that the transaction and register data sets should not be used to infer the monetary amount of the electronic coin data set and/or a participant identity.

Another system requirement may be that a transmission must be identity anonymous, i.e. the transaction and register data sets should not be used to infer the (natural person of the) participant unit of the electronic coin data set and/or a participant identity.

The setting of the anonymity level can be done in dependence of a mode of the coin register, so that in case of non-trusted anonymous participants (first mode) a higher level of anonymity is to be set for the transaction data sets or the register data sets, respectively, in order to allow an easier traceability of the coin data sets.

A low level of anonymity is understood to mean that the record is completely anonymous, i.e. neither a participant (identifier) nor an amount can be inferred. The highest level of anonymity is the unobfuscated (visible to everyone) transmitting of the participant identity (identifier) and the amount of the electronic coin data set.

The task is also solved by a participant unit in the payment system described above. The participant unit is preferably a security element. The participant unit comprises a computing unit arranged for transmitting an electronic coin data set to another participant unit. Furthermore, the participant unit comprises means for accessing a data memory, wherein at least one electronic coin data set is stored in the data memory. the participant unit further comprises an interface arranged for sending status and/or registration requests concerning the electronic coin data sets or the modified electronic coin data sets to the coin register.

In a preferred embodiment, the computing unit is further arranged to generate a transaction data set relating to the transmission of the electronic coin data set, the interface being further arranged to establish a communication link establishment to a transaction register as a transaction data source to send the generated transaction data set to the transaction register. The task is further performed by a coin register in the payment system described above. The coin register comprises a computing unit arranged to set a first mode or a second mode of the coin register according to an authentication success of a participant unit at the coin register. Furthermore, the coin register comprises means for accessing a coin memory, wherein electronic coin data sets are registered in the coin memory. Furthermore, the coin register comprises an interface arranged to provide register data sets in a first mode and to provide register data sets and transaction data sets in a second mode to the monitoring register.

Preferably, the computing unit of the coin register is arranged to set an anonymity level of a register data set.

Preferably, the computing unit of the coin register is arranged to create register data sets. A register data set preferably comprises a masked electronic coin data set provided by a participant unit or an issuing instance. The register data set is then identity and amount anonymous and has a very low anonymity level. A register data set (alternatively) preferably comprises a masked electronic coin data set and an amount category relating to a monetary amount of an electronic coin data set corresponding to the masked electronic coin data set. The register data set is then identity anonymous and amount pseudonymous and has a medium anonymity level. A register data set (alternatively) preferably has a coin identifier of an electronic coin data set, a check value of the electronic coin data set and a pseudonym of the participant identifier. The register data set is then identity pseudonymous and amount neutral and has a higher average anonymity level. The check value of the register data set is for example a signature or a known masked electronic coin data set, e.g. a previous version.

Preferably, the interface or another interface of the coin register is arranged for obtaining status and/or registration requests concerning the electronic coin data sets or the modified electronic coin data sets from the participant unit.

Preferably, the coin register comprises a status verifier arranged to generate a status report relating to a registered electronic coin data set based on a status request from the participant unit, the interface or a further interface being arranged to provide the status report to the participant unit. Preferably, the coin register comprises a change verifier arranged to change an entry in the coin register relating to a registered electronic coin data set based on a register request from the participant unit.

Preferably, the interface or another interface of the coin register is arranged to request proof from the participant unit before the change is registered in the coin register.

Preferably, the interface or a further interface is arranged to receive register data sets of generated electronic coin data sets from an issuing instance of the payment system.

In a preferred embodiment, a module, preferably a hardware security module, is arranged in the coin register for replacing a participant identifier of the participant unit with a pseudonym of the participant unit in the register data set to obtain a pseudonymised register data set. Additionally or alternatively, the module is arranged to replace a participant unit pseudonym with a participant unit identifier in the register data set to obtain an identity open register data set. Additionally or alternatively, the module is arranged to replace a monetary amount of an electronic coin data set with an amount category in the register data set to obtain a pseudonymised register data set. Additionally or alternatively, the module is arranged to replace an amount category of the electronic coin data set with a monetary amount of the electronic coin data set in the register data set to obtain an open-amount register data set.

The task is further solved by a transaction register for the payment system described above. The transaction register comprises means for accessing a data memory, wherein at least one transaction data set is stored in the data memory. The transaction register further comprises an interface arranged to communicate with a participant unit to receive a transaction data set from the participant unit.

In a preferred embodiment, a module, preferably a hardware security module, is arranged in the transaction register for replacing a participant identifier of the participant unit with a pseudonym of the participant unit in the transaction data set to obtain a pseudonymised transaction data set. Additionally or alternatively, the module is arranged to replace a participant unit pseudonym with a participant unit identifier in the transaction data set to obtain an identity open transaction data set. Additionally or alternatively, the module is arranged to replace a monetary amount of an electronic coin data set with an amount category in the transaction data set to obtain a pseudonymised transaction data set. Additionally or alternatively, the module is arranged to replace an amount category of the electronic coin data set in the transaction data set with a monetary amount of the electronic coin data set to obtain an amount open transaction data set.

Preferably, the interface or another interface of the transaction register is arranged to send a transaction data set to the monitoring register of the payment system. In one embodiment, the transaction data set is either anonymised or pseudonymised or it corresponds to the transaction data set as provided by the participant unit, preferably in decrypted form.

Preferably, the interface or another interface of the transaction register is arranged to receive a participant identifier or a pseudonym of the participant identifier from a person register of the payment system.

In a preferred embodiment, the transaction register further comprises: a hardware security module arranged for securely saving partial keys of different generations; and decrypting encrypted transaction data sets.

In a preferred embodiment, the transaction register HSM is arranged for decrypting encrypted transaction data sets; replacing a participant unit identifier with a pseudonym in the transaction data set to obtain a decrypted pseudonymised transaction data set.

In a preferred embodiment, the HSM of the transaction register is arranged for decrypting encrypted transaction data sets and replacing a monetary amount of an electronic coin data set with an amount category in the transaction data set to obtain a decrypted amount-categorised transaction data set.

In a preferred embodiment, the interface is arranged to send the decrypted pseudonymised or the decrypted amount-categorised transaction data set to a monitoring register of the payment system.

The task is further solved by a monitoring register in a previously described payment system, wherein the monitoring register comprises an interface for receiving transaction data sets and/or register data sets from the coin register, wherein the interface or a further interface is further arranged for receiving transaction data sets from a transaction data source. The monitoring register further comprises a computing unit arranged to form monitoring data sets from the received transaction data sets and register data sets and further arranged to evaluate the formed monitoring data sets.

The task is further solved by a method for payment with electronic coin data sets in a payment system described herein. The method comprises the method steps: Registering the electronic coin data sets in a coin register of the payment system; executing payment transactions by transmitting the electronic coin data sets by participant units of the payment system; sending status and/or registration requests concerning the electronic coin data sets by the participant units of the payment system; evaluating monitoring data sets relating to the payment transactions by a monitoring register of the payment system, wherein a monitoring data set in the monitoring register is formed from at least one register data set and at least one transaction data set, wherein the at least one register data set is provided by the coin register and wherein the at least one transaction data set is provided by a transaction data set source and/or the coin register.

In a preferred embodiment, the payment system further comprises an issuing instance configured to create an electronic coin data set for the payment system.

In a preferred embodiment, a corresponding masked electronic coin data set is associated with each electronic coin data set in the respective method. Knowledge of a masked electronic coin data set does not authorise the issuance of the digital money represented by the electronic coin data set. This represents a key difference between masked electronic coin data sets and (non-masked) electronic coin data sets. A masked electronic coin data set is unique and also uniquely associated with an electronic coin data set, so there is a 1-to-1 relationship between a masked electronic coin data set and a (non-masked) electronic coin data set. The masking of the electronic coin data set is preferably performed by a computing unit of the participant unit. The participant unit has at least one electronic coin data set. Alternatively, masking may be performed by a computing unit of a participant unit receiving the electronic coin data set.

This masked electronic coin data set is obtained by applying a homomorphic one-way function, in particular a homomorphic cryptographic function. This function is a one-way function, i.e. a mathematical function that is “easy” to compute in terms of complexity theory, but “difficult” to practically impossible to reverse. In this context, one-way function also refers to a function for which no inversion is known that can be practically executed in a reasonable amount of time and with a reasonable amount of effort. Thus, the calculation of a masked electronic coin data set from an electronic coin data set is comparable to the generation of a public key in an encryption procedure via a residue class group. Preferably, a one-way function is used that operates on a group in which the discrete logarithm problem is difficult to solve, such as a cryptographic method analogous to elliptic curve encryption, or ECC, from a private key of a corresponding cryptographic method. The reverse function, i.e. generating an electronic coin data set from a masked electronic coin data set, is thereby—equivalent to generating the private key from a public key in an encryption procedure over a residue class group—very time-consuming. In the present document, when sums and differences or other mathematical operations are mentioned, they are to be understood in the mathematical sense of the respective operations on the corresponding mathematical group, for example the group of points on an elliptic curve.

The one-way function is homomorphic, i.e. a cryptographic method that has homomorphism properties. Thus, mathematical operations can be performed on the masked electronic coin data set that can also be performed in parallel on the (non-masked) electronic coin data set and thus be traced. Using the homomorphic one-way function, calculations with masked electronic coin data sets can be traced in the coin register and/or the monitoring register without the corresponding (non-masked) electronic coin data sets being known there. Therefore, certain calculations with electronic coin data sets, for example for processing the (non-masked) electronic coin data set (for example splitting or connecting), can also be determined in parallel with the corresponding masked electronic coin data sets in the coin register, for example for validation checks (=validities). In addition, parallel proof of the legitimacy of the respective electronic coin data set can be provided in the monitoring register. The homomorphism properties apply at least to addition and subtraction operations, so that a switching (=switching), splitting (=splitting) or combining (=connecting) of electronic coin data sets is also recorded in the monitoring register by means of the correspondingly masked electronic coin data sets in the coin register or the check whether the electronic coin data set is to be returned (deleted) or recoined and is verified by the requesting participant units or by the security elements of the participant units and/or by the coin processing system. The coin register and/or the monitoring register shall be able to retrace the electronic coin record without knowledge of the monetary amount and the performing participant unit.

The homomorphism property thus allows an entry of valid and invalid electronic coin data sets based on their masked electronic coin data sets to be kept in a coin register and a monitoring register without knowledge of the electronic coin data sets, even if these electronic coin data sets are processed (split, connected, switched) or directly transmitted, i.e. an action is performed on these electronic coin data sets. This always ensures that no additional monetary amount has been created or that an identity of the participant units or their security elements is recorded in the coin register or monitoring register. Masking allows a high level of security without revealing the monetary amount or the participant unit.

When transmitting an electronic coin data set directly from the first participant unit to a second participant unit, two participant units have simultaneous knowledge of the electronic coin data set to be transmitted. It is important to prevent the sending first participant unit from also using the electronic coin data set at another (third) participant unit for payment (so-called double spending). Before transmitting, a status of the electronic coin data set can be set to inactive status to invalidate the electronic coin data set, then transmitting (as the first step of transmitting) to the second participant unit takes place, and if there is an acknowledgement of receipt from the second participant unit, deletion of the electronic coin data set in the first participant unit takes place (as the second step of transmitting). A deletion confirmation from the first participant unit may be sent to the coin register or the second participant unit to display a successful deletion (performed in the first participant unit) of the electronic coin data set.

In addition, the transmitted electronic coin data set can be switched from the first participant unit to a second participant unit. Preferably, the switching can be done automatically upon receiving the cancellation confirmation of an electronic coin data set in the second participant unit. In addition, it may also occur upon request, for example, a command from the first participant unit and/or the second participant unit. Additionally, an electronic coin data set can also be split into at least two electronic coin data sets. Additionally, two electronic coin data sets can be connected to one electronic coin data set (“merging”).

Switching, splitting and connecting are different modifications to an electronic coin data set, i.e. actions with the electronic coin data set. These modifications require registering the masked coin data set in the coin register of the payment system. The actual execution of the individual modifications will be explained later.

Switching also occurs when an electronic coin data set has been modified, for example split or connected to other electronic coin data sets, especially in order to be able to settle a monetary amount to be paid appropriately. The payment system should always be able to pay any monetary amount.

This pseudonymisation is explained in more detail below: The transmitting of electronic coin data sets in the payment system is anonymous as long as the anonymity is not to be explicitly removed by additional measures. It could be a requirement in the payment system to remove anonymity depending on a value for monetary amounts. In other words, a typical requirement in the payment system could be to send monetary amounts anonymously below a determining threshold. If this limit is exceeded, the transmitting in the system is de-anonymised.

In a preferred embodiment, the payment system is arranged to execute the further steps: masking the electronic coin data set by applying a homomorphic one-way function to the electronic coin data set to obtain a masked electronic coin data set; associating the masked electronic coin data set with a pseudonym to obtain a pseudonymised masked electronic coin data set; and sending the pseudonymised masked electronic coin data set to a coin register and/or a monitoring register of the payment system. In this way, modifications to the electronic coin data set are tracked in the coin register and documented in the monitoring register under a pseudonym, without removing anonymity in the payment system. The monitoring register can thus identify the outgoing transactions at the participant unit even if the affiliation of the pseudonym and participant unit is known.

In the above-mentioned method according to the invention, the pseudonymised masked electronic coin data set is preferably inserted into the transaction data set in the generating step by the first participant unit, further preferably instead of the masked electronic coin data set, and is preferably sent to the transaction register in encrypted form. A later decryption then also reveals the pseudonym under which the transaction took place.

This is an alternative to providing the transaction register with pseudonymised transaction data as described above and could be used in parallel or additionally in the coin register or also in the monitoring register. The selection of the respective pseudonymisation can be set flexibly in the payment system and adapted to the actual requirements of the payment system, for example to the computing power of the transaction register or the coin register or the monitoring register or a transmission capacity in the payment system. The selection may be a payment system preset.

Since a digital payment transaction (transmitting electronic coin data sets) of a large monetary amount could also be split into several digital payment transactions of smaller monetary amounts, each of which may be below the threshold, the threshold must be participant unit-specific and/or time period-dependent. Moreover, due to the non-transparent multiple (direct) transmission of a coin data set between a multitude of different participant units, this requirement for de-anonymisation, also called re-identification, is not directed at individual transmissions (transactions) between two participant units, but usually concerns the sum of all transactions within a determining time unit (duration) that are received and/or transmitted by a participant unit. A mechanism is therefore provided to determine what the sum of all monetary amounts sent or received by a participant unit is within a given unit of time. For this purpose, a method is described that enables the de-anonymity of a sending participant unit when exceeding a limit value per time unit.

To enable such a mechanism for de-anonymisation, in a preferred embodiment pseudonymisation or even anonymisation is performed. For this purpose, a linking step is performed before the masking step in order to associate a pseudonym of the first participant unit with the electronic coin data set. The pseudonym is preferably participant unit-specific.

In general for this system, a pseudonym is any type of disguised identity that does not allow the participant unit and the transactions performed with it to be directly inferred in mere knowledge of the electronic coin data set. For example, the pseudonym is temporary and can be replaced by another pseudonym. It disguises the constant identity (participant identifier) of a participant in the payment system. An assignment between pseudonym and constant participant identifier is stored in the system in a secure environment, such as a person register, for example, and can be verified accordingly.

In contrast, an anonymous data record is not provided with a participant identifier or the participant identifier is freely selectable and is not assigned to a natural person in the payment system.

The participant unit must be able to make a modification (splitting, switching, connecting) for each coin data set received in order to associate the pseudonym with the coin data set. The registration in the coin register associated with each modification (for validating the modification) is sufficient to uniquely associate all coin data set transactions made with the participant unit to that participant unit based on the associated pseudonym. A monitoring register, knowing the association of the pseudonym and the participant unit, can identify the transactions received by the participant unit.

Thus, modifications to the electronic coin data set are associated with a pseudonym stored on the participant unit. This pseudonym can be either permanent or valid only for a determined period of time.

The difference between an anonymous masked electronic coin data set and a pseudonymised masked electronic coin data set is thus the identifiability of the participant unit by the monitoring register when it uses the pseudonym. An anonymous masked electronic coin data set does not contain any information about its origin, so it cannot be connected to a participant unit. In contrast, a pseudonymised masked electronic coin data set has an association with a pseudonym of the participant unit, so that the participant unit that sent the pseudonymised masked electronic coin data set to the monitoring register can be identified by the associated pseudonym.

The mechanism described is sufficient to determine whether the sum of the monetary amounts of all transactions of a participant unit are below a threshold value, preferably within a certain time unit. If it is detected that the threshold is exceeded by a desired modification, the coin register or monitoring register could promptly prevent such a modification by blocking or rejecting the registration of the corresponding electronic coin data set in the coin register. Alternatively or additionally, the participant unit could be informed that the modification (and thus the transaction) would only be carried out if the participant unit de-anonymises itself, e.g. discloses personal access data, before the modification is registered and the electronic coin data set is set to valid, thereby accepting the transaction.

In a preferred embodiment of masking, sending the pseudonymised masked electronic coin data set instead of an anonymous masked electronic coin data set reduces the number of range confirmations or range proofs that the monitoring register requests from the first participant unit.

The monitoring register, the coin register, the transaction register and/or the participant units may process the masked electronic coin data sets in an anonymous or in a pseudonymous mode. In an anonymous mode, the monitoring register requests necessary and further (catch-up) range verifications or range confirmations. In pseudonymous mode, the monitoring register does not request at least one of the further range proofs or range confirmations, but checks whether a (catch-up) criterion is fulfilled for the pseudonym. An electronic coin data set can already be treated as valid if the necessary checks have been made. Only when the (catch-up) criterion is fulfilled are range proofs or a cumulative range proof (or confirmation) requested from the participant unit. For example, a period of time or a number of masked electronic coin data sets can be used as (catch-up) criteria for the pseudonym.

In a further preferred embodiment of pseudonymisation, the first (sending) participant unit receives a request for a sum range confirmation or a sum range proof from the monitoring register, and sends the requested sum range confirmation or the requested sum range proof to the monitoring register.

In an alternative embodiment, the first participant unit generates an unsolicited aggregate range confirmation or an unsolicited aggregate range proof, and sends the unsolicited aggregate range confirmation or the requested aggregate range proof to the monitoring register.

A sum range confirmation or a sum range proof is an indication by the participant unit of a sum of monetary amounts of a plurality of electronic coin data sets, preferably electronic coin data sets transmitted directly between participant units. This sum information is compared with a range information in the monitoring register. If the range is exceeded, the electronic coin data sets are de-anonymised in order to secure or control the transmitting of large monetary amounts.

Preferably, the first participant unit forms a sum of monetary amounts of several electronic coin data sets and confirms with the sum range confirmation that the formed sum is within a range. The sum range confirmation is understood in the monitoring register as a display of the participant unit and the participant unit is considered trustworthy.

In an alternative embodiment of pseudonymisation, the participant unit creates a sum range proof for several electronic coin data sets that can be verified by the monitoring register. The sum range is thus then checked by the monitoring register and confirmation is made there that the sum is in range (or not). The sum range proof is preferably also part of the transaction data set for the transaction register.

In a preferred embodiment of pseudonymisation, the multiple electronic coin data sets comprise only selected electronic coin data sets. Thus, the sum range confirmation or sum range proof is not performed for all electronic coin data sets of the participant units, but only for a targeted selection. In one embodiment, the selection only concerns electronic coin data sets of sent pseudonymised masked electronic coin data sets. In an alternative embodiment of masking, only electronic coin data sets from sent anonymous masked electronic coin data sets or sent pseudonymised masked electronic coin data sets are affected. In an alternative embodiment of masking, only electronic coin data sets from sent anonymised masked electronic coin data sets, sent pseudonymised masked electronic coin data sets and/or masked electronic coin data sets not sent to the monitoring register are affected. In a preferred embodiment of the pseudonymisation process, the multiple electronic coin data sets are selected according to a pre-selected time period as a selection criterion. The time period may be selected to be a day, a week, or a much lesser time period.

This selection is preferably masked and then sent to the transaction register in encrypted form as part of the transaction data set.

In an alternative or additional embodiment of pseudonymisation, a list in the first participant unit or monitoring register is to be used as the selection criterion, based on which list the electronic coin data sets are selected.

This list is preferably masked and then sent to the transaction register in encrypted form as part of the transaction data set.

In a preferred embodiment of pseudonymisation, the monitoring register requests range confirmations or range proofs from participant units as part of a summary check. Preferably, the monitoring register applies a first sum check mode for anonymous masked electronic coin data sets. Preferably, the monitoring register applies a second sum check mode for pseudonymised masked electronic coin data sets.

In a preferred embodiment of pseudonymising, the monitoring register checks a range proof for each modified electronic coin data set received.

In a preferred embodiment of pseudonymisation, the monitoring register requests range confirmations or range proofs from participant units on a regular or quasi-random basis. This is done, for example, in the first sum check mode.

In an alternative or additional embodiment of pseudonymisation, the monitoring register requests a range confirmation or range proof from the participant unit only after a number of coin data sets have been received for a pseudonym. This is done, for example, in the second sum check mode. This number is preferably dependent on the subscriber unit type and/or the coin amount range. In this way, the range proofs or range confirmations can be flexibly adapted to a specific user situation and thus increase the security of the payment system.

In principle, identifying the outgoing transactions or the incoming transactions is sufficient, so that in one embodiment masking the electronic coin data set and associating the masked electronic coin data set in the second participant unit with a pseudonym of the second participant unit in the second participant unit and sending the pseudonymised masked electronic coin data set to the monitoring register is not performed.

These identified outgoing transactions are preferably sent to the transaction register in encrypted form as part of the transaction data set.

The associating step of pseudonymising is preferably performed by signing the respective masked electronic coin data set in the second participant unit with a private signature key of the second participant unit for obtaining a signed masked electronic coin data set as a pseudonymised masked electronic coin data set or as a pseudonymised masked transmitted electronic coin data set.

The signing is done with a private signature key of the participant unit. This signature key is preferably participant unit-specific, i.e. knowing the verification key, it can be traced who last modified (switched, split, connected) the coin data set. The signed masked electronic coin data set is registered in the monitoring register.

In the above-mentioned method according to the invention, the signed masked electronic coin data set is preferably inserted into the transaction data set in the generating step by the first participant unit, further preferably instead of the masked electronic coin data set, and thus sent to the transaction register in encrypted form. A subsequent decryption then also reveals the signature under which the transaction took place.

To generate a signature, an asymmetric cryptosystem is thus preferred, in which the participant unit calculates a value for a data record using a secret signature key, referred to here as a private signature key or “private key”. This value allows anyone to verify the authorship and integrity of the record using a public verification key, the “public key”.

Preferably, with the step of registering, there will be a verification of the signature in the monitoring register, with the monitoring register having the public verification key of the signature for this purpose. The signature can now be verified by the monitoring register by having a public verification key of the signature known there.

The public verification key for checking the signature is preferably only known to the monitoring register, whereby the method remains anonymous for the participant units among themselves.

Preferably, the coin register registers any modification, i.e. switching, splitting and/or connecting together with the signature of the participant unit. In this way, monitoring and determining the sum of monetary amounts for all transactions of a participant unit can be done by the coin register and/or the monitoring register. For example, the signature is part of the transaction data set and is sent to the transaction register either in encrypted form or also in plain text and stored (archived) there.

Preferably, the signature is valid within a determining time unit, the determining time unit preferably being a day. Thus, for this determining time unit, the transaction volume (=sum of monetary amounts in transactions) per participant unit can be checked.

Each participant unit thus has an asymmetric key pair to sign each modification with the private signature key. The public key is known to the monitoring register (and also to the coin register). Thus, the monitoring register can associate each transaction with the participant unit as the sender or recipient of the coin data set.

The mechanism described is sufficient to detect (measure) whether the sum of all monetary amounts per participant unit (=transactions) is within a limit per time unit, for example a daily limit.

The following explains the detection of return criteria for already issued coin data sets, for example that a coin data set is to expire: The electronic coin data sets are issued by a central issuing instance, whereby each electronic coin data set additionally has a check value. The check value is incremented when the electronic coin data set is transmitted directly between two participant units, or the check value is invariant to an action (modification) performed by participant units on the electronic coin data set. The method comprises the step of: determining by the participant unit, based on the check value of an electronic coin data set, whether the electronic coin data set is displayed by the participant unit to the payment system or determining by the participant unit, based on the check value of the electronic coin data set, whether the electronic coin data set is returned to the central issuing instance. Thus, in a preferred embodiment, the check value for unsent transaction data sets mentioned above or another check value is also used to determine whether the electronic coin data set is displayed by the first participant unit to the payment system, in particular a coin register, and/or whether the electronic coin data set is returned to the central issuing instance.

Each check value of the electronic coin data set is used in the method to enable or enhance a control function in the payment system. Each check value is preferably a data element of the electronic coin data set that can be read by the participant unit or a data element in the participant unit and its value can be determined by the participant unit. The return criteria check value is linked to an electronic coin data set.

In a first embodiment, the check value for the return criteria is incremented when the electronic coin data set is transmitted directly between two participant units. The incrementing is either incremented by a sending participant unit immediately before the coin data set is sent to a receiving terminal. Or the incrementing is done in a receiving participant unit immediately after receiving the coin data set. Thus, the number of direct transmissions between participant units is recorded for each coin data set.

In a second (alternative to the first) embodiment, the check value is invariant to an action performed by participant units with the electronic coin data set (action invariant). Action invariant means that the check value is obtained unchanged during an action with the coin data set. The action invariant check value is not individual to the electronic coin data set, but group specific and therefore applies to a plurality of different coin data sets to maintain anonymity and prevent coin data set tracking. An action with a coin data set is any modification made to the coin data set by a terminal, i.e. in particular switching, splitting, combining, as will be described later. In addition, any transmitting of the coin data set, for example to a (different) participant unit or also to an instance in the payment system, is meant as an action. In addition, an action means redeeming the coin data set to credit a monetary amount of the coin data set or changing the currency system. These actions are performed by participant units and do not change the check value.

The check value of the electronic coin data set is used by the participant unit to determine whether this electronic coin data set is displayed (=reported) to the payment system. For example, if the number of transmissions between participant units exceeds a predefined threshold value, the electronic coin data set is displayed to the payment system. In an exemplary embodiment of the method, displaying corresponds to sending a switching command to a coin register of the payment system to cause switching of the coin data set to the participant unit sending the coin data set. In an alternative exemplary embodiment of the method, the display causes the coin data set to be marked in a monitoring register of the payment system. The check value and/or the coin data set may, but need not, be transmitted to the payment system for the purpose of display. The return of the electronic coin data set by the participant unit requires either the redemption of a monetary amount associated with the electronic coin data set or the issuance of a new electronic coin data set with an identical monetary amount.

The return of the electronic coin data set by the participant unit may trigger a reset or deletion of all existing entries for the electronic coin data set in the monitoring register in the payment system. This deletes digital traces of the electronic coin data set and ensures the anonymity of the method.

Alternatively, the check value of the electronic coin data set is used by the participant unit to determine whether the electronic coin data set is returned to the central issuing instance. Thus, the check value can be used to define a criterion for the return of an electronic coin data set. In this way, electronic coin data sets can be expired, for example, based on their lifetime or the number of actions performed with the coin data set, in order to increase the security at the payment system.

In a preferred embodiment, the electronic coin data set is returned to the central issuing instance as a result of being displayed by the payment system (the monitoring register). The display to the payment system thus determines in the payment system whether the coin data set is to be returned. In this embodiment, determining whether a return must be made is performed in the payment system instead of the participant unit. The result of the determining is communicated to the participant unit and the participant unit is requested by the payment system to return the electronic coin data set.

In a preferred embodiment, the payment system (the monitoring register) requests modification of the electronic coin data set as a result of the display. Modifying, for example splitting, combining or switching, requires registering the electronic coin data set in the payment system. In many embodiments of the digital currency system, a return to the issuing instance is not necessary and sometimes not useful. This is especially true if the coin data set was modified quickly after it was issued. In this embodiment, the coin data set is not returned, but it is considered returned.

In a preferred embodiment, a counter value in the payment system (the monitoring register) relating to that electronic coin data set is determined as a result of being displayed by the payment system using the check value of the electronic coin data set. The check value of the coin data set is preferably transmitted from the participant unit to the payment system (the monitoring register). The counter value is not part of the coin data set. Preferably, the counter value is managed in the payment system. Preferably, the counter value is incremented with each action (modification, transmission, redemption) concerning the electronic coin data set. Preferably, the counter value is increased with different weighting for different actions. This makes it possible to control the return in an improved way according to different actions. Thus, in the coin data set, the check value is provided as a data element that is incremented, in particular, with each direct transmission between participant units. The counter value in the payment system incorporates the check value, for example by adding the previous counter value to the check value.

In a preferred embodiment, each electronic coin data set has a first check value and a second check value. The first check value is then incremented accordingly when the electronic coin data set is transmitted directly between two participant units, the first check value of the electronic coin data set being used to determine whether the electronic coin data set is displayed by the participant unit at the payment system. At least the second check value of the electronic coin data set is used to determine whether the electronic coin data set is returned to the central issuing instance. Thus, a display check value is provided separately from a return check value in the coin data set.

Preferably, the second check value is invariant to an action performed by participant units on the electronic coin data set, wherein preferably the second check value is at least one value from the following list: return date of the electronic coin data set; issue date of the electronic coin data set; registration date of the electronic coin data set; and identification value of the electronic coin data set. The action invariant check value is not individual to the electronic coin data set but is group specific and therefore applies to a plurality of different coin data sets to maintain anonymity and prevent coin data set tracking. The second action-invariant check value is not individual to the electronic coin data set, but applies to a plurality of different coin data sets (group ID) to preserve anonymity and prevent coin data set tracking.

In an advantageous embodiment, the second check value is variable and comprises the first check value to determine whether the electronic coin data set is returned. A sum could be formed and this sum compared to a predefined threshold value. For example, the number of direct transmissions could be a return criterion, so that no infrastructure for evaluating the coin data set with regard to the return of the coin data set would have to be maintained in the payment system, thus enabling a simpler and more secure administration while creating the control functions.

In an advantageous embodiment, exceeding a threshold value of the check value of the electronic coin data set is detected by a first terminal and an action with this electronic coin data set, in particular the direct transmitting of this electronic coin data set from the first terminal to a second terminal, is only carried out if it has been determined in the first terminal that no other electronic coin data set is present in the first terminal. This ensures that a payment transaction between two terminals can still be carried out and completed with the coin data set despite the high number of direct transmissions of this coin data set between terminals due to the lack of alternative coin data sets in the terminal.

In an advantageous embodiment, exceeding a blocking threshold value of the check value of the electronic coin data set is detected by a first participant unit and an action with this electronic coin data set, in particular the direct transmitting of this electronic coin data set from the first participant unit to a second participant unit, is blocked, irrespective of whether another electronic coin data set is present in the first participant unit or not. Thus, a threshold value is defined which, when reached, completely prevents (blocks) direct transmitting between participant units. For example, this coin data set could be stored in a secure storage area, where only a return process but no action process of the participant unit has access. The threat of blocking may be detected in advance by the participant unit and communicated to a user of the participant unit to prevent the coin data set from being blocked by immediately returning the coin data set. Additionally or alternatively, the participant unit may return the electronic coin data set upon detection of exceeding the blocking threshold value.

Preferably, the threshold value of the check value is less than the blocking threshold value of the check value. The blocking threshold value can be a multiple of the threshold value in order not to block the coin data set too early. For example, the threshold value is ten, or for example five, or for example 3. The blocking threshold value is correspondingly 30, or for example 15, or for example 10.

In a preferred embodiment, the issuing instance queries check values of coin data sets at predefined periodic intervals or in a targeted manner and automatically reclaims an electronic coin data set when a check value of the electronic coin data set is exceeded.

In a preferred embodiment of the return method, the payment system's monitoring register determines a counter value in the monitoring register relating to the electronic coin data set using the electronic coin data set's check value. If a threshold value of the counter value is exceeded, the electronic coin data set is returned (directly or indirectly) to the central issuing instance. Preferably, only masked coin data sets are managed in the monitoring register. The issuing instance or the payment system requests the corresponding coin data set from the participant unit or provides a corresponding information from the payment system to the participant unit for (direct) return. The counter value is preferably increased with each action on the electronic coin data set, whereby preferably for different actions the counter value is increased with different weighting. Reference is made to the above advantages in such a method.

In a preferred embodiment of the return method, when an action is performed on the electronic coin data set by the monitoring register, the check value of the electronic coin data set is reset by the payment system. This simplifies the method as the participant unit does not need to be adjusted to the sum of all allowed actions, but only to the sum of successively allowed direct transmissions.

In a preferred embodiment, when combining (=connecting) electronic coin data sets into a combined electronic coin data set, the payment system determines the highest check value of the electronic coin data sets and takes this highest check value as the check value of the combined electronic coin data set.

In a preferred embodiment, when combining electronic coin data sets into a combined electronic coin data set, a new check value is determined by the monitoring register from the sum of all check values of the electronic coin data sets divided by the product of the number of coin data sets with a constant correction value, wherein said new check value is taken as the check value of the combined electronic coin data set, wherein the correction value is greater than or equal to 1, and wherein preferably the correction value depends on a maximum deviation of the individual check values of the electronic coin data sets or on a maximum check value of one of the electronic coin data sets, wherein further preferably the correction value is less than or equal to 2. The correction value is constant for payment.

In a preferred embodiment, the return of the electronic coin data set from the monitoring register to the issuing instance occurs when the terminal initiates the redeeming of a monetary amount of the electronic coin data set to an account of the payment system and/or when the participant unit requests an exchange of the monetary amount of the electronic coin data set to another currency system of the payment system.

An electronic coin data set can be split in a participant unit and this splitting is subsequently registered in the coin register. This has the advantage that an owner of the at least one electronic coin data set is not forced to always transmit the entire monetary amount at once, but to now form and transmit corresponding partial monetary amounts. The monetary value can be split symmetrically or asymmetrically without restrictions as long as all electronic coin data subsets have a positive monetary amount that is smaller than the monetary amount of the electronic coin data set from which to split and the sum of the electronic coin data sets is equal to the electronic coin data set to be split. Alternatively or additionally, fixed denominations can be used. Splitting into partial amounts is arbitrary. The splitting triggers, for example, executing the method described above for generating and encrypting a transaction data set, and the masked split electronic coin token data set may be part of a transaction data set for the transaction register.

The method preferably comprises the further steps of: Switching the transmitted electronic coin data set; and/or Connecting the transmitted electronic coin data set to a second electronic coin data set to form a (new) connected electronic coin data set. Upon switching, the electronic coin data set obtained from the first participant unit results in a new electronic coin data set, preferably with the same monetary amount, called the electronic coin data set to be switched. The new electronic coin data set is generated by the second participant unit, preferably by using the monetary amount of the obtaining electronic coin data set as the monetary amount of the electronic coin data set to be switched. In doing so, a new obfuscation amount, for example a random number, is generated. The new obfuscation amount is added to the obfuscation amount of the obtained electronic coin data set, for example, so that the sum of both obfuscation amounts (new and obtained) serves as the obfuscation amount of the electronic coin data set to be switched. After switching, the obtained electronic coin record and the electronic coin record to be switched are preferably masked in the participant unit by applying the homomorphic one-way function to the obtained electronic coin record and the electronic coin record to be switched, respectively, to obtain a masked obtained electronic coin record and a masked electronic coin record to be switched, respectively. The switching triggers, for example, executing the method described above for generating and encrypting a transaction data set, and the masked electronic coin to-be-switched data set may be part of a transaction data set for the transaction register.

The switching is thus secured by adding a new obfuscation amount to the obfuscation amount of the obtained electronic coin data set, thereby obtaining an obfuscation amount known only to the second participant unit. Newly created obfuscation amounts must have a high entropy, as they are used as a blinding factor for the corresponding masked electronic coin record. Preferably, a random number generator on the security element is used for this purpose. This safeguard can be tracked in the coin register.

Preferably, as part of the switching, additional information needed to register the switching of the masked electronic coin data set in the coin register is calculated in the participant unit. Preferably, the additional information includes a range record of the masked electronic coin data set to be switched and a range record of the masked obtained electronic coin data set. The range proof is a proof that the monetary amount of the electronic coin data set is non-negative, the electronic coin data set is validly created and/or the monetary amount and obfuscation amount of the electronic coin data set are known to the creator of the range proof. In particular, the range proof is used to provide such proof(s) without revealing the monetary amount and/or the obfuscation amount of the masked electronic coin data set. These range proofs are also called “zero-knowledge range proofs”. Preferably, ring signatures are used as range proofs. This is followed by registering the switching of the masked electronic coin data set in the remote coin register. Registering triggers, for example, executing the method described above for generating and encrypting a transaction data set, and the masked electronic coin record to be switched may be part of a transaction data set for the transaction register.

The step of executing the registration is preferably executed when the second participant unit is connecting to the coin register. While the electronic coin data sets are used for direct payment between two participant units, the masked coin data sets can be registered with a pseudonym in the coin register.

The registering triggers, for example, executing the method described above for generating and encrypting a transaction data set, and the pseudonymised masked electronic coin record to be switched may be part of a transaction data set for the transaction register.

In a further preferred embodiment of the method, for connecting electronic coin data sets, a further electronic coin data set (connected electronic coin data set) is determined from a first and a second electronic coin data set. In doing so, the obfuscation amount for the electronic coin data set to be connected is calculated by forming the sum of the respective obfuscation amounts of the first and the second electronic coin data set. Further, preferably, the monetary amount for the linked electronic coin data set is calculated by forming the sum of the respective monetary amounts of the first and second electronic coin data sets.

After connecting, the first electronic coin data set, the second electronic coin data set, and the electronic coin data set to be connected in the (first and/or second) participant unit is masked by applying the homomorphic one-way function to each of the first electronic coin data set, the second electronic coin data set, and the electronic coin data set to be connected, respectively, to obtain a masked first electronic coin data set, a masked second electronic coin data set, and a masked electronic coin data set to be connected, respectively. Further, additional information required for registering the connecting of the masked electronic coin data sets in the remote coin register is calculated in the participant unit. Preferably, the additional information includes a range proof on the masked first electronic coin partial data set and a range proof on the masked second electronic coin partial data set. The range proof is a proof that the monetary amount of the electronic coin data set is non-negative, the electronic coin data set is validly created and/or the monetary amount and obfuscation amount of the electronic coin data set are known to the creator of the range proof. In particular, the range proof is used to provide such proof(s) without revealing the monetary value and/or obfuscation amount of the masked electronic coin data set. These range proofs are also called “zero-knowledge range proofs”. Preferably, ring signatures are used as range proofs. This is followed by registering the connecting of the two masked electronic coin records in the remote coin register. Registering triggers, for example, executing the method described above for generating and encrypting a transaction data set, and the masked linked electronic coin partial data set may be part of a transaction data set for the transaction register.

The connecting step can be used to combine two electronic coin data sets or two electronic coin partial data sets. In this process, the monetary amounts as well as the obfuscation amounts are added together. Thus, as with splitting, a validity of the two original coin data sets can be performed when connecting.

In a preferred embodiment, the registering step comprises receiving the masked electronic coin data set to be switched in the coin register, checking the masked electronic coin data set to be switched for validity; and registering the masked electronic coin data set to be switched in the coin register if the checking step is successful, whereby the electronic coin data set to be switched is deemed to be checked.

This results, for example, in at least a three-tier payment system. In a first layer (direct transaction layer), electronic coin data sets are transmitted directly between individual participant units or their security elements. In a second layer (verification layer), masked electronic coin data sets are registered and verified in a coin register and a monitoring register. Preferably, no payment transactions are recorded in the second layer, but only masked electronic coin data sets, their status, check values if applicable, signatures and modifications for the purpose of verifying the validity of (non-masked) electronic coin data sets. This ensures the anonymity of the participants in the payment system. The second layer provides information on valid and invalid electronic coin data sets, for example, to avoid multiple issuance of the same electronic coin data set, or to verify the authenticity of the electronic coin data set as validly issued electronic money, or to record the sum of monetary amounts per security element in order to compare this sum with a threshold value and to prevent or allow modification accordingly. The second layer can use a counter value of an electronic coin data set to determine whether the electronic coin data set has expired and is to be returned, or modified accordingly so that it is considered returned. In a third layer (archiving layer), encrypted transaction data sets are stored in a transaction register and are decrypted and verified upon regulatory request as shown above.

In addition, the payment system also comprises, for example, an issuing instance that generates (creates) and reclaims (deletes) electronic coin data sets. When issuing an electronic coin data set from the issuing instance to a participant unit, a masked electronic coin data set can be issued in parallel by the issuing instance to the coin register and/or the monitoring register of the payment system for registration of the electronic coin data set.

A participant unit can have a security element or be a security element itself in which the electronic coin data set is securely stored. An application can be inserted on the participant unit ready for use, which controls or at least initiates parts of the transmitting method.

The transmitting of electronic coin data sets can be done with the help of terminals as participant units that are logically and/or physically connected to the security elements.

The communication between two participant units, possibly with the respective security elements, can be wireless or wired, or e.g. also by optical means, preferably via QR code or barcode, and can be designed as a secure channel, for example between applications of the participant units. The optical path may comprise, for example, the steps of generating an optical code, in particular a 2D code, preferably a QR code, and reading the optical code.

The transmitting of the electronic coin data set is secured, for example, by cryptographic keys, such as a session key negotiated for an electronic coin data set exchange or a symmetric or asymmetric key pair.

By communicating between participant units, for example via their security elements, the exchanged electronic coin data sets are protected against theft or manipulation. The security element level thus complements the security of established blockchain technology.

In a preferred embodiment, the coin data sets are transmitted as APDU commands. For this purpose, the coin data set is preferably stored in an (embedded) UICC as a security element and is managed there. An APDU is a combined command/data block of a connection protocol between the UICC and a terminal. The structure of the APDU is defined by the ISO-7816-4 standard. APDUs represent an information element of the application layer (layer 7 of the OSI layer model).

Furthermore, it is advantageous that the electronic coin data sets can be transmitted in any format. This implies that they can be communicated, i.e. transmitted, on any channels. They do not have to be stored in a determined format or in a determined programme.

A participant unit is considered to be in particular a mobile telecommunication terminal, for example a smartphone. Alternatively or additionally, the participant unit can also be a device such as a wearable, smart card, machine, tool, vending machine or even a container or vehicle. A participant unit is thus either stationary or mobile. The participant unit is preferably designed to use the Internet and/or other public or private networks. For this purpose, the participant unit uses a suitable connection technology, for example Bluetooth, LoRa, NFC and/or WiFi, and has at least one corresponding interface. The participant unit can also be designed to connect to the internet and/or other networks by accessing a mobile network.

For example, two participant units provide a local wireless communication link via whose protocol the transmission between the two security elements located therein is then inserted.

In one embodiment, the first and/or second security element may process the received electronic coin data sets according to their monetary value when multiple electronic coin data sets are present or received. Thus, it can be provided that electronic coin data sets with a higher monetary value are processed before electronic coin data sets with a lower monetary value.

In one embodiment, after receiving an electronic coin data set, the participant unit can be designed to connect it to an electronic coin data set already present in the participant unit depending on attached information, such as a currency or denomination, and execute a connecting step accordingly. Furthermore, the participant unit can also be designed to automatically execute a switching after receiving the electronic coin data set.

In one embodiment, further information, in particular metadata, is transmitted from the first participant unit or first security element to the second participant unit or second security element during transmitting, for example a currency. In one embodiment, this information may be comprised by the electronic coin data set.

The methods are not limited to a currency. For example, the payment system may be arranged to manage different currencies from different issuing instances. For example, the payment system is arranged to convert (=change) an electronic coin data set of a first currency into an electronic coin data set of another currency. This change is also a modification of the electronic coin data set. With the change, the original coin data set becomes invalid and is considered returned. Flexible payment with different currencies is thus possible and user-friendliness is increased.

The methods also allow the electronic coin data set to be converted into book money, e.g. the monetary amount to be paid into an account of the participant in the payment system. This conversion is also a modification. Upon redemption, the electronic coin data set becomes invalid and is considered returned.

Preferably, the at least one initial electronic coin data set is created exclusively by the issuing instance, although preferably the split electronic coin data sets, in particular electronic coin token data sets, may also be generated by a participant unit. Preferably, the generation and selection of a monetary amount also includes the selection of a high entropy obfuscation amount. The issuing instance is a computing system, which is preferably remote from the first and/or second participant unit. After creating the new electronic coin data set, the new electronic coin data set is masked in the issuing instance by applying the homomorphic one-way function to the new electronic coin data set to obtain a masked new electronic coin data set accordingly. Furthermore, additional information needed to register the creation of the masked new electronic coin data set in the remote coin register is computed in the issuing instance. Preferably, this additional information is a proof that the (masked) new electronic coin data set originates from the issuing instance, for example by signing the masked new electronic coin data set. In one embodiment, the issuing instance may sign a masked electronic coin data set with its signature when generating the electronic coin data set. The signature of the issuing instance is stored in the coin register. The signature of the issuing instance is different from the generated signature of a participant unit or security element.

Preferably, the issuing instance can deactivate an electronic coin data set in its possession (i.e. of which it knows the monetary amount and the obfuscation amount) by masking the masked electronic coin data set to be deactivated with the homomorphic one-way function and preparing a deactivate command for the coin register. Part of the deactivate command is preferably, in addition to the masked electronic coin data set to be deactivated, proof that the deactivating step was initiated by the issuing instance, for example in the form of the signed masked electronic coin data set to be deactivated. As additional information, the deactivate command could include range checks for the masked electronic coin data set to be deactivated. The deactivation may be the result of a return. This is followed by registering the masking of the masked electronic coin data set in the remote coin register. The deactivate command triggers the deactivate step.

The create and deactivate steps are preferably performed in secure locations, in particular not in the participant units. In a preferred embodiment, the steps of creating and deactivating are only performed or triggered by the issuing instance. Preferably, these steps take place in a secure location, for example in a hardware and software architecture designed to process sensitive data material in insecure networks. Deactivating the corresponding masked electronic coin data set has the effect that the corresponding masked electronic coin data set is no longer available for further processing, in particular transactions. However, in one embodiment, it may be provided that the deactivated masked electronic coin data set remains in archival storage at the issuing instance. The fact that the deactivated masked electronic coin data set is no longer valid or returned may be indicated, for example, by means of a flag or other coding, or the deactivated masked electronic coin data set may be destroyed and/or deleted. The deactivated electronic coin data set is also physically remote from the participant unit or security element.

The method according to the invention enables various processing operations (modifications) to be performed on the electronic coin data sets and the corresponding masked electronic coin data sets. Each of the processing operations (in particular creating, deactivating, splitting, connecting and switching) is registered in the coin register and appended to the list of previous processing operations for the respective masked electronic coin data set in an unchangeable form. Each of the processing operations triggers, for example, the method for generating and encrypting a transaction data set. The registration process is independent of the payment process between the participant units in terms of both time and location (space). The processing operations “create” and “deactivate” (=return), which concern the existence of the monetary amount itself, i.e. mean the creation and destruction up to the destruction of money, require an additional authorisation, for example in the form of a signature, by the issuing instance in order to be registered (i.e. logged) in the coin register. The remaining processing operations (splitting, connecting, switching), of which splitting and connecting can also be delegated from one participant unit to another participant unit, do not require authorisation by the issuing instance or by the instruction initiator (=payer, e.g. participant unit or security element).

A processing in the direct transaction layer only concerns the ownership and/or the allocation of the coin data sets to participant units of the respective electronic coin data sets. A registration of the respective processing in the coin register or the monitoring register is realised, for example, by corresponding list entries in a database, which comprises a number of flags to be performed by the coin register. A possible structure for a list entry comprises, for example, column(s) for a predecessor coin data set, column(s) for a successor coin data set, a signature column for the issuing instance, a signature column for the sending and/or receiving security element, a signature column for coin distribution operations and at least one marking column. A change (modification) is final if and the required flags have been validated by the coin register or the monitoring register, i.e. changed from status “0” to status “1”, for example, after the corresponding check. If a check fails or takes too long, it is changed from status “−” to status “0” instead, for example. Other status values are conceivable and/or the status values mentioned here are interchangeable. The statuses regarding the modifications are independent of the status during the transmission process (inactive/active). Preferably, the validity of the respective (masked) electronic coin data sets is summarised from the status values of the flags, each in a column for each masked electronic coin data set involved in the registering processing.

In another embodiment, at least two, preferably three, or even all of the aforementioned flags may also be replaced by a single flag that is set when all checks have been successfully completed. Furthermore, the two columns for predecessor data sets and successor data sets can be combined into one column each, in which all coin data sets are listed together. This would make it possible to manage more than two electronic coin data sets per field entry and thus, for example, to split them into more than two coin data sets.

The checks by the monitoring register to verify whether a processing is final are already described above and are in particular:
Are the masked electronic coin data sets of the predecessor column(s) valid?
Does a monitoring result in the correct check value?
Are the range proofs for the masked electronic coin data sets successful?
Is the signature of the masked electronic coin data set a valid signature of the issuing instance?
Does the sending/receiving participant unit (pseudonym) exceed a limit for a maximum allowable monetary amount, especially per time unit?
Is the coin data set Inactive due to transmitting between participant units?

Preferably, a masked electronic coin data set is also invalid if any of the following checks apply, i.e. if:
(1) the masked electronic coin data set is not registered in the coin register;
(2) the last processing of the masked electronic coin data set indicates that there are predecessor coin data sets for it, but this last processing is not final; or
(3) the last processing of the masked electronic coin data set indicates that there are successor coin data sets for it and that last processing is final;
(4) the masked electronic coin data set is not the successor to a valid masked electronic data set, unless it is signed by the issuing instance;
(5) the monetary amount of the masked electronic coin data set causes a limit for a maximum allowable monetary amount, in particular per time unit, to be exceeded and the requested de-anonymisation is rejected by the relevant participant unit;
(6) An active status for a security element is entered in the coin register, but another participant unit requests an action (switching, combining, splitting) under possession notification.

Preferably, the payment system is adapted to perform the above method and/or at least one of the embodiments.

Another aspect relates to a currency system comprising an issuing instance, a coin register layer, a first security element and a second security element, wherein the issuing instance is adapted to create an electronic coin data set. The masked electronic coin data set is adapted to be verifiably created by the issuing instance. The verification layer is adapted for executing a registration step as performed in the above method. Preferably, the security elements, i.e. at least the first and second security elements are adapted for executing one of the above methods (i) transmitting and (ii) generating+encrypting+initiating.

In a preferred execution of the currency system, only the issuing instance is authorised to initially create and finally withdraw an electronic coin data set. Processing, for example the step of connecting, splitting and/or switching, can and preferably is performed by a participant unit. Preferably, the processing step of deactivating can only be executed by the issuing instance.

Preferably, the coin register, the monitoring register and the issuing instance are arranged in a common server instance or are present as a computer program product on a server and/or a computer.

Preferably, the transaction register is located in, or is a computer program product on, a server instance different from the common server instance.

An electronic coin data set can exist in a variety of different forms and can thus be exchanged via different communication channels, hereinafter also referred to as interfaces. A very flexible exchange of electronic coin data sets is thus created.

The electronic coin data set can be represented in the form of a file, for example. A file consists of data that belong together in terms of content and are stored on a data carrier, data memory or storage medium. Each file is initially a one-dimensional string of bits that are normally interpreted as a group of byte blocks. An application programme (application) or an operating system of the security element and/or the terminal interpret this bit or byte sequence as, for example, a text, an image or a sound recording. The file format used for this can be different, for example it can be a plain text file representing the electronic coin data set. In particular, the monetary amount and the blind signature are represented as a file.

For example, the electronic coin data set is a sequence of American Standard Code for Information Interchange, or ASCII, characters. In particular, the monetary amount and the blind signature are mapped as this sequence.

The electronic coin data set can also be converted from one form of representation to another form of representation in a participant unit. For example, the electronic coin data set can be received as a QR code in a participant unit and output as a file or string by the participant unit.

These different forms of representation of one and the same electronic coin data set enable a very flexible exchange between participant units or security elements or terminals of different technical equipment using different transmission media (air, paper, wired) and taking into account the technical design of a participant unit. The choice of the presentation form of the electronic coin data sets is preferably made automatically, for example on the basis of recognised or negotiated transmission media and device components. In addition, a user of a participant unit can also choose the form of presentation for exchanging (=transmitting) an electronic coin data set.

In a simple case, the data memory is an internal data memory of the participant unit. This is where the electronic coin data sets are stored. Easy accessing of electronic coin data sets is thus ensured.

The data memory is in particular an external data memory, also called online memory. Thus, the security element or the participant unit has only one means of access to the externally and thus securely stored electronic coin data sets. In particular, if the security element or participant unit is lost or malfunctions, the electronic coin data sets are not lost. Since the ownership of the (non-masked) electronic coin data sets is equal to the ownership of the monetary amount, money can be saved and managed more securely by using external data memories.

If the coin register is a remote instance, the participant unit preferably has an interface for communication using a common internet communication protocol, for example TCP, IP, UDP or HTTP. The transmitting may involve communication over the cellular network.

In a preferred embodiment, the interface for outputting (=sending) the at least one electronic coin data set is a protocol interface for wirelessly sending the electronic coin data set to the other security element via a participant unit using a wireless communication protocol. In particular, a near-field communication, for example by means of Bluetooth protocol or NFC protocol or IR protocol, is provided; alternatively or additionally, WLAN connections or mobile radio connections are conceivable. The electronic coin data set is then adapted according to the protocol properties or integrated into the protocol and transmitted.

In a preferred embodiment, the interface for outputting the at least one electronic coin data set is a data interface for providing the electronic coin data set to the other participant unit by means of an application. In contrast to the protocol interface, the electronic coin data set is transmitted by means of an application. This application then transmits the electronic coin data set in a corresponding file format. A file format specific to electronic coin data sets can be used. In its simplest form, the coin data set is transmitted as an ASCII string or as a text message, for example SMS, MMS, instant messenger message (such as Threema or WhatsApp). In an alternative form, the coin data set is transmitted as an APDU string. A wallet application may also be provided. In this case, the exchanging participant units preferably ensure that an exchange is possible by means of the application, i.e. that both participant units have the application and are ready to exchange.

In a preferred embodiment, the participant unit further comprises an interface for receiving electronic coin data sets.

In a preferred embodiment, the interface for receiving the at least one electronic coin data set is an electronic capture module of the security element or terminal, arranged to capture an electronic coin data set presented in visual form. The capture module is then, for example, a camera or a barcode or QR code scanner.

In a preferred embodiment, the interface for receiving the at least one electronic coin data set is a protocol interface for wirelessly receiving the electronic coin data set from another security element or terminal by means of a communication protocol for wireless communication. In particular, near-field communication, for example by means of Bluetooth protocol or NFC protocol or IR protocol, is provided. Alternatively or additionally, WLAN connections or mobile radio connections are conceivable.

In a preferred embodiment, the interface for receiving the at least one electronic coin data set is a data interface for receiving the electronic coin data set from the other participant unit by means of an application. This application then receives the coin data set in a corresponding file format. A file format specific to coin data sets can be used. In its simplest form, the coin data set is transmitted as an ASCII string or as a text message, for example SMS, MMS, Threema or WhatsApp. In an alternative form, the coin data set is transmitted as an APDU string. Additionally, the transmitting can be done by means of a wallet application.

In a preferred embodiment, the participant unit comprises at least one security element reader arranged to read a security element; a random number generator; and/or a communication interface to a vault module and/or banking institution with accessing a bank account to be authorised.

In a preferred embodiment, the data memory is a shared data memory that can be accessed by at least one other participant unit, each of which comprises an application, said application being arranged to communicate with the coin register for corresponding registration of electronic coin records.

Thus, what is proposed here is a solution that issues digital money in the form of electronic coin data sets, which is modelled on the use of conventional (analogue) banknotes and/or coins. The digital money is represented here by electronic coin data sets. As with (analogue) banknotes, these electronic coin data sets can be used for all forms of payments, including peer-to-peer payments and/or POS payments. Knowing all the components (especially monetary amount and obfuscation amount) of a valid electronic coin data set is tantamount to owning (possessing) the digital money. It is therefore advisable to keep these valid electronic coin data sets confidential, e.g. to save them in a security element/vault module (of a terminal) and process them there. Elm to decide on the authenticity of an electronic coin data set and to prevent duplicate issues, masked electronic coin data sets are kept in the coin register as a unique corresponding public representation of the electronic coin data set. Knowing or having a masked electronic coin data set does not constitute possession of money. Rather, it is akin to verifying the authenticity of the analogue means of payment.

The coin register also contains, for example, flags on performed and planned processing of the masked electronic coin data set. The processing flags are used to derive a status of the respective masked electronic coin data set, indicating whether the corresponding (non-masked) electronic coin data set is valid, i.e. ready for payment. Therefore, a recipient of an electronic coin data set will first generate a masked electronic coin data set and have the coin register authenticate the validity of the masked electronic coin data set. A major advantage of this solution according to the invention is that the digital money is distributed to terminals, merchants, banks and other users of the system, but no digital money or further metadata is stored with the coin register or the monitoring register—i.e. common instances.

The proposed solution can be integrated into existing payment systems and infrastructures. In particular, there can be a combination of analogue payment transactions with notes and coins and digital payment transactions according to the present solution. Thus, a payment transaction can be made with banknotes and/or coins, but the change or change back is available as an electronic coin data set. For example, ATMs with a corresponding configuration, in particular with a suitable communication interface, and/or mobile terminals can be provided for the transaction. Furthermore, an exchange of electronic coin data set into banknotes or coins is conceivable. The steps of creating, switching, splitting, connecting and deactivating (returning) are each triggered by a corresponding creating, switching, splitting, connecting or deactivating command (return command).

### BRIEF SUMMARY OF FIGURES

In the following, the invention or further embodiments and advantages of the invention will be explained in more detail with reference to figures, the figures merely describing embodiments of the invention. Identical components in the figures are given the same reference signs. The figures are not to be regarded as true to scale, and individual elements of the figures may be shown in exaggeratedly large or exaggeratedly simplified form.

They show:

FIG. 1 a,b an embodiment example of a payment system according to the state of the art;

FIG. 2 an embodiment example of a payment system according to the invention;

FIG. 3 is a further development of the embodiment example of a payment system in FIG. 2;

FIG. 4a an embodiment example of a coin register of the payment system according to the invention in a first mode;

FIG. 4b an embodiment example of the coin register of the payment system according to the invention in a second mode;

FIG. 5 a further development of the payment system embodiment example of FIG. 2;

FIG. 6 an embodiment example of a method flow chart of a method according to the invention in a participant unit;

FIG. 7 an embodiment example of a method flow chart of a method according to the invention in a transaction register;

FIG. 8 an embodiment example of an encryption and decryption of a transaction data set;

FIG. 9 an alternative further development of the embodiment example of a payment system of FIG. 2;

FIG. 10 an embodiment example of a data structure in the coin register and monitoring register;

FIG. 11 an embodiment example of a system according to the invention for splitting and switching and directly transmitting electronic coin data sets;

FIG. 12 an embodiment example of a payment system according to the invention for connecting electronic coin data sets;

FIG. 13 an embodiment example of a method flow chart of a method according to the invention and corresponding processing steps of a coin data set;

FIG. 14 an embodiment example of a method flow chart of a method according to the invention and corresponding processing steps of a coin data set;

FIG. 15 an embodiment example of a security element according to the invention;

FIG. 16 a payment system according to the invention;

FIG. 17 an embodiment example of a sequence of payment operations according to the invention, monitoring the monetary amounts per participant unit; and

FIG. 18 an embodiment example of a sequence of a range confirmation according to the invention.

### FIGURE DESCRIPTION

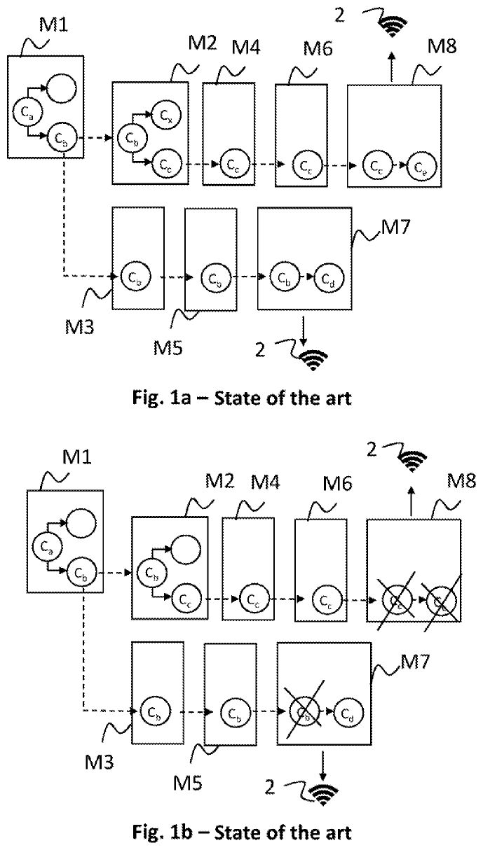

FIG. 1a and FIG. 1b show an embodiment example of a payment system BZ according to the prior art. These FIG. 1a and FIG. 1b are already described in the introduction to the description. Repeating, it is pointed out, that a terminal M8 wants to register the coin data set C_{c} as the coin data set Cₑ to the coin register 2 and the coin register 2 determines that the coin data set C_{b} is already invalid. As a result, the coin register 2 does neither accept either the supposedly valid coin data set C_{c} nor the coin data set Cₑ to be switched.

The problem can occur if, for example, an attacker with terminal M1 directly forwards a coin data set C_{b} (without permission) to two terminals M2 and M3. As soon as one of the two participants with terminal M2 registers the coin data set in coin register 2 (so-called coin change), the coin data set C_{b} becomes invalid. An unsuspecting subscriber with terminal M3 instead passes the coin data set C_{b} directly to terminal M5 without registering it. Only terminal M7 breaks the direct transmission chain and displays coin data set C_{b} at coin register 2. In parallel, the subscriber with terminal M2 splits coin data set C_{b} into coin data set C_{c} and Cₓ and passes C_{c} directly to terminal M4. Terminal M4 passes the coin data set C_{c} directly to terminal M6. Terminal M6 passes the coin data set C_{c} directly to terminal M8. Only when coin data set C_{c} is registered with coin register 2 can the invalidity of coin data set C_{b} and consequently the double spending be detected. Thus, an attack (double-spending of an electronic coin data set) of M1 is detected late in the prior art and a large number of direct transmissions have been executed in an unauthorised manner. In addition, due to the large number of transactions of an electronic coin data set and also due to the advancing life span, the risk increases that manipulation(s) have been carried out on the electronic coin data set.

Therefore, in a payment system, if a certain lifetime or number of actions on/with the coin data set is exceeded, the coin data set should expire, i.e. on the one hand, the number of direct transmitting of coin data sets should be limited and on the other hand, in case of a detected attack, it should be possible to trace who carried out the attack (here terminal M1). For the purpose of securing evidence, a method/system is described below in which transaction data of participant units (terminals or security elements) are archived in a remote transaction register and can be checked in the event of an official decision.

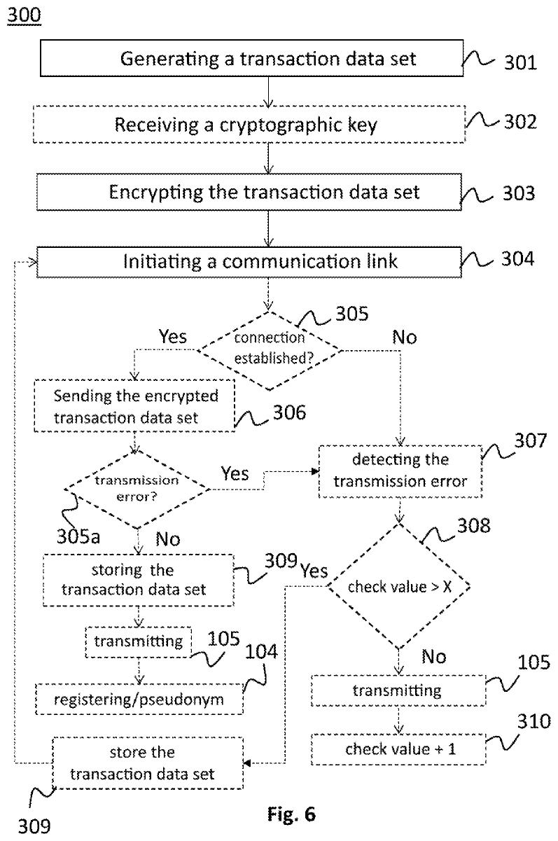

For this purpose, the payment system according to the invention comprises at least two, preferably a plurality of participant units TEs, which are also referred to or shown below as security elements SEx or terminals Mx, and a transaction register. The payment system may further comprise, for example, at least one issuing instance 1, one or more commercial banks, one (or more) central issuing register 2, which performs the registration of the coin data sets and checks and records the modifications to the coin data set. Further examples of payment systems according to the invention are shown in FIGS. 6, 7, 14 and 16.

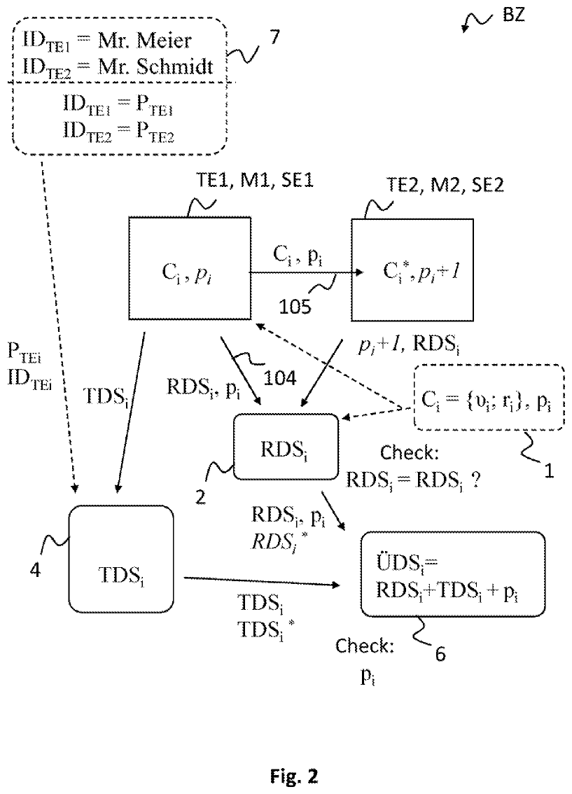

FIG. 2 shows an embodiment example of a payment system BZ according to the invention. The dashed blocks and arrows of the payment system BZ are optional. The payment system BZ comprises at least two security elements SE1 and SE2. The SE1 and SE2 can be inserted ready for use in respective terminals M1 and M2 and connected logically or physically to the respective terminal M1 and M2. A transaction register 4 of the payment system BZ is also shown.

In the payment system of FIG. 2, an issuing instance 1, for example a central bank, is optionally also provided, which generates the electronic coin data set C. In addition, a person allocation 7 is provided. A register data set RDS, for example a masked electronic coin data set Z, is generated for the electronic coin data set C and registered in a coin register 2 of the payment system 104. The electronic coin data set C is output by the issuing instance 1 to the first terminal M1 in step 102. The register data set RDS, for example the masked electronic coin data set Z, is output to the coin register 2 in step 104, for example by the issuing instance 1 directly or via the first terminal M1. The register data set RDS, for example the masked electronic coin data set Z, is alternatively generated by the first terminal M1 (or second terminal M2) and sent to the coin register 2 in step 104.

During a scheduled or already executed transmitting 105 of an electronic coin data set C, as will be described in further detail below, a transaction data set TDS is generated in the first terminal M1. The transaction data set TDS has a subscriber ID of the sending terminal M1, a subscriber ID of the receiving terminal M2, optionally a transaction number, optionally a monetary amount of the coin data set, optionally a masked coin data set Z corresponding to the electronic coin data set C (masking will be explained later), and optionally a transaction time. Each subscriber ID of a terminal is assigned to a natural person for payment purposes, which is carried out and also managed in the person assignment 7. This assignment 7 is only carried out after the person has been successfully identified by presenting an identity card or passport. This assignment 7 can be changed at the request of the person, for example when changing the participant unit or adding another participant unit.

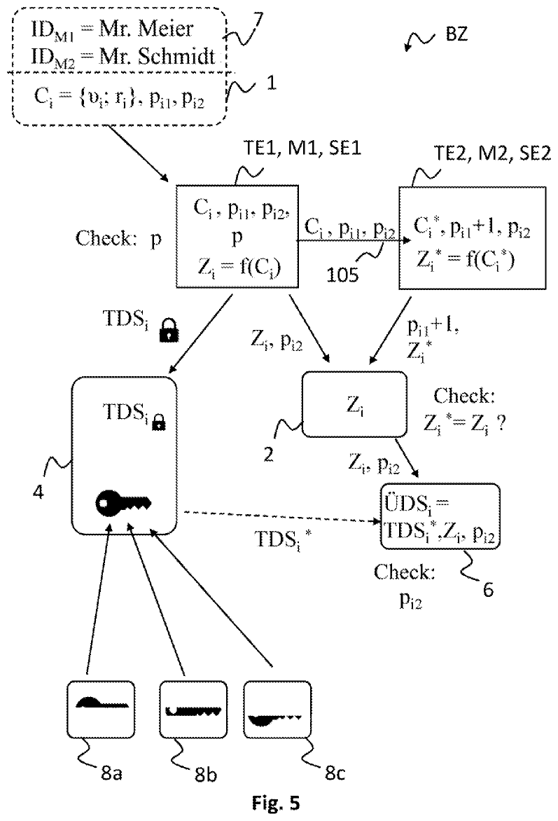

After generating the transaction data set TDS, it can be encrypted by the first terminal M1 with a cryptographic key, this is shown in more detail in FIG. 5.

As a result of the court decision, the transaction data can be read out

The payment system BZ of FIG. 2 thus introduces at least three different layers for coin record-based transmission. These layers process different tasks, have different stakeholders, different attack vectors and different implementations. Separating these specific tasks within the payment system FC into isolated layers reduces the complexity within each layer and makes the payment system more flexible, secure and resistant to attacks. The advantage of this multi-layered payment system BZ is that data relevant to data protection is strictly separated from the rest of the payment ecosystem and is only made accessible on the basis of strict organisational processes.

The payment system shown in FIG. 2 has a three-layer structure. In a first layer, the issuing instance 1, for example a central bank, is responsible for money creation and destruction, as will be explained later. Commercial banks (not shown) can store coin data sets C, for example in vault modules that are designed as highly secure modules, for example as HSMs. This layer distributes money to users and sends or receives money to/from the central bank.

The person allocation 7 is also arranged in this first layer. The issuing instance 1 can be reached by the TEs via an air interface, for example mobile radio or WLAN or NFC. The provision of participant units TE must meet regulatory requirements. Ultimately, all participant units TE should be provided by an instance that is authorised to issue participant units TE. In one embodiment, the person allocation (person register 7) is responsible for managing personal identities of users (natural persons). Technically, this can be realised by providing each participant unit with an individual key and a certificate signed by its intermediate or root CA (Certificate Authority). This means that only participant units TE signed by the root CA can establish a secure communication channel, and malicious or modified participant units TE with invalid keys are blocked. Through the unique serial number of each certificate, an association with a determined user can be established if the relationship between serial number and user are recorded in the person register 7.

In a second layer, the coin register 2, the monitoring register 6 and the transaction register 4 are provided. This layer is used for the secure operation of checking the coin data sets C, in particular the validity, the presence of the correct monetary amount and the authenticity of the circulating coin data sets C, and checks whether coin data sets C have been issued twice. This layer can be a “distributed network”. Up to this point in the second layer, the payment system BZ is completely private. By default, payment transactions are untraceable, i.e. anonymous. This applies both to the participant (payer, payee) and to the monetary amount (payment amount).

There are country-specific requirements regarding the traceability of the electronic coin data sets both in terms of the current coin levels in the participant units TE and the transactions already carried out (history). In order to set up a law enforcement system and/or, to allow anonymous—non-trustworthy participants in the payment system BZ, the transaction register 4 is provided. It is conceivable to decouple this transaction register 4 from the payment system BZ in order to follow the principle of “separation of concerns”. For the sake of simplicity, the transaction register 4 will be assigned to the second layer of the payment system BZ in the following. Information relevant for tracing a coin data set C is stored in a transaction register 4 (of the second layer) as a “trusted instance”, i.e. a trustworthy instance. The purpose of the transaction register 4 is to keep track of data elements (payer, payee, monetary amount) of payment transactions at the payment system 2 and to keep track of payments with the associated participant units TE, their monetary amounts and a transaction time among other information. The transaction register 4 can monitor transactions for various scenarios such as money laundering, terrorist financing or tax evasion, but also analyse the use of a single coin data set. Preferably, no personal information of a natural persons is stored in the transaction register, but only subscriber unit identifiers or their pseudonyms.

In case of suspicious activities, the participant unit can thus be identified. Optionally, participant units are not linked to natural persons in order to remain anonymous. Here, participation in the payment system is only permitted with limited functionality or restrictions on monetary amounts. Accessing the transaction register can be strictly controlled and the TDS stored there can be secured. The advantage of this set-up is that unauthorised tapping from the transaction register does not constitute procurement of money and thus the monetary amounts cannot be stolen. The transaction register 4, as a trusted instance, is responsible for protecting people's privacy in regular situations and disclosing (encrypted) transaction data sets TDS when required by court decisions or when requested by the monitoring register 6. This makes it possible to check that no irregular transactions or money operations are taking place, in particular that no (new) money is being illegally created or destroyed. On the one hand, the transaction register 4 represents an extension for use cases in law enforcement with the aim of uncovering suspicious transaction data. On the other hand, the transaction register 4 is an extension for use cases where participant units cannot or do not want to authenticate themselves with the coin register 2. The transaction register 4 stores (encrypted) data records about transactions TDS that are (have to be) reported by the participating units and passes them on to the authorities or the monitoring register 6 of the payment system BZ according to a proper method. The transaction register 4 may store the transaction data sets TDS in encrypted form. This ensures that due method must be followed and that no one can access this sensitive transaction data at will. In addition, a re-encryption unit can be used in the transaction register 4 to perform re-encryption of the TDS so that a law enforcement agency obtains access only to the officially authorised data. Metadata, such as transaction time and subscriber ID, is used to provide the requested data. The re-encryption unit of the transaction register 4 can access and decrypt all data.

The third layer is a direct transaction layer 3 in which all participants, i.e. consumers, merchants, etc., participate equally via their participant units TE to exchange electronic coin data sets C. Each participant unit TE may have a wallet application to manage coin data sets C. The coin data sets C can be stored locally in the participant unit TE or they can be stored in an online storage (=cloud storage) and the participant unit TE can manage them remotely. In the case of an offline scenario, where a transmission 105 takes place without control instances or register instances 2, 4, 6 of the payment system BZ, participant units TE can interact directly (directly) with other participant units TE. The actual data transmission for a coin data set may comprise further intermediary instances. This offline design of the payment system BZ requires that the coin data sets C are saved in certified areas, for example a wallet application, ideally within security elements SE, for example smart cards or an eSim environment, in order to obtain trustworthiness in the payment system BZ.

To generate an electronic coin data set C, the following method is proposed.

The transmitting 105 is done, for example, wirelessly via WLAN, NFC or Bluetooth, thus preferably locally. The transmitting 105 may be further secured by cryptographic encryption methods, for example by negotiating a session key or applying a PKI infrastructure. The transmitting 105 may also be performed involving an online data memory from which the electronic coin data set C is transmitted to the TE2 (M2, SE2).

In the transmission step 105, for example, a secure channel is established between the SE1 and the SE2, during which both SEs authenticate each other. The transmission path between SE1 and SE2 is not necessarily direct, but can be an Internet or near-field communication path with instances (terminals, routers, switches, applications) connected in between. By using SEs as a secure environment instead of terminals ME as TEs, a higher level of trust is generated, i.e. trustworthiness in the payment system BZ is increased. At the same time as the eMD C is sent, or immediately before or after, a timer is optionally started. Before this, the eMD C can be invalidated and then no longer be used by SE1 for actions (as described below). The eMD C is thus blocked in the payment system BZ due to a transmission process 105 that has already been initiated (and not yet completed). This prevents double spending. Invalidation enables easy handling during the transmission process 105.

When the eMD C is properly received in the SE2, a receipt confirmation is generated by the SE2 and sent back to the SE1. The receipt confirmation from the SE2 can be sent as a deletion request, because only after deletion of the eMD C in the SE1 can (may) the eMD C be validated and used in the SE2. Optionally, the deletion of the eMD C can be displayed by SE1. For example, an amount display of the SE1 (or of a terminal ME1 in which the SE1 is logically located) is updated. For example, the monetary amount of the eMD C is subtracted from an amount of the SE1 available for payment transactions. A deletion confirmation can be sent from the SE1 to the SE2. This serves as an acknowledgement that the eMD C is no longer available in SE1 and can therefore be validated in SE2. Upon obtaining the deletion confirmation in the SE2, the SE2 can convert a status of the eMD C in the SE2 into an active status, the eMD C is thus validated and can be used for further payment transactions or actions (splitting, combining, switching) in the SE2 from this point on. Optionally, the eMD C of the SE2 is switched to the SE2 in coin register 2 (see below), whereby the eMD C is registered to the SE2 (step 104).

A transmitting error 105 may be detected in the SE1, for example by exceeding a predefined time period, indexed by a timer, or by receiving an error message from the SE2 or the terminal M1 or the other terminal M2 (not shown). For example, with each new transmitting attempt for transmitting the eMD C (RETRY), a counter value can be incremented and, if a maximum permissible number of retries is exceeded, for example 10 or 5 or 3 times, it is decided in step 308 automatically and independently of the error case that no new transmitting attempt (RETRY) is carried out, but that the transmitting 105 is to be terminated as unsuccessful and a ROLLBACK is to be carried out.

In an alternative embodiment of the transmitting method 105, the status of the eMD is reported by the SE1 to the coin register 2. A connecting is then established with the coin register 2 for a status request to the eMD C. If the coin register 2 continues to report an inactive status back to the eMD C (registered to the SE1), no transaction error (tampering attempt) is assumed. However, if coin register 2 returns an active status to the eMD C or a registration to another SE, a transaction error (tampering attempt) is assumed and the payment system is alerted. The transaction data set TDS of the SE1 is used for proof.

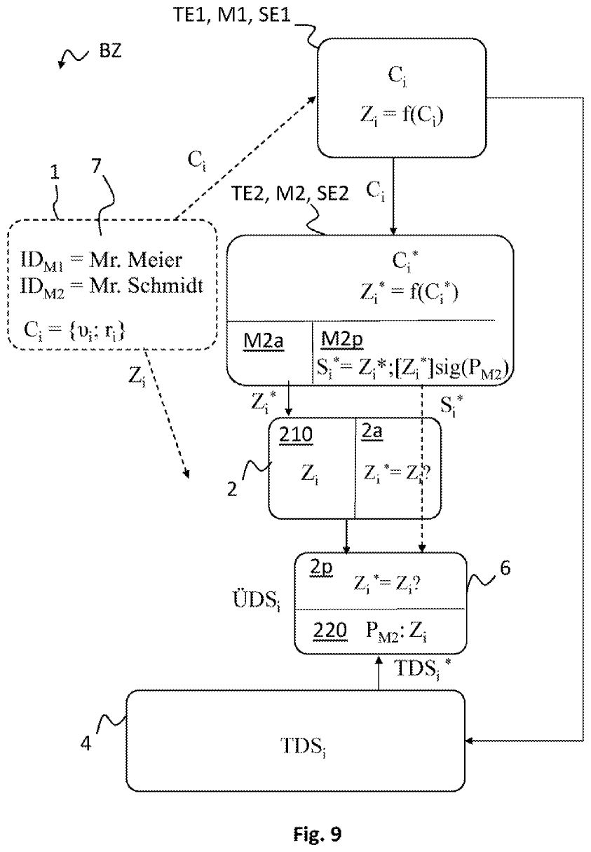

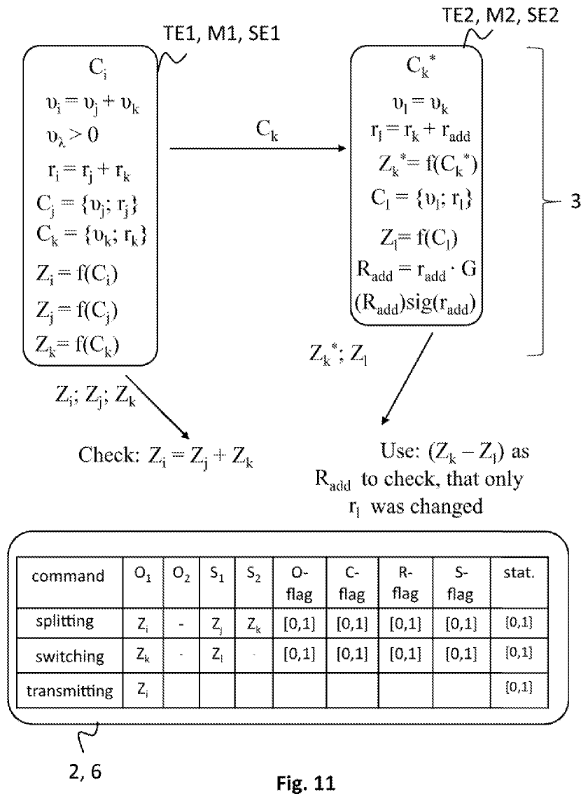

The electronic coin data set C may be requested in advance from an issuing instance 1 and optionally received by a terminal M (or an SE) or the issuing instance 1 or another payment system. Steps 104 and 105 may correspond to steps 104 and 105 of FIG. 11. An action (splitting, connecting, switching, transmitting, redeeming, switching) on the eMD C may correspond to any of the actions of FIGS. 9 to 12.

For example, a true random number is generated as the obfuscation amount rᵢ. The obfuscation amount rᵢ is known in the direct transaction layer 3 and also in the issuing instance 1, but is secret to the transaction register 4, the monitoring register 6 and the coin register 2. The obfuscation amount rᵢ is associated with a monetary amount νᵢ. Accordingly, an i-th electronic coin data set according to the invention could read:

Cᵢ={νᵢ;rᵢ} (1)

In addition to these data elements, the electronic coin data set C may comprise at least one check value. The check value represents, for example, the number of off-line transmissions (payment transactions) with this electronic coin data set. For example, the check value represents the number of offline transmissions (payment transactions) of the participant unit without performing registration.

In addition to these data elements, the electronic coin data set C may comprise a coin identifier M-ID. For example, the coin identifier is a unique number that is unique to the payment system BZ. For example, the coin identifier M-ID is a random number generated by the participant unit or the issuing instance 1.

A valid electronic coin data set can be used for payment. The owner of the two values νᵢ and rᵢ, is therefore in possession of the digital money. The digital money is defined by a pair consisting of a valid electronic coin data set Cᵢ and a corresponding masked electronic coin data set Zᵢ. A register data set, or RDS, is associated with the electronic coin data set.

For example, a masked electronic coin data set Zᵢ is obtained as RDS, by applying a homomorphic one-way function f (Cᵢ) according to equation (2):

Zᵢ=f(Cᵢ) (2)

This function f(Cᵢ) is public, i.e. any system participant can call and use this function. This function f(Cᵢ) is defined according to equation (3):

Zᵢ−νᵢ·H+rᵢ·G (3)

where H and G are generator points of a group G in which the discrete logarithm problem is hard, with generators G and H for which the discrete logarithm of the other basis is unknown. For example, G and H are generator points of an elliptic curve encryption, ECC—that is, private keys of ECC. These generator points G and H must be chosen in such a way that the context of G and H is not publicly known, so that if:

G=n·H (4)

the association n must be practically unlocatable to prevent the monetary amount νᵢ from being manipulated and yet a valid Zᵢ could be calculated. Equation (3) is a “Pederson commitment for ECC”, which ensures that the monetary amount can be committed to a coin register 2 without revealing it to the coin register 2.

Alternatively, the RDS may comprise an amount category in addition to the masked coin data set Zᵢ. The amount category is a pseudonymised form of the monetary amount νᵢ of the electronic coin data set C. For example, the amount category is a range (from to) in which the monetary amount νᵢ lies. For example, the amount category is a range threshold (greater than; less than) above or below which the monetary amount νᵢ lies. For example, the amount category is a rounded value of monetary amount νᵢ. For example, the amount category is a rounded up value of the monetary amount νᵢ. This makes the RDS amount pseudonymous and identity anonymous.

Alternatively, the RDS may comprise a coin identifier M-ID in addition to or instead of the masked coin data set Zᵢ. This creates a unique reference in the RDS to the electronic coin data set C.

Alternatively, the RDS may comprise a pseudonym P of the participant unit. The pseudonym may be managed in the person assignment 7. Thus, the RDS is amount-anonymous and identity-pseudonymous. In this embodiment, the RDS may comprise a check value p of the coin data set.

In the following, for simplicity, an RDS may be equated with a masked coin data set Z, as this is a highly preferred embodiment.

Therefore, only the RDS, for example the masked coin data set Zᵢ is sent (revealed) to the coin register 2, which is shown in FIG. 2 as step 104 (register, registration request).

Even though in the present example an encryption based on elliptic curves is described, another cryptographic method based on a discrete logarithmic method would also be conceivable.

Due to the entropy of the obfuscation amount rᵢ, equation (3) makes it possible to obtain a cryptographically strong Zᵢ even with a small range of values for monetary amounts νᵢ. Thus, a simple brute force attack by merely estimating monetary amounts νᵢ is practically impossible.

Equation (3) is a one-way function, which means that computing Zᵢ from Cᵢ is easy because an efficient algorithm exists, whereas computing Cᵢ starting from Zᵢ is very hard because no polynomial-time solvable algorithm exists.

Moreover, equation (3) is homomorphic for addition and subtraction, which means:

Zᵢ+Zⱼ=(νᵢ·H+rᵢ·G)+(νⱼ·H+rⱼ·G)=(νᵢ+νᵢ)·H+(rᵢ+rⱼ)·G (5)

Thus, addition operations and subtraction operations can be executed both in the direct transaction layer 3 and in parallel in the coin register 2 without the coin register 2 having knowledge of the electronic coin data sets C. The homomorphic property of equation (3) allows monitoring of valid and invalid electronic coin data sets Cᵢ based solely on the masked coin data sets Zᵢ and ensuring that no new monetary amount νⱼ has been created.

This homomorphic property allows the coin data set Cᵢ to be split according to equation (1) into:

Cᵢ=Cⱼ+Cₖ={νⱼ;rⱼ}+{νₖ;rₖ} (6)

Where it holds that:

νᵢ=νⱼ+νₖ (7)

rᵢ=rⱼ+rₖ (8)

For the corresponding masked coin data sets holds:

Zᵢ=Zⱼ+Zₖ (9)

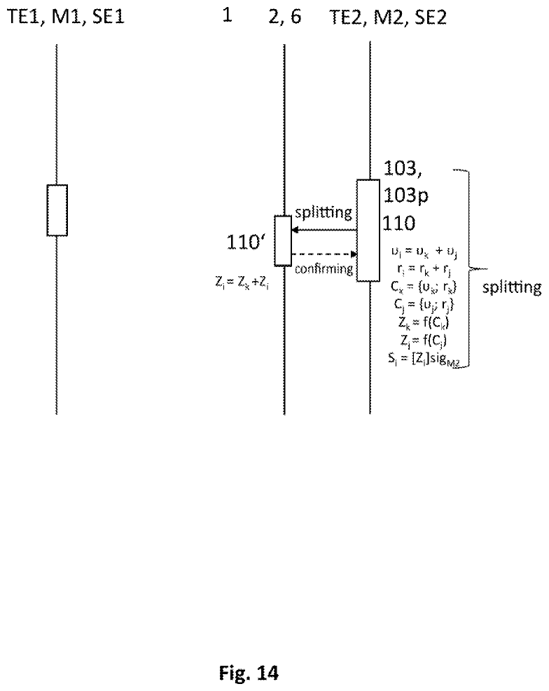

Equation (9) can be used, for example, to easily check a “symmetric or asymmetric splitting” processing or a “symmetric or asymmetric splitting” processing step of a coin data set according to FIG. 11 or 14 without the coin register 2 having knowledge of Cᵢ, Cⱼ, Cₖ. In particular, the condition of equation (9) is checked to validate split coin data sets Cⱼ and Cₖ and invalidate coin data set Cᵢ. Such splitting of an electronic coin data set Cᵢ is shown in FIG. 11 or 14.

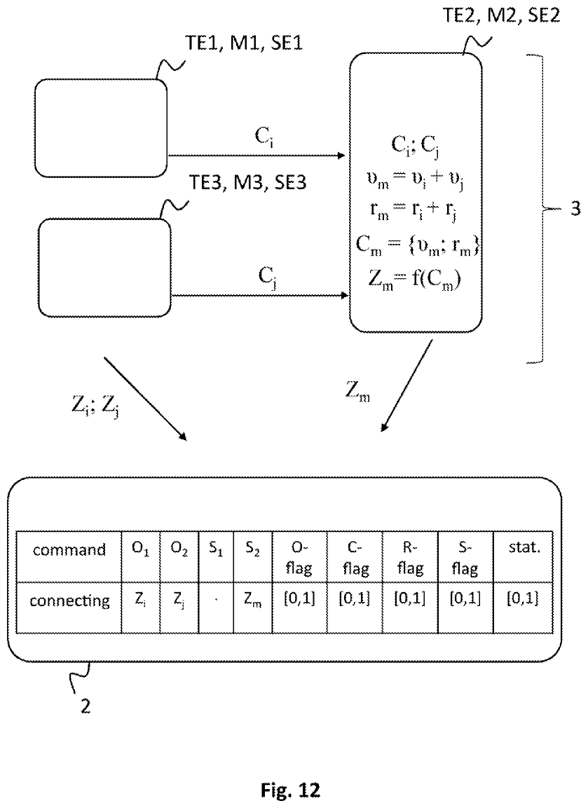

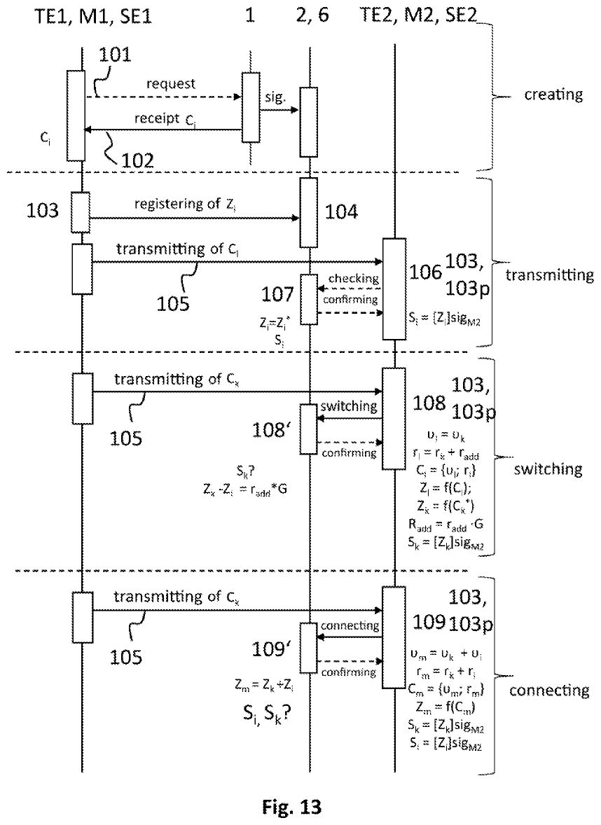

Electronic coin data sets C can also be joined (connected) in the same way, see FIG. 12 or 13 and the explanations.

In addition, it is important to check whether (not allowed) negative monetary amounts are registered. An owner of an electronic coin data set Cᵢ must be able to prove to the coin register 2 and/or a monitoring register 6 that all monetary amounts νᵢ in a processing operation are within a value range of [0, . . . , n] without informing the coin register 2 of the monetary amounts νᵢ. These range proofs are also called “range proofs”. Preferably, ring signatures are used as range proofs. For this example, both the monetary amount ν and the obfuscation amount r of an electronic coin data set C are resolved in bit representation. It holds:

νᵢ=Σaⱼ·2^{j} for 0≤j≤n and aⱼ∈{0;1} (9a)

As well as

rᵢ=Σbⱼ·2^{j} for 0≤j≤n and bⱼ∈{0;1} (9b)

For each bit, preferably a ring signature with

Cᵢⱼ=aⱼ·H+bⱼ·G (9c)

and

Cᵢⱼ−aⱼ·H (9d)

is preferably carried out for each bit, whereby in one embodiment it can be provided that a ring signature is only carried out for certain bits.

According to FIG. 2, at least one additional check value pᵢ₁ can be stored as a further data element in the electronic coin data set C. This check value pᵢ₁ is used to check the coin's authenticity. This check value pᵢ₁ is incremented during each direct transmission 105 of this electronic coin data set C between participant units TE1, TE2, i.e. terminals M1, M2 or security elements SE1, SE2 as participant units TE1, TE2.

In the payment system BZ, a counter value pᵢ₂ can also be maintained or determined to include the check value pᵢ₁, for example as the sum of the previous (registered) counter value pᵢ₂ and the check value pᵢ₁, to determine whether to return the coin data set C. Each action with coin data set C increases this counter value pᵢ₂. Different action types weight the counter value pᵢ₂ differently, so that, for example, a direct transmission of the coin data set C has a higher weight than a modification (splitting, combining, switching). In this way, the lifetime and the actions performed in it of a coin data set C are evaluated and criteria for its return are defined according to the actions performed. The check value pᵢ₁ and also the counter value pᵢ₂ map the life cycle of the coin data set C, which is then used to decide whether to return it.

In the payment system BZ, a check value p can also be provided in a participant unit TE (i.e. the terminals M1, M2 or security elements SE1, SE2 shown in FIG. 2), which represents the number of coin data sets C already transmitted without (directly) sending an encrypted transaction data set TDS to the transaction register 4. This check value p is compared with a threshold value X when a connection error is detected (in step 307 of FIG. 6). This determines whether a further (offline) transmission 105 may be performed (payment system preset) or not.

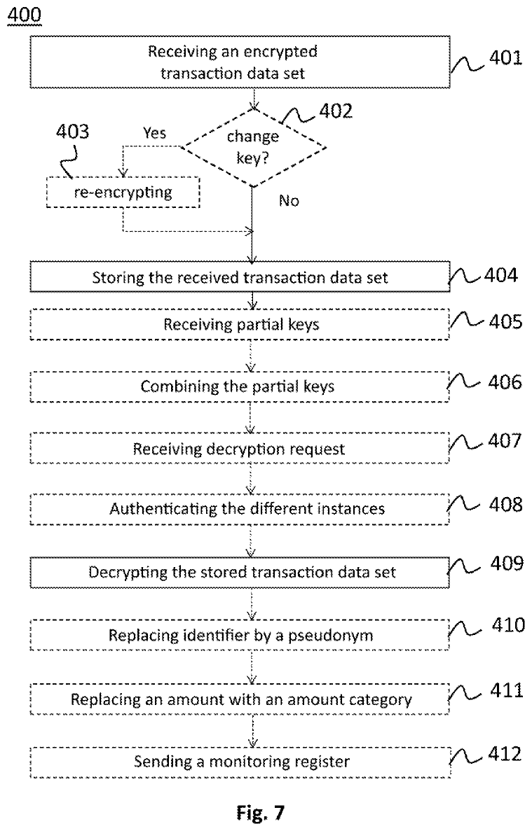

FIG. 2 shows the transaction register 4. The transaction register 4 is in communication link with the monitoring register 6 in order to register the RDS or anonymised or pseudonymised transaction data sets TDS* in the monitoring register 6. For this purpose, (according to step 410 of FIG. 7), for example, a participant unit identifier in the decrypted transaction data set TDS is replaced by a pseudonym P of the participant unit TE. Furthermore, (according to step 411 of FIG. 7), for example, in addition or alternatively (to step 410 of FIG. 7), a monetary amount in the transaction data set TDS is replaced by an amount category. This (steps 410 and/or 411 of FIG. 7) may be performed by an HSM in the transaction register 4. The pseudonymised transaction data TDS* and/or the amount categorised transaction data TDS* are sent (according to step 412 of FIG. 7) to the monitoring register 6 while the transaction data sets TDS generated by the participant unit TE are stored in the transaction register 4.

In FIG. 2, an RDS, for example a masked electronic coin data set Zᵢ, is calculated from the electronic coin data set Cᵢ using equation (3), for example in SE1, and this RDS is registered in a monitoring register 6 together with the check value pᵢ.

In SE2, the transmitted electronic coin data set Cᵢ is obtained as Cᵢ*. Upon obtaining the electronic coin data set Cᵢ*, the SE2 is in possession of the digital money represented by the electronic coin data set Cᵢ*. With direct transmission 105, it is available to the SE2 for further action.

Due to the higher trustworthiness when using SEs, SE1, SE2 can trust each other and in principle no further steps are necessary for transmitting 105. However, SE2 does not know whether the electronic coin data set Cᵢ* is actually valid. Further steps in the method may be provided to further validate transmitting 105, as explained below.

To check the validity of the obtaining electronic coin data set Cᵢ*, another RDS, for example the masked transmitted electronic coin data set Zᵢ*, can be calculated in SE2 using the—public—one-way function from equation (3). The RDS, for example the masked transmitted electronic coin data set Zᵢ*, is then transmitted to the coin register 2 in step 104 and searched for there. If both RDSs match with respect to the same coin data set C, for example a match with a registered and valid masked electronic coin data set Zᵢ, the validity of the obtaining coin data set Cᵢ* is displayed to the SE2 and it is valid that the obtained electronic coin data set Cᵢ* is equal to the registered electronic coin data set Cᵢ. In one embodiment, the validity check can be used to determine that the obtained electronic coin data set Cᵢ* is still valid, i.e. that it has not already been used by another processing step or in another transaction/action and/or has not been subject to further modification.

Preferably, a switching (=Switch) of the obtained electronic coin data set takes place afterwards.

The sole knowledge of an RDS, e.g. a masked electronic coin data set Zᵢ, does not authorise the issuing of the digital money of the corresponding electronic coin data set Cᵢ.

The sole knowledge of the electronic coin data set Cᵢ entitles for payment, i.e. to perform a transaction successfully, especially if the coin data set Cᵢ is valid, for example if the electronic coin data set Cᵢ has an active status. The status is preferably set to an active status only upon obtaining the deletion confirmation of the SE1. There is a one-to-one relationship between the electronic coin data sets Cᵢ and the corresponding masked electronic coin data sets Zᵢ. The masked electronic coin data sets Zᵢ are registered in the coin register 2, for example a public database. This registration 104 first makes it possible to check the validity of the electronic coin data set Cᵢ, for example whether new monetary amounts have been created (in an illegal manner).

The masked electronic coin data sets Zᵢ are stored in the coin register 2. All processing on the electronic coin data set Zᵢ is registered there or in the monitoring register 6, whereas the actual transmitting of the digital money takes place in a (secret, i.e. not known to the public) direct transaction layer 3 of the payment system BZ. Moreover, in this payment system BZ, monitoring operations on the coin data set C and the participant unit TE can be recorded in a monitoring register 6.

To prevent multiple issuance or to ensure more flexible transmitting 105, the electronic coin data sets C can be modified. Table 1 below lists exemplary operations, with the specified command also executing a corresponding processing step:

TABLE 1
Number of operations that can be performed per processing
of a C in the TE or the issuing instance

| command | create | create random | create | create range |
|---|---|---|---|---|
| or step | signature | number | masking | proof |
| generating | 1 | 1 | 1 | 0 or 1 |
| returning | 1 | 0 | 1 | 0 or 1 |
| splitting | 1 | 1 | 3 | 0 or 1 |
| connecting | 1 | 0 | 3 | 1 |
| switching | 1 | 1 | 2 | 1 |

Other operations not listed in table 1 may be required, such as changing the currency or redeeming the monetary amount in an account. Instead of the implementation listed, other implementations are also conceivable that imply other operations. Table 1 shows that for each coin data set, each of the processing operations (modifications) “generating”, “returning”, “splitting”, “connecting” and “switching” may provide for different operations “create signature”; “create random number”; “create masking”; “range check”, each of the processing operation being registered in the coin register 2. Alternatively and preferably, each of the processing operation is appended in the monitoring register 6 in invariant form to a list of previous processing operations for masked electronic coin data sets Zᵢ. The monitoring register 6 thus represents an archive for RDS concerning previous coin data sets. The operations of the processing operations “create” and “return” an electronic coin data set C are executed only at secure locations and/or only by selected instances, for example the issuing instance 1, while the operations of all other processing operations can be executed on the participant units TE, i.e. the terminals M or their security elements SE.

The number of operations for the individual processings is marked with “0”, “1” or “2” in Table 1. The number “0” indicates that a participant unit TE or the issuing instance 1 does not need to perform this operation for this processing of the electronic coin data set C. The number “1” indicates that the participant unit TE or the issuing instance 1 must be able to perform this operation once for this processing of the electronic coin data set C. The number “2” indicates that the participant unit TE or the issuing instance 1 must be able to perform this operation twice for this processing of the electronic coin data set.

In principle, in one embodiment, it can also be provided that an range check is also performed by the issuing instance 1 during generating and/or deleting.

Table 2 below lists the operations required for the coin register 2 and/or the monitoring register 6 for the individual processing operations:

TABLE 2
Number of operations that can be performed per processing of a C in the coin register

| | | | | | retrace homomorphic |
|---|---|---|---|---|---|
| | | check | check validity | | properties of |
| | check | signature | of masked | | masked electronic |
| command | signature | from security | electronic | retrace | coin data sets, i.e. |
| or step | from issuer | element | coin data set | range proof | adding or subtracting |
| generating | 1 | 0 | 0 | 0 or 1 | 0 |
| returning | 1 | 0 | 1 | 0 or 1 | 0 |
| splitting | 0 | 1 | 1 | 2 or more | 1 |
| connecting | 0 | 1 | 2 or more | 1 | 1 |
| switching | 0 | 1 | 1 | 1 | 0 |

Other operations not listed in table 2 may be required. Instead of the listed implementation, other implementations are conceivable that imply other operations. All operations of table 2 can be performed in the coin register 2, which is a trusted instance, for example a server instance, for example a distributed trusted server, which ensures sufficient integrity of the electronic coin data sets C.

Table 3 shows the preferred components to be installed for the system participants in the payment system of FIG. 1:

TABLE 3
Preferred units in the system components

| | | | coin |
|---|---|---|---|
| | | | register/monitoring |
| | issuing | participant | register/transaction |
| command or step | instance | unit | register |
| random number generator | yes | — | — |
| (high security) | | | |
| random generator | — | yes | —/—/yes |
| (deterministic) | | | |
| PKI for signing | yes | yes | —/—/yes |
| PKI for signature check | — | (yes) | yes |
| read access | yes | yes | yes |
| write access | yes | yes | yes |
| returning the electronic | yes | yes | — |
| coin data set | | | |
| transport encryption | yes | yes | —/—/yes |
| secure storage | (yes) | yes | —/—/yes |
| masking unit | yes | yes | — |
| range proof | — | yes | — |
| check range proof | — | — | yes/yes/— |

Table 3 shows an overview of the preferred components to be used in each system participant, i.e. the issuing instance 1, a participant unit TE and the register instances, namely the coin register 2, the monitoring register 6, the transaction register 4.

The participant units TE can be designed by means of an e-wallet for electronic coin data sets Cᵢ (with the check value p, pᵢ₁, pᵢ₂), i.e. as an electronic purse with a memory section in which a plurality of coin data sets Cᵢ can be stored, and thus be implemented, for example, in the form of an application on a smartphone or IT system of a trader, a commercial bank or another market participant. Thus, the components in the participant unit TE, as shown in table 3, are implemented as software. It is assumed that the coin register 2, the transaction register 4 and/or the monitoring register 6 are based on a server or on a DLT and are operated by a number of trusted market participants.

In the coin register 2, an RDS relating to the electronic coin data set C may be replaced by an RDS relating to the electronic coin data set C or a modified electronic coin data set C to be registered. Thus, (only) current coin data sets C—existing in the payment system BZ—are maintained as RDS in the coin register 2. Any previous versions or earlier modifications are then maintained, for example, in monitoring register 6 as monitoring data set ÜDS and are made available for this purpose from coin register 2 to monitoring register 6 during the replacement process and are saved there. This allows the history of the electronic coin data set C to be logged by the monitoring register 6. In this way, the coin register 2 is optimised in terms of register data records (=memory optimised) and reacts more quickly to registers or status requests from participant units TE and/or the monitoring register 6.

The monitoring register 6 stores monitoring data sets, or ÜDS for short, for this purpose. An ÜDS is formed from at least one TDS and at least one RDS in the monitoring register 6.

A ÜDS corresponds to exactly one electronic coin data set C and is formed from exactly one TDS, which also corresponds to the electronic coin data set, and exactly one RDS, which also corresponds to the electronic coin data set, in the monitoring register 6. This formation takes place after the TDS has been provided by the transaction register and the RDS has been provided by the coin register. A monitoring data set ÜDS relates to exactly one payment transaction.

In an alternative embodiment, a ÜDS may also concern a plurality of electronic coin data sets C, for example all electronic coin data sets C sent by a participant unit TEx within a predefined time period. In this context, an ÜDS is formed, for example, from a plurality of TDS concerning this participant unit TEx in the time period. In addition, the ÜDS is formed, for example, from several RDS relating to modifications to coin data sets C. The modifications are thereby initiated and/or requested and/or status checked by the TEx within the time period. Next, a ÜDS concerns a plurality of TDS (corresponding to respective electronic coin data sets C of this participant unit TE, preferably in this transaction time period) and at least one, preferably several register data sets RDS (also corresponding to the respective electronic coin data sets C of this participant unit TE, preferably in this transaction time period) formed in the monitoring register 6. A monitoring data set ÜDS then concerns several payment transactions of this participant unit TEx, preferably within a predefined time period.

After the respective monitoring data set ÜDS has been formed, the monitoring register 6 can evaluate the monitoring data set ÜDS. This evaluating concerns checking for double issuing of electronic coin data sets C or unauthorised generation of monetary amounts by a participant unit TE and/or also checking for ageing of electronic coin data sets C. By forming and evaluating in the monitoring register 6, it can be determined, for example, that a participant unit TE has issued a coin data set C twice or has changed a monetary amount. In addition, it can be determined that a coin data set C has not been used for a predefined period of time and this is communicated to the subscriber TE or an automatic return to the issuing instance 1 is initiated.

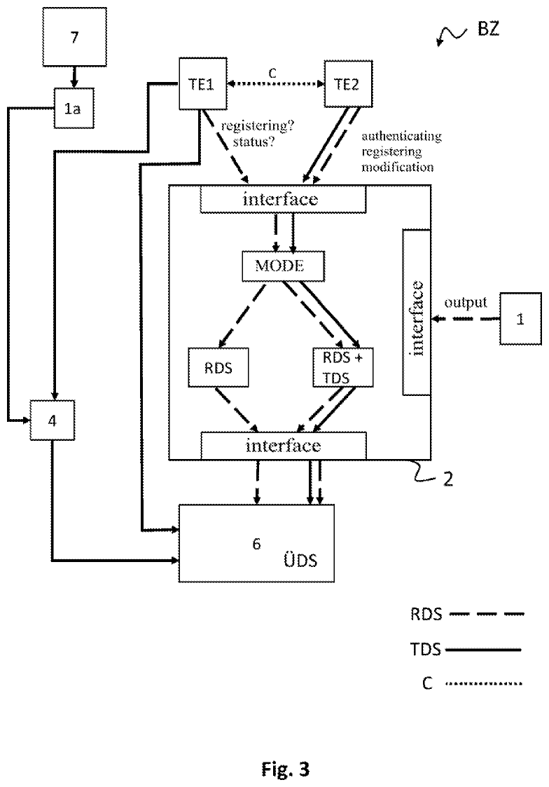

FIG. 3 shows a further development of the execution example of a payment system of FIG. 2.

Reference is made to the executions of FIG. 2 to avoid repetition. The embodiments of FIG. 3 can also be combined with the embodiments of FIG. 2.

In FIG. 3, the data flow of electronic coin data sets C, RDS, TDS and ÜDS in the payment system BZ is illustrated by different lines. The transmitting 105 of electronic coin data sets C is represented by a dotted line between two participant units TE. This transmission 105 represents a payment process (payment transaction) in the payment system BZ.

In addition, the sending of TDS in the payment system BZ is represented by a solid line. In principle, TDS are created by a TE and made available to the transaction register 4 (see FIGS. 6 to 8). In addition, the TDS can also be sent directly to a monitoring register 6. In one embodiment, a communication channel between the participant unit and the coin register 2 is used to send the TDS to the monitoring register. In this embodiment, the coin register 2 is prevented from accessing the TDS. In the monitoring register 6, the TDS and the RDS are then used to form the ÜDS.

In the payment system BZ, data elements that can lead to a TDS are also shown as a solid line. On the one hand, participant identifiers or pseudonyms P derived from them are kept in the person register 7 or a commercial bank 1a or a service server (not shown).

This mapping is then provided to the transaction register 4 to pseudonymise, for example, a TDS of a participant unit TE1 to provide a pseudonymised TDS* to the monitoring register 6. Pseudonymising a TDS will be explained in more detail with steps 410 and/or 411 of FIG. 7.

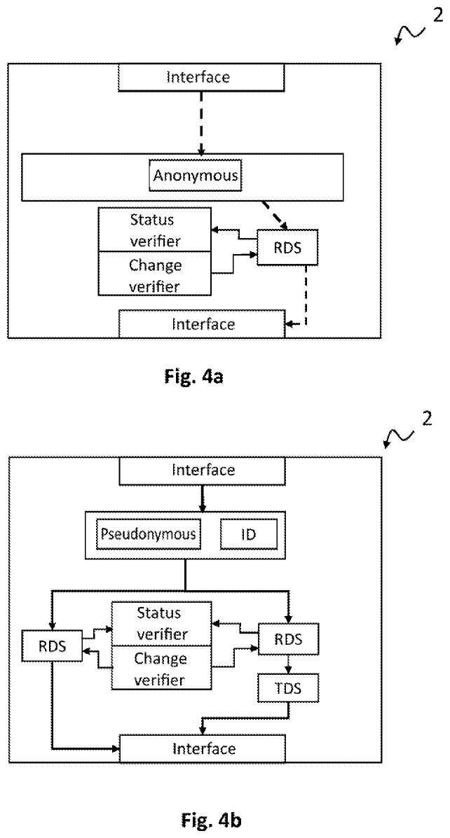

In one embodiment of the payment system BZ, a TE (in this case the TE2) authenticates itself to the coin register 2. During authentication, participant identifiers or pseudonyms P are queried. Thus, the coin register 2 is aware of participant identifiers and can use them in a second mode (FIG. 4b) to provide TDS to the monitoring register 6.

In an alternative embodiment of the payment system BZ, a TE (here the TE2) does not authenticate itself to the coin register 2. Thus, the coin register 2 is not aware of participant identifiers and only provides RDS to the monitoring register 6 in a first mode (FIG. 4a).

FIG. 3 shows the sending of RDS in the payment system BZ with a dashed line. In principle, RDS are generated by a TE and made available to the coin register 4 (according to FIG. 2). In addition, the RDS are provided to the monitoring register 6 in both modes of the coin register to check there the validity, status, modifications, check values and lifetime (return value) of an electronic coin data set C.

In one embodiment, an assignment of the person register 7 or the TE is made known to the coin register 2, for example, to pseudonymise an RDS to provide a pseudonymised RDS* to the monitoring register 6. Pseudonymising an RDS is similar to steps 410 and/or 411 of FIG. 7, but is independent of pseudonymising a TDS. In FIG. 3, three logical representatives of interfaces are shown for the coin register, an interface of the coin register 2 to the TE, an interface of the coin register 2 to the monitoring register 6 and an interface to the issuing instance 1. Not shown but conceivable is an interface to a transaction register 4 to forward TDS to the monitoring register 6. These interfaces can be physically designed as one interface and only logically separated.

A mode switch MODE in coin register 2 sets either the first mode of the coin register 2, in which only the RDS are provided to the monitoring register 6, or sets the second mode of the coin register 2, in which the RDS and the TDS are provided to the monitoring register 6. The TDS can be obtained from the authentication data.

FIG. 4a shows an embodiment example of a coin register 2 of the payment system BZ according to the invention in a first mode. In this case, the interface to the TE of the coin register 2 receives a registration and/or status request from the TE regarding an electronic coin data set C. It is determined that the TE has sent these requests anonymously. No authentication is performed, so the coin register 2 operates in the first mode. The registration requests may be verified by means of a status verifier and the TE may obtain a corresponding status message. Alternatively or additionally, further checks may be requested by means of status verifier and change verifier and an RDS may be provided to the monitoring register 6 for these purposes. The TDSs that may be required to verify the TE's requests are not provided by the coin register 2 and may, for example, be requested from the TE directly or from the transaction register 4 at the request of the monitoring register 6.

FIG. 4b shows an embodiment example of the coin register 2 of the payment system BZ according to the invention in a second mode. In this case, the interface to the TE of the coin register 2 receives a registration and/or status request from the TE regarding an electronic coin data set C. In this case, it is determined that the TE can/will authenticate itself to the coin register 2. Authentication is performed by requesting a participant identifier or pseudonym from coin register 2 and obtaining it from coin register 2. Successful authentication of the TE results in the coin register 2 operating in the second mode. To create the RDS, the registration requests may be checked using a status verifier and the TE may obtain a corresponding status message. Alternatively or additionally, further checks may be requested by means of a status verifier and a change verifier, and an RDS may be provided to the monitoring register 6 for these purposes. The TDS that may be required to verify the TE's requests are provided by the participant identifier provided with authentication or its pseudonym in combination with the RDS used by the coin register 2 to provide TDS to the monitoring register 6.

FIG. 5 shows a further development of the payment system embodiment example of FIG. 2. Reference is made to the explanations of FIG. 2 and FIG. 3 to avoid repetition. The embodiments of FIG. 5 can also be combined with the embodiments of FIG. 2. In FIG. 5, a masked electronic coin data set Z described above is used as the RDS. This is amount-anonymous and identity-anonymous.

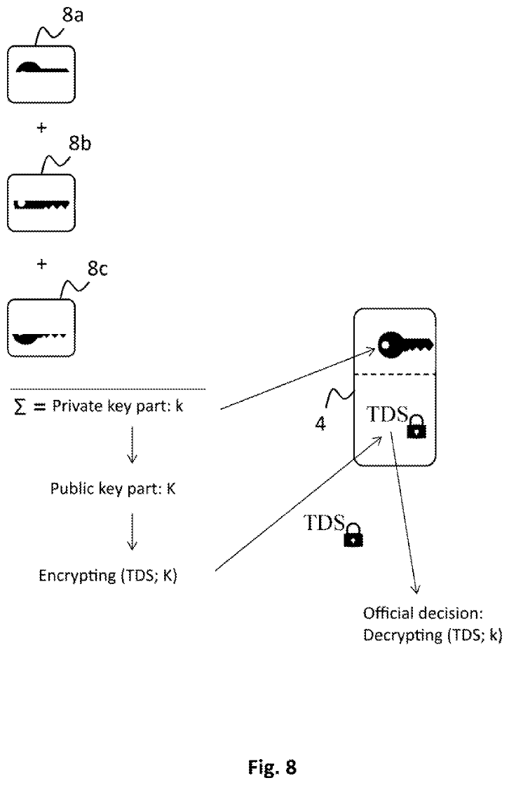

After generating the transaction data set TDS, it is encrypting by the first terminal M1 with a cryptographic key. This cryptographic key is, for example, a public key part of a corresponding composed private key part. This private key part is composed of three partial keys 8a, 8b, 8c, where the partial keys 8a, 8b, 8c have been added or XOR-associated, for example. This association of the partial keys 8a, 8b, 8c takes place either in the first terminal M1 or in the transaction register 4. This association of the partial keys 8a, 8b, 8c is, for example, secret throughout the system. Knowledge or possession of only one partial key 8a, 8b, 8c does not enable decryption of the transaction data set TDS. FIG. 8 shows an embodiment example for encrypting and decrypting a transaction data set TDS.

In FIG. 5, the encrypted transaction data set TDS is sent from the first terminal M1 to the transaction register 4 and stored there. The time of sending is preferably closely associated with the transmitting 105 of the electronic coin data set, so that the transaction register 4 is always up to date with the transactions carried out in the payment system BZ.

In cases of suspected fraud, an official order, for example a court order, could be issued to decrypt the encrypted transaction data set TDS in order to detect and analyse the transaction recorded with it (the transmitting 105). By means of the official order, for example, all stored transactions would then be queried at the transaction register 4 for a terminal M (by means of the identifier) over a determining time or period of time. In addition, further attributes of the transaction data, such as the monetary amounts of the coin data sets, the respective transaction partners, etc., could be queried.

As a result of the court decision, the transaction data can be decrypted by a plurality of remote instances as authorised parties generating (or providing) a decryption key by combining their partial keys. The remote instances are, for example, law enforcement agencies, notaries, the ministry of justice, a central bank or others. All remote instances (authorised parties) have only partial keys 8a, 8b, 8c of the decryption key. All members or a minimum number n of m remote instances are required to decrypt the transaction data set TDS together. Technically, the individual partial keys 8a, 8b, 8c of the different remote instances are composed into a common private key part by addition or by bitwise XORing. This private key part (which corresponds to the corresponding public key part of the encryption) is then used to decrypt the transaction data set TDS. This concept guarantees that no remote instance can decrypt the transaction data set TDS on its own and could thus bypass other instances. If the concept should not rely on the availability of all m remote instances, threshold cryptography could be applied to use a subset n of these partial keys 8a, 8b, 8c. This subset n then defines the minimum number of partial keys 8a, 8b, 8c to be combined.

In addition to identifying illegal activities, storing transaction data in the transaction register can perform the following additional tasks:
1. A monitoring of the movement and use of a coin data set: all information is stored in a transaction register 4, for example a large data memory available. The corresponding data analysis enables an adaptation of the behaviour of a central bank when issuing the coin data set.
2. The visibility of the coin data sets in circulation to control the offering: The issuing instance, for example a central bank, always knows the exact amount of coin data sets currently in circulation. It is thus possible to track and deactivate both participant units and coin data sets that have not participated in the payment system FC for a long period of time, for example 1 year, so as not to jeopardise the security of the payment system BZ.
3. Provision of monitoring information by commercial banks or service providers is not necessary anymore. This information is automatically provided at a transaction-based level by all participant units.

FIG. 6 shows an embodiment example of a method flow diagram of a method 300 in a participant unit TE, hereinafter also referred to as terminals M or security elements SE. The dashed blocks of the method 300 are optional. Each of these steps may involve subscriber interaction or at least subscriber information, for example via a GUI of the TE.

In step 301, a transaction data set TDS is generated. The transaction data set TDS comprises the participant identifiers from the first participant unit TE1 (sending TE) and from the second participant unit TE2. In addition, information about the electronic coin data set C to be transmitted (or the transmitted) is included, for example the monetary amount ν. Instead of the information about the electronic coin data set C to be transmitted (or the transmitted), the masked electronic coin data set Z can be inserted into the TDS. In addition, a transaction time may be included in the TDS to indicate the time of transmitting 105 the electronic coin data set C between both participant units TE. The time of generating 301 may be closely timed to the time of transmitting 105. The payment system BZ may require that the electronic coin data set C is transmitted first (step 105) before the encrypted transaction data set TDS is sent.

After the generating step 301, the generated transaction data set TDS is encrypted. For this purpose, the first participant unit TE1 has a public key part K composed of partial keys of different remote instances. The key composition is shown, for example, in FIG. 8. Alternatively, the participant unit TE1 receives a corresponding cryptographic key K in step 302, for example upon request of the key at the transaction register 4. The key K may be a key of a PKI structure or a symmetric key.

In step 303, the encrypting of the transaction data set TDS with the cryptographic key K in the first participant unit TE1 takes place, for example by an encryption module or a computing unit of the first participant unit TE1.

Not shown in FIG. 6 is an optional linking step of (plain text) metadata to the encrypted transaction data set TDS, for example an identifier of the first participant unit TE1, an identifier of the second participant unit TE2 and/or a transaction time. This metadata allows the encrypted TDS stored locally and/or in the transaction register 4 to be indexed or catalogued.

In step 304, a communication link to the transaction register 4 is then initiated. This attempts to establish a communication channel between the first participant unit TE1 and the transaction register 4. Initiating also comprises the respective participant unit TE detecting/knowing that an offline transaction is currently scheduled/performed and that a connecting to the remote transaction register 4 cannot or should not be established.

In the subsequent check step 305, the participant unit TE1 is queried whether a connection could be established in step 304. In the yes case of check step 305, the encrypted transaction data set TDS is sent to transaction register 4 in step 306. If necessary, other transaction data sets TDS from previous transmissions of electronic coin data sets C are also transmitted, should this communication link have been established for the first time since these transmissions. In this context, a check value is then also reset (not shown in FIG. 6) representing a number of transmissions of electronic coin data sets C that have occurred without sending a transaction data set TDS. In a check step 305a, if necessary, it is queried whether a transmission error occurred during sending 305 of the encrypted transaction data set TDS. In the no case of the check step 305a, the encrypted and/or the unencrypted transaction data set TDS is then optionally stored locally in the first participant unit TE2 for archiving purposes or for storing a history or for queries based on official requests. Subsequently, the electronic coin data set C is transmitted to the second participant unit TE2 in step 105 if it is a requirement in the payment system BZ that the encrypted transaction data set TDS is to be sent first before the electronic coin data set C may be transmitted in step 105. In one embodiment of the method 300, registering 104 of the masked electronic coin data set Z in the coin register 2 is mandatory after transmitting 105. In one embodiment of the method 300, a pseudonymised masked coin data set is registered in the coin register 2 or the monitoring register 6 in step 104 as described in FIGS. 9, 17 and 18.

In the no case of check step 305 (offline transaction, flight mode, no sending of transaction data TDS desired (by subscriber)) and also in the yes case of check step 305a (transmission error, disconnection), a connection error is detected in step 307. Following this, a check value p in the first participant unit TE1 is compared with a threshold value X in check step 308. The check value in step 308 represents a number of (offline) transmissions 105 of electronic coin data sets C that have occurred without sending a transaction data set TDS. These (offline) transmissions 105 from the first participant unit TE1 may have been transmitted to any other participant unit TEx. In the yes case of the check step 308, i.e. if this check value p is greater than the threshold value X, for example 100 or 50 or 10 transmissions, the transaction data set TDS is stored (encrypted and/or unencrypted) and it is mandatory to repeat step 304. In the no case of the checking step 308, transmitting 105 takes place if a default in the payment system BZ is that the encrypted transaction data set TDS must be sent first before the electronic coin data set C may be transmitted in step 105. In step 310, the check value p is then incremented, i.e. increased in steps, preferably by 1.

Steps 308 to 310 ensure that the off-line behaviour of the participant units TE remains monitored and is not possible to exceed a predefined determined (payment system predetermined) threshold value X of transmission numbers. Transaction data sets TDS of an offline transaction that cannot be transmitted immediately, i.e. a transmitting 105 without registering 104 or reporting to one of the register instances 2, 4, 6 of the payment system BZ, are temporarily stored in step 309 and transmitted at a later time. The number of offline transactions that a participant unit TE may perform is limited by the payment system and controlled by means of the check value p in step 308. If the threshold value X is reached, the transaction data sets TDS must first be sent before another offline transaction 105 is possible (see step 309 for step 304). This check value p may be recorded and maintained independently of other checks in the participant unit TE. This check value p can be combined with other check or count values pᵢ₁, pᵢ₂, of the coin data set C for checking in the coin register 2 or the monitoring register 6, see payment system BZ of FIG. 9.

Individual method steps can be interchanged. For example, a general first requirement in the payment system BZ can be that coin data sets C are first transmitted between TEs before a transaction data set TDS is created for them. In this case, a TDS would always relate to a coin data set C that has already been transmitted, and step 105 would be performed before the associated steps 301, 303.

Alternatively, a general first default in the payment system BZ can be that coin data sets C are only transmitted between TEs (step 105) after a transaction data set TDS has been created for it (step 301). In this case, a TDS would always concern a coin data set C that has yet to be transmitted, and step 105 would be carried out after the corresponding step 301.

A second general requirement in the payment system BZ could concern the local storage of TDS in the TE. Thus, it may be required that TDS are also to be stored locally (i.e. history or archiving). The storage step 309 is then not only to be provided for transmitting repetitions (in case of error of a first transmitting attempt). It may be a default detail that the TDS shall also be stored encrypted in the TE. This local storage of the TDS, which is redundant to the storage of the TDS in the transaction register 4, can be read out in the context of an official request (a court order), i.e. the participant can be forced to provide this local storage or the transmission of the local storage can take place in a (background) process of the participant unit TE without participant interaction.

A third general requirement in the payment system BZ can be to store pseudonymised TDS* in a monitoring register 6 of the payment system BZ. These pseudonymised TDS* are taken into account in the validity of the coin data sets in order to be able to detect fraud scenarios within the payment system. A fourth general requirement in the payment system FC can be not to send encrypted TDS to the transaction register 4 if an offline transaction is planned/carried out. This default can be closely coupled to the check value p, so that a participant unit TE issues a warning to the participant even before a transmitting mode (online or offline) is selected that a check value p has exceeded a threshold value for the maximum number of offline transmissions 105 and no further offline transmission is possible without first sending (old) TDS to the transaction register 4 (with resetting of the check value counter).

In FIG. 7, an embodiment example of a method flow diagram of a method 400 according to the invention in a transaction register 8 is shown. The dashed blocks of the method 400 are optional.

Here, in step 401, an encrypted transaction data set TDS is received from a participant unit TE in the transaction register 4. This transaction data set TDS has been generated according to the method shown in FIG. 6.

In the optional check step 402, it is checked whether different generations of partial keys are present in the payment system BZ, for example the transaction register 4, preferably an HSM module within the transaction register 4 as a key store. In the yes case of step 402, the transaction data set TDS is decrypted with the private key part k of the cryptographic key as decryption key in step 403 and re-encrypted with a cryptographic key, for example an HSM key of the transaction register 4. In this way, storing differently encrypted transaction data sets TDS encrypted with different key versions of the remote instances can be prevented in the transaction register 4. The administrative overhead in transaction register 4 is thus reduced.

After the re-encrypting step 403 or in the no case of the checking step 402, the transaction data set TDS is stored in a memory section and archived there. If applicable, the transaction data set TDS has metadata in plain text that is entered or kept track of in a database of the transaction register 4. For example, if a transaction time exists as a metadata of the TDS, a deletion time can be generated as part of a data retention. The TDS would then be automatically deleted from the transaction register 4 after a set period of time (the deletion time) has elapsed.

In the transaction register 4 (e.g. a database as a trusted instance), the TDS are stored in encrypted form, requiring multiple partial keys to decrypt them. This ensures that due method must be followed and that no one can access sensitive transaction data TDS at will.

Optionally, for example in the absence of a key store in the transaction register 4, partial keys of the cryptographic key k are received in step 405 and combined in step 406 in the transaction register 4, for example to form the private key part of the private key part when using a PKI key structure. The combination is secret, for example, so as not to allow owners of the partial keys 8a, 8b, 8c to combine the decryption key. The combined key may also be composed of only a subset of partial keys, which is possible by applying threshold value cryptography.

In the context of an official request—generated from outside the payment system BZ—in particular on the basis of a court order, a decryption request is made to the transaction register 4 in step 407. In this step, the metadata of the transaction data sets can be matched with parameters of the decryption request, for example to query all transaction data sets with a determining participant ID for a determining point in time or period of time. Subsequently, in step 408, each remote instance is requested to authenticate to the transaction register 4. Alternatively, only a required subset of remote instances necessary to decrypt the desired transaction data set(s) TDS is requested. In step 409, decryption is then performed using the combined key from the shared partial keys of the remote instances.

Optionally, in step 410, for example, even without step 407, a participant unit identifier in the decrypted transaction data set TDS is replaced by a pseudonym of the participant unit TE. The pseudonym preferably corresponds to the pseudonym of FIGS. 9, 17 and 18. This changes an anonymity level for the TDS so that the TDS can be used in unencrypted form for checking coin data sets in the monitoring register 6.

Optionally, in step 411, for example, even without step 407, a monetary amount in the decrypted transaction data set TDS is replaced with one or more amount categories in addition to or as an alternative to step 410. In one embodiment, for example, the monetary amount of the coin data set C is rounded up or down, for example:
monetary amount of 1.97 becomes the amount category “2 euros”
monetary amount of 878.99 becomes the amount category “1000 euros”
monetary amount of 4.07 becomes amount category “4 euros”
monetary amount of 2118.22 becomes the amount category “2000 euros”

In a further embodiment, the monetary amount is sorted into one or more amount categories that represent amount ranges, for example:
a monetary amount of 1.97 becomes the amount category “less than 10 euros”
monetary amount of 878.99 becomes the amount category “between 100 and 1000 euros”)
monetary amount of 4.07 becomes the amount category “greater than 1 euro”.

Steps 410 and/or 411 may be performed by an HSM in transaction register 4. The pseudonymised transaction data TDS* and/or the amount categorised transaction data is (re)sent to the monitoring register 6 or the participant unit TE in step 412. changed for the respective transaction data set. The encrypted transaction data set TDS is stored in the transaction register (step 404 after step 412, if applicable).

The pseudonymised transaction data set TDS* always has a higher level of anonymity than the (non-pseudonymised) transaction data set TDS. With this higher anonymity level, the pseudonymised transaction data set TDS*—in a default of the payment system BZ—can also be stored unencrypted in the coin register 2, monitoring register 6 and/or the transaction register 4 and used for further validity checks in the payment system BZ. This could improve the detection of cases of fraud or manipulation in the payment system BZ by the payment system BZ itself; a request by the authorities (court order) may then not be necessary.

The measures described here for pseudonymising or anonymising a TDS to obtain a pseudonymised TDS* or an anonymised TDS* can also be used for anonymising or pseudonymising register data sets RDS to obtain a pseudonymised RDS* or an anonymised RDS*.

Thus, according to the invention, different anonymity levels are provided for the RDS and the TDS. These anonymity levels may comprise, for example, 3 levels, such as level 1 (anonymous), level 2 (pseudonymous) and level 3 (open, non-anonymous, personalised). These levels can be set in the coin register 2 and/or the transaction register 4. These levels can be system requirements to be able to track coin data sets C without (or to be able to track) identities/amounts.

These anonymity levels apply in particular to the data element “participant identifier of the TE” in the respective RDS or TDS. Thus, each TDS or RDS can be either identity anonymous, identity pseudonymous and identity open. These anonymity levels apply in particular to the data element “monetary amount of coin data set C” in the respective RDS or TDS. Thus, each TDS or RDS can be either amount anonymous, amount pseudonymous and amount open.

These anonymity levels may vary within the RDS or TDS for different data elements. In addition, the anonymity level of a participant identifier (identity) may be different from an anonymity level of a monetary amount. Preferably, the anonymity levels of a participant identifier (identity) is less than from an anonymity level of a monetary amount to protect the identity of the participant in priority to the payment amount.

Preferably, the TDS for the participant identifier and/or monetary amount have a lower anonymity level than the RDS.

Amount-neutral register changes can also be made, whereby at least one RDS of an already registered coin data set is replaced in the coin register 2 by at least one RDS of a coin data set to be registered. Thus, the coin register 2 will only have RDS to electronic coin data sets currently available in the payment system BZ.

FIG. 8 shows an embodiment example of encryption and decryption of a transaction data set TDS. The remote instances 8a, 8b, 8c each have partial keys whose bitwise addition results in a private key part k of a cryptographic key (key pair). The private key part k is stored, for example, in a key store of the transaction register 4, for example a hardware security module of the transaction register 4.

The public key part K is derived from the private key part k and provided to the participant unit TE. The re-encryption step 303 in FIG. 6 of the generated transaction data set TDS or the re-encryption step 403 in FIG. 7 of the decrypted transaction data set TDS will then be done with the public key part K. This asymmetric crypto system must be able to ensure that the public key part K is indeed the key part derived from the combined private key part k and that this is not a forgery by an impostor. Digital certificates confirming the authenticity of the public key part K serve this purpose. The digital certificate can itself be protected by a digital signature. The transaction data set TDS encrypted with the public key part K is stored in the transaction register 4.

Before using the private key part k to decrypt the stored encrypted transaction data set TDS, the subset or all remote instances must authenticate themselves to the transaction register 4. If authentication is successful, the transaction data set TDS is decrypted using the private key part k.

The generated transaction data set consisting of, for example, a transaction number, a recipient address (here from TE2), a sender address (here from TE1) and a monetary amount of the eMD C. The generated transaction data set may also be used in TE1 to log the transmitting 105 to perform a reverse transaction (ROLLBACK) or a repetition (RETRY) of the transmitting 105 in the event of a transmitting error.

FIG. 9 shows an alternative embodiment to FIG. 5 of the execution example of a system of FIG. 2. Reference is made to the executions of FIG. 2 and FIG. 5 to avoid repetition. The embodiments of FIG. 9 can also be combined with the embodiments of FIG. 5.

FIG. 9 shows an example of a payment system BZ with terminals M1 and M2 (as examples of participant units TE), an issuing instance 1, a coin register 2, a monitoring register 6 and a transaction register 4. The terminals M1 and M2 can also be devices or security elements SE1, SE2.

The coin register 2 contains a register 210 in which only valid masked electronic coin data set Zᵢ is stored. The electronic coin data set Cᵢ represents a monetary amount νᵢ. The electronic coin data set Cᵢ is output to a first terminal M1. Electronic coin data sets Cᵢ, preferably for which a masked electronic coin data set Zᵢ is registered, can be used for payment. The masked electronic coin data set Zᵢ can also be referred to as an amount-masked electronic coin data set, since the monetary amount νᵢ for the coin register 2 is unknown (and also remains unknown in the further course). A receiver, here for example a second terminal M2, of the electronic coin data set Cᵢ can check its validity with the help of the coin register 2. The coin register 2 can confirm the validity of the electronic coin data set Cᵢ with the help of the masked electronic coin data set Zᵢ. For the coin register 2, the masked electronic coin data set Zᵢ is an anonymous electronic coin data set, especially since it does not know an owner of the associated electronic coin data set C. The anonymity level of a masked coin data set Zᵢ in the register 201 of the coin register 2 is therefore level 1 (completely anonymous).

FIG. 9 shows that the second terminal M2 sends masked electronic coin data sets Zᵢ* to the coin register 2 anonymously in an anonymous mode M2a, i.e., in particular, it sends only the masked electronic coin data set Zᵢ*. The coin register 2 processes the anonymously sent masked electronic coin data set Zᵢ* in an anonymous mode 2a, in which, for example, the second terminal M2 is only confirmed that the sent masked electronic coin data set Zᵢ* is valid.

The coin register 2 stores in the register 210 anonymous (amount) masked coin data sets Zᵢ of electronic coin data sets C of the issuing instance 1 or of modified electronic coin data sets of the terminals M.

FIG. 9 further shows that the second terminal M2 can also send masked electronic coin data sets Sᵢ* in a pseudonymised mode M2p to the monitoring register 6 via the coin register 2. For example, the second terminal M2 associates the masked electronic coin data set Zᵢ* with a pseudonym P_{M2} and sends the pseudonymised masked electronic coin data set Si* to the monitoring register 6 via the coin register 2. The second terminal M2 could generate a pseudonymised masked electronic coin data set Sᵢ* by attaching the pseudonym P_{M2} to the masked electronic coin data set Zᵢ*. In the embodiment shown, the second terminal M2 creates a signature over the masked electronic coin data set Zᵢ* and adds the signature to the coin data set Zᵢ*. The pseudonym P_{M2} can be, for example, the public key of the signature key pair. Alternatively, the pseudonym P_{M2} is a derivation from a participant identifier, such as terminal number, IMEI, IMSI or a similarly derived identifier.

The pseudonym P can be a derivative of the above-mentioned participant unit identifier. The pseudonym P may additionally be listed in the personal identifier 7 of the issuing instance 1 (or alternatively of a service provider, e.g. a wallet application provider or an online storage provider) next to the participant unit identifier. To protect the natural person, the pseudonym P can only be assigned to a natural person in a trusted instance, if applicable.

The monitoring register 6 processes the pseudonymously sent masked electronic coin data set S a pseudonymous mode 2p, in which it is also confirmed to the second terminal M2 that the sent masked electronic coin data set Zᵢ* is valid. However, the assignment of the masked electronic coin data set Zᵢ to the pseudonym PM 2 is additionally stored in a data structure 220 of the monitoring register 6. As will become clear in the further embodiments, the data structure 220 can be used as a register for masked electronic coin data sets Zᵢ still to be checked, i.e. it can also fulfil the function of a coin register 2. In pseudonymous mode 2p, the monitoring register 6 postpones or skips, in particular, a checking step performed in anonymous mode 2a (more frequently or always). In the checking step, it is checked—preferably further in ignorance of the monetary amount νᵢ—whether the monetary amount νᵢ of the masked electronic coin data set Zᵢ is within a range.

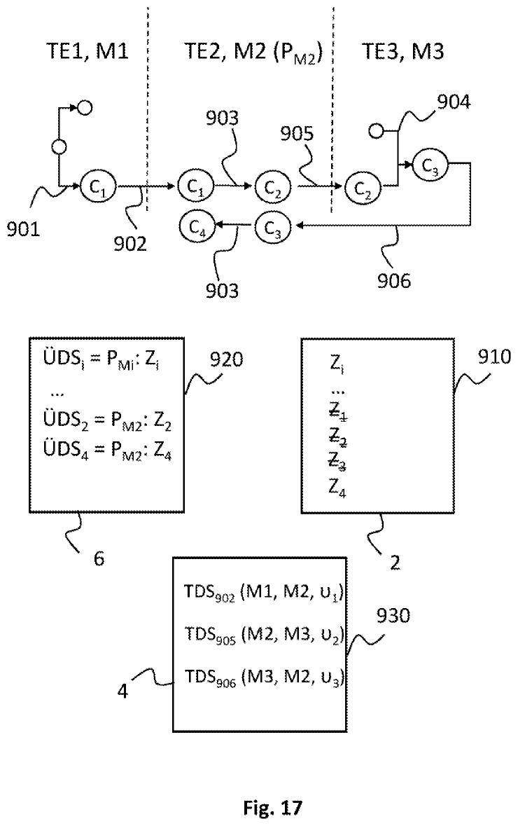

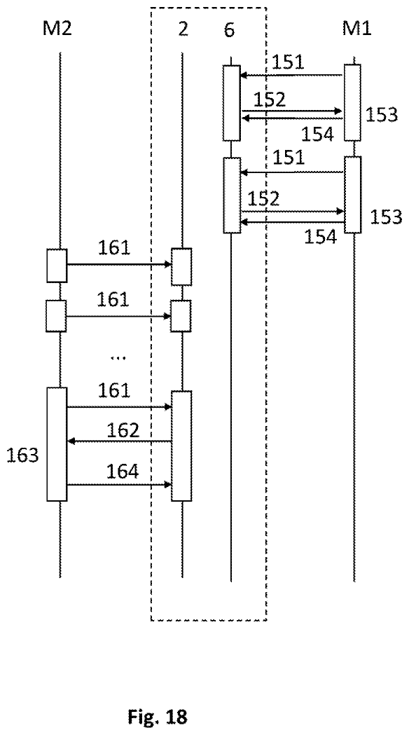

The aspects described below are based at least in part on details of this embodiment of FIG. 2, 3 or 5. The more complex pseudonymous mode 2p or M2p is primarily described there, since the simpler anonymous mode 2a or M2a runs without a pseudonym (or signature). FIGS. 17 and 18, on the other hand, describe embodiments that can only optionally be combined with the details of the other embodiments.

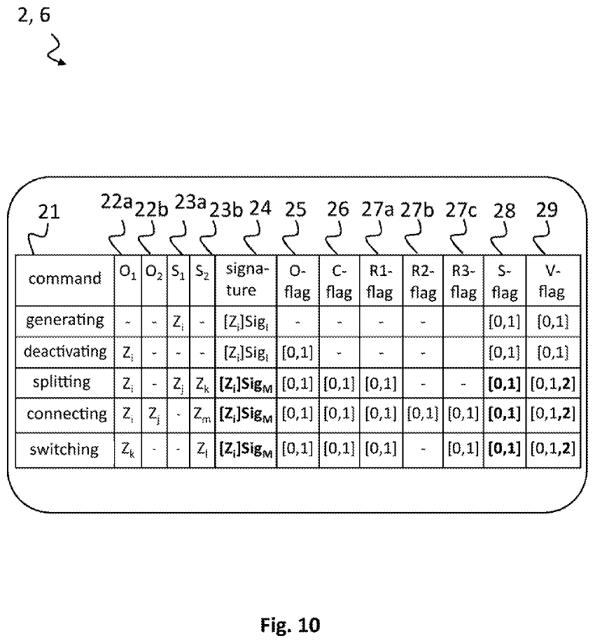

FIG. 10 shows a data structure for a coin register 2 and/or a monitoring register 6 of the preceding figures. In FIG. 10, data of the coin register 2 and/or the monitoring register 6 are shown together as a table in a common data structure for illustration purposes. The registers 2, 6 register the masked electronic coin data sets Zᵢ and their processing, if any. The coin register 2 and the monitoring register 6 can be housed in a common server instance and are only logically separated from each other in order to be able to reduce the computing effort for the individual checks by strict assignments. Alternatively, the registers 2, 6 are also physically separated from each other. Both registers 2, 6 are preferably located locally remote from the participant units TE and are housed in a server architecture, for example.

Each processing operation for a processing (creating, deactivating, splitting, connecting and switching) is registered in the coin register 2 and appended there, for example in unchangeable form, to a list of previous processing operations for masked electronic coin data sets Zᵢ. The individual operations and their check results, i.e. the intermediate results of a processing operation, are recorded in the coin register 2. Although a continuous list is assumed in the following, this data structure can also be cleaned or compressed, if necessary according to predetermined rules, or provided separately in a cleaned or compressed form.

The processing operations “creating” and “deactivating”, which concern the existence of the monetary amount νᵢ, per se, i.e. imply the creation and the destruction of money, require an additional authorisation by the issuing instance 1 to be registered (i.e. logged) in the coin register 2 and/or the monitoring register 6. The remaining processing operations (splitting, connecting, switching) do not require authorisation by the issuing instance 1 or by the command initiator (=payer, e.g. the first terminal M1). However, the other processing operations must be checked with regard to various check criteria.

A registration of the respective processing is realised, for example, by corresponding list entries in the database according to FIG. 10. These list entries are the RDS. Each list entry has further flags 25 to 28 which document the intermediate results of the respective processing which must be carried out by the coin register 2 and/or the monitoring register 6. Preferably, the flags 25 to 28 are used as an aid and are discarded by the coin register 2 and/or the monitoring register 6 after completion of the instructions.

For anonymous coin data sets, all checks must always be executed, so that all flags 25-28 could also be discarded. For pseudonymised coin data sets, on the other hand, a check can be omitted or executed later.

In FIG. 10, for example, the checks corresponding to flags 27b and 27c are not necessary for pseudonymised coin data sets because they are carried out later in a different form. The checking steps of flags 25, 26, 27a and 28, on the other hand, are necessary. In the following, we will refer in part to necessary or validity-relevant verification steps and to verifiable or validity-independent verification steps, since they are performed directly or indirectly. A coin data set can be treated as valid if the necessary checks have been carried out. The data in columns 24, 28 and 29 highlighted in bold in FIG. 10 are only relevant for coin data sets obtained pseudonymised and therefore primarily concern entries in the monitoring register 6.

An optional flag 29 can, for example, display the completion of processing. The flags 29 are in the state when a processing command is received, for example, and are set to the state “1” after all checks have been successfully completed (for flags 25-28) and are set to the state “0” if at least one check has failed. A (completion) flag 29 with the value “2” could display, for example, that only the necessary examinations were completed and that examinations that could be made up for were omitted. If checks for one or more entries are later made up by the terminal with the pseudonym, the flag can be set to the value “1”. Instead of using the completion flag 29 in this way, the flags 27b and 27c of the checks to be made up could of course also be used and/or a separate pseudonym flag could be used.

For example, a possible structure for a list entry of a coin data set comprises two columns 22a, 22b for a predecessor coin data set (O1, 02), two columns 23a, 23b for a successor coin data set (S1, S2), a signature column 24 for signatures of issuing entity (issuing entities) 1 and signatures of terminals M, and six marker columns 25, 26, 27a, 27b and 27c and 28. Each of the entries in columns 25 to 28 has three alternative states “−”, “1” or “0”.

Column 25 (O flag) displays whether a validation check was successful with regard to a predecessor electronic coin data set in column 22a/b. The “1” state indicates that a validity check revealed that the electronic coin data set of column 22a/b is valid and the “0” state indicates that a validity check revealed that the electronic coin data set of column 22a/b is invalid and the state “−” indicates that a validity check has not yet been completed. For multiple predecessor coin data sets, it is preferred to use a common O flag (both valid) rather than two separate O flags. Column 26 (C flag) displays whether an initial check calculation was successful for the masked electronic coin data sets. The first check calculation checks in particular whether the command is amount-neutral, i.e. primarily that the sum of the monetary amounts involved is zero. The state “1” means that a calculation was successful and the state “0” indicates that calculation was not successful and the state “−” displays that a calculation has not yet been completed.

For example, the calculation to be performed in column 26 is:

(Z_{O1}+Z_{O2})−(Z_{S1}+Z_{S2})==0 (10)

Column 27a (R1 flag) displays whether a first check of a range proof or the range proof was successful. The same applies to the other columns 27b (R2 flag) and 27c (R3 flag). The state “1” means that a validity check showed that the range proofs or the range evidence could or could not be retraced and the state “0” indicates that a validity check showed that the range proofs or the range evidence could not or could not be retraced and the state “−” indicates that a validity check is not yet completed, was not successful. The first range proof of column 27a is always necessary for the coin data set(s) to be considered valid. A typical example of a necessary check is the check that the monetary amount is not negative (or none of the monetary amounts are negative). The second and third range proofs do not affect the validity of the coin data set and can be made up for pseudonymised masked coin data sets, for example in a later transaction of the pseudonym. The range proof of column 27b is used to check whether the monetary amount of the masked coin data set (or each coin data set) is below a maximum amount. The maximum amount can be pre-determined system-wide or for specific terminal types. For example, the range proof of column 27c compares a sum of monetary amounts (sent or) received by the participant unit TE in a specified time period, such as 24 hours, against a sum limit, or checks, for example, a transaction count per time period for the participant unit TE, such as a maximum of 5 per minute or 100 per day. The limit values can be predefined by the payment system BZ system-wide or defined for specific participant unit types (i.e. participant unit-specific). For example, a coffee machine of type X can only dispense four portions of hot drinks per minute due to the device and accordingly only four coin transactions per minute are permitted.

The column 28 (S flag) displays whether a signature of the electronic coin data set matches the signature of column 24, where state “1” indicates that a validity check revealed that the signature could be identified as that of the issuing instance and state “0” indicates that a validity check revealed that the signature could not be identified as that of the issuing instance and the state “−” indicates that a validity check has not yet been completed.

A change in the status of one of the flags (also referred to as a “flag”) requires authorisation by the coin register 2 and/or the monitoring register 6 and must then be stored unalterably in the data structure of FIG. 10. Processing is final in anonymous mode (or for an anonymous masked coin data set) if and only if the required flags 25 to 28 have been validated by the coin register 6, i.e. changed from the “0” state to the “1” state or the “1” state after the appropriate check. Processing is completed in pseudonymous mode (or for a pseudonymised masked coin data set) when the checks to flags 25 to 27a and 28 have been performed by monitoring register 6.

In the following, a data structure without completion flag 29 is assumed and the validity of anonymous coin data sets is considered first. In order to determine whether a masked electronic coin data set Z is valid, the coin register 2 searches for the last change affecting the masked electronic coin data set Z. The coin register 2 then checks whether the masked electronic coin data set Z is valid. It holds that the masked electronic coin data set Z is valid if the masked electronic coin data set Z is listed for its last processing in one of the successor columns 23a, 23b, if and only if that last processing has the corresponding final flag 25 to 28. It also applies that the masked electronic coin data set Z is valid, provided that the masked electronic coin data set Z is listed for its last processing in one of the predecessor columns 22a, 22b, if and only if this last processing has failed, i.e. at least one of the corresponding required states of the flags 25 to 28 is set to “0”.

If the masked electronic coin data set Z is not found in the coin register 2, it is invalid. It is also true that the anonymous masked electronic coin data set Z is not valid for all other cases. For example, if the last processing of the masked electronic coin data set Z is listed in one of the successor columns 23a, 23b, but this last processing never became final, or if the last processing of the masked electronic coin data set Z is in one of the predecessor columns 22a, 22b and this last processing is final.

The checks made by coin register 2 and/or monitoring register 6 to determine whether a processing is final are represented by columns 25 to 28: The state in column 25 displays whether the masked electronic coin data set(s) are valid according to predecessor columns 22a, 22b. The state in column 26 indicates whether the calculation of the masked electronic coin data set according to equation (10) is correct. The state in column 27a indicates whether the range checks for the masked electronic coin data set Z could be successfully verified. The state in column 28 indicates whether the signature in column 24 of the masked electronic coin data set Z is a valid signature of issuing instance 1.

The state “0” in a column 25 to 28 thereby displays that the verification was not successful. The status “1” in a column 25 to 28 indicates that the verification was successful. The state “−” in a column 25 to 28 displays that no check was carried out. The states can also have a different value, as long as a clear distinction can be made between success/failure of a check and it is evident whether a determining check was carried out.

As an example, five different processes are defined, which are explained in detail here. Reference is made to the corresponding list entry in FIG. 10.

For example, one processing is “generating” an electronic coin data set Cᵢ. Generating in the direct transaction layer 3 by the issuing instance 1 involves selecting a monetary amount νᵢ and creating an obfuscation amount rᵢ, as described earlier with equation (1). As shown in FIG. 10, the “generating” processing does not require any entries/flags in columns 22a, 22b, 23b and 25 to 27. In the successor column 23a, the masked electronic coin data set Zᵢ is registered. This registration is preferably done before transmitting 105 to a participant unit TE, in particular or already during generation by the issuing instance 1, in both cases executing equation (3) for this purpose. The masked electronic coin data set Zᵢ is signed by the issuing instance 1 when it is generated, this signature is entered in column 24 to ensure that the electronic coin data set Cᵢ has actually been generated by an issuing instance 1, although other methods may also be used for this purpose. If the signature of a obtained Cᵢ matches the signature in column 24, the flag in column 28 is set (from “0” to “1”). The flags in columns 25 to 27 do not require a status change and can be ignored. The range proof is not needed because the coin register 2 and/or the monitoring register 6 can trust that the issuing instance 1 does not issue negative monetary amounts. However, in an alternative executing, it can be sent by the issuing instance 1 in the create command and checked by the coin register 2 and/or the monitoring register 6.

For example, one processing is “deactivate”. The deactivating, i.e. destroying money, causes the masked electronic coin data set Zᵢ to become invalid after successful executing of the deactivate command by the issuing instance 1. One can therefore no longer process the (masked) electronic coin data set to be deactivated in the coin register 2 and/or in the monitoring register 6. To avoid confusion, the corresponding (non-masked) electronic coin data sets Cᵢ should also be deactivated in the direct transaction layer 3. When “deactivating”, the predecessor column 22a is written to with the electronic coin data set Zᵢ, but no successor column 23a, 23b is occupied. The masked electronic coin data set Zᵢ shall be checked during deactivation to ensure that the signature matches the signature according to column 24 to ensure that the electronic coin data set Cᵢ has indeed been created by an issuing instance 1, again other means may be used for this check. If the signed Zᵢ sent in the deactivate command can be confirmed as signed by issuing instance 1, flag 28 is set (from “0” to “1”). The flags according to columns 26 to 27 do not require a status change and can be ignored. The flags according to columns 25 and 28 are set after appropriate verification.

A processing (modification) is, for example, “splitting”. Splitting, i.e. dividing an electronic coin data set Zᵢ into a number n, for example 2, of electronic coin data sets Zⱼ and Zₖ is first carried out in the direct transaction layer 3, as still shown in FIGS. 11, 13 and 14, whereby the monetary amounts νⱼ and the obfuscation amount rⱼ are generated. νₖ and rₖ are obtained by equations (7) and (8). In the coin register 2 and/or the monitoring register 6, the flags 24 to 27 are set, the predecessor column 22a is described by the electronic coin data set Zᵢ, successor column 23a is described by Zⱼ and successor column 23b is described by Zₖ. The status changes required according to columns 24 to 27 are made after the corresponding check by coin register 2 and/or monitoring register 6 and document the respective check result. The flag according to column 28 is ignored, especially in anonymous mode. A first range proof R1 according to column 27a must be provided, for example, to show that no monetary amount is negative. A second range proof R2 in column 27b is not necessary because the successor monetary partial amounts are always smaller than the initial monetary amount of the predecessor. A cumulative range entry R3 in column 27c is also usually not necessary (no new monetary amounts). Column 24 is used for the entry of a participant unit TE generated signature splitting the coin data set.

For example, one processing is “connecting”. Connecting, i.e. merging, two electronic coin data sets Zᵢ and Zⱼ into one electronic coin data set Zₘ is first performed in the direct transaction layer 3, as still shown in FIGS. 12 and 13, where the monetary amount νₘ and the obfuscation amount rₘ are calculated. In the coin register 2 and/or the monitoring register 6, the flags 25 to 28 are set, the predecessor column 22a is described with the electronic coin data set Zᵢ, predecessor column 22b is described with Zⱼ and successor column 23b is described with Zₘ. The flags in columns 25 to 28 require status changes and the coin register 2 and/or monitoring register 6 performs the corresponding checks. A first range proof R1 according to column 27a must be provided to show that no new money has been generated. A second range proof R2 in column 27b is useful, as the new monetary amount of the successor could be larger than a maximum value. A sum range proof R3 in column 27c is also usually useful, as the terminal could be using newly received predecessors. The flag according to column 28 can be ignored. Column 24 is used to generate an entry of a participant unit TE connecting the coin data set.

Another processing is, for example, “switching”. Switching is necessary when an electronic coin data set has been transmitted to another participant unit TE and re-issuing by the transmitting participant unit TE is to be prevented. During switching, the electronic coin data set Cₖ obtained from the first participant unit TE1 is exchanged for a new electronic coin data set Cᵢ with the same monetary amount. The new electronic coin data set Cᵢ is generated by the second participant unit TE2. This switching is necessary to invalidate (invalidate) the electronic coin data set Cₖ obtained from the first participant unit TE2, thus avoiding re-issuing the same electronic coin data set Cₖ. This is because, as long as the electronic coin data set Cₖ is not switched, since the first participant unit TE1 is aware of the electronic coin data set Cₖ, the first participant unit TE1 can pass this electronic coin data set Cₖ to a third participant unit TE. The switching is done, for example, by adding a new obfuscation amount r_{add} to the obfuscation amount rₖ of the obtained electronic coin data set Cₖ, thereby obtaining an obfuscation amount rᵢ that only the second participant unit TE2 knows. This can also be done in the coin register 2 or the monitoring register 6. To prove that only a new obfuscation amount r_{add} has been added to the obfuscation amount rₖ of the masked obtained electronic coin data set Zₖ, but the monetary amount has remained the same, and thus equation (11):

νₖ=νₗ (11)

holds, the second participant unit TE2 must be able to prove that Zₗ-Zₖ can be represented as a scalar multiple of G, i.e. as r_{add}*G. This means that only one obfuscation amount r_{add} has been generated and the monetary amount of Zₗ is equal to the monetary amount of Zₖ, i.e. Zₗ=Zₖ+r_{add}*G. This is done by generating a signature with the public key Zₗ-Zₖ=r_{add}*G.

The modifications “splitting” and “connecting” to an electronic coin data set can also be delegated from one participant unit TE1 to another participant unit TE, for example if a communication link to the coin register 2 and/or to the monitoring register 6 is not available.

FIG. 11 shows an embodiment example of a payment system BZ according to the invention for the actions of “splitting”, “connecting” and “switching” electronic coin data sets C. In FIG. 11, the first participant unit TE1 has obtained the coin data set Cᵢ and now wishes to perform a payment transaction not with the entire monetary amount νᵢ, but only with a partial amount νₖ. To do this, the coin data set Cᵢ is split. To do this, the monetary amount is first divided:

νᵢ=νₖ (12)

Each of the obtained amounts νⱼ, νₖ, must be greater than 0, because negative monetary amounts are not permitted.

In a preferred embodiment, the monetary amount νᵢ is split symmetrically into a number n of equally large partial monetary amounts νⱼ.

νⱼ=νᵢ/n (12a)

The number n is an integer greater than or equal to two. For example, a monetary amount of 10 units can be split into 2 partial amounts of 5 units (n=2) or into 5 partial amounts of 2 units each (n=5) or 10 partial amounts of one unit each (n=10).

In addition, new obfuscation amounts are derived:

rᵢ=rⱼ+rₖ (13)

When symmetrically splitting, an individual unique obfuscation amount rⱼ is formed in participant unit TE1 for each coin partial amount, where the sum of the number n of obfuscation amounts rⱼ of the coin data sets is equal to the obfuscation amount rᵢ of the split coin data set:

rᵢ=Σₖ₌₁ⁿr_{j_k} (13a)

In particular, the last obfuscation partial amount r_{j_n} is equal to the difference between the obfuscation amount rᵢ and the sum of the remaining obfuscation partial amounts:

r_{j_n}=rᵢ−Σₖ₌₁ⁿ⁻¹r_{j_k} (13b)

In this way, the obfuscation amounts r_{j_1} to r_{j_n-1} can be chosen arbitrarily and the rule of equation (13a) is satisfied by calculating the “last” individual obfuscation amount r_{j_n} accordingly.

For asymmetric splitting, masked coin data sets Zⱼ and Zₖ are obtained from coin data sets Cⱼ and Cₖ according to equation (3) and registered in coin register 2 and/or monitoring register 6. For splitting, the predecessor column 22a is described by the coin data set Zᵢ, the successor column 23a by Zⱼ and the successor column 23b by Zₖ. Additional information for the range proof (zero-knowledge-proof) is to be generated. The flags in columns 25 to 27 require status change and the coin register 2 and/or the monitoring register 6 performs the corresponding checks. The flag according to column 28 and the status according to column 29 are ignored.

In the case of symmetrical splitting, a signature is calculated in the respective participant unit TE. For this purpose, the following signature key sig is used for the kth coin part record C_{j_k}:

sig=rᵢ−n·r_{j_k} (13c)

Where n is the number of symmetrically split coin part records. In the case of symmetrical splitting, the signature of the k^{th} coinage record C_{j_k} can be verified according to (13c) with the following verification key Sig:

Sig=Zᵢ−n·Z_{j_k} (13d)

Where Z_{j_k} is the masked kth coin part record and n is the number of symmetrically split coin part records. This simplification results from the relationship with equation (3):

Zᵢ−n·Z_{j_k}=(νᵢ−n·ν_{j_k})·H|(rₗ−n·r_{j_k})·G (13e)

where, due to the symmetry properties of splitting, the following applies:

(νᵢ−n·ν_{j_k})·H=0 (13f)

so that equation 13e is simplified to:

Zᵢ−n·Z_{j_k}=(rᵢ−n·r_{j_k})·G (13g)

The simplification due to equation 13f makes it possible to completely dispense with zero-knowledge proofs, whereby the application of symmetrical splitting saves enormous computing power and data volume. Then, a coinage data set, here Cₖ is transmitted from the first participant unit TE1 to the second participant unit TE2. To prevent double spending, a switching operation is useful to exchange the electronic coin data set Cₖ obtained from the first participant unit TE1 for a new electronic coin data set Cₗ with the same monetary amount. The new electronic coin data set Cₗ is generated by the second participant unit TE2. The monetary amount of the coin data set Cₗ is taken over and not changed, see equation (11).

Then, according to equation (14), a new obfuscation amount r_{add} is added to the obfuscation amount rₖ of the obtained electronic coin data set Cₖ,

rₗ=rₖ+r_{add} (14)

thereby obtaining an obfuscation amount rᵢ known only to the second participant unit TE2. In order to prove that only a new obfuscation amount r_{add} has been added to the obfuscation amount rₖ of the obtaining electronic coin data set Zₖ, but that the monetary amount has remained the same (νₖ=νₗ), the second participant unit TE2 must be able to prove that Zₗ-Zₖ can be represented as a multiple of G. This is done by means of public signature r_{add} according to equation (15):

$$\begin{matrix}{R}_{add} = {r}_{add} \cdot G \\ = {Z}_{l} - {Z}_{k} = ( {v}_{l} - {v}_{k} ) * H + ( {r}_{k} + {r}_{add} - {r}_{k} ) * G\end{matrix} \qquad ( 15 )$$

where Cᵢ is the generator point of the ECC. Then the coin data set Cₗ to be switched is masked using equation (3) to obtain the masked coin data set Zᵢ. In the coin register 2 and/or the monitoring register 6, the private signature r_{add} can then be used to sign, for example, the masked to-be-switched electronic coin data set Zₗ, which is taken as proof that the second participant unit TE2 has only added an obfuscation amount r_{add} to the masked electronic coin data set and no additional monetary value, i.e. νₗ=νₖ.

The proof is as follows:

$$\begin{matrix}{Z}_{k} = {v}_{k} \cdot H + {r}_{k} \cdot G \\ {Z}_{l} = {v}_{l} \cdot H + {r}_{l} \cdot G = {v}_{k} \cdot H + ( {r}_{k} + {r}_{add} ) \cdot G \\ \begin{matrix}{Z}_{l} & {Z}_{k} = ( {r}_{k} + {r}_{add} - {r}_{k} ) \cdot G\end{matrix} \\ = {r}_{add} \cdot G\end{matrix} \qquad ( 16 )$$

FIG. 12 shows an example of a payment system according to the invention for connecting (also called combining) electronic coin data sets. Here, the two coin data sets Cᵢ and C are obtained in the second participant unit TE2. Following the splitting according to FIG. 11, a new coin data set Zₘ is obtained by adding both the monetary amounts and the obfuscation amount of the two coin data sets Cᵢ and Cⱼ. Then the obtained coin data set Cₘ to be connected is masked and the masked coin data set Zₘ is registered in the coin register 2. Then, when “connecting”, the signature of the second participant unit TE2 is entered as it has obtained the coin data set Cᵢ and Cⱼ.

When combined by the payment system BZ, the highest of the two individual check values of the respective electronic coin records Cᵢ and Cⱼ is determined. This highest check value is taken as the check value Cᵢ and Cⱼ of the combined electronic coin data set.

Alternatively, when combining (=connecting) by a payment system BZ, a new check value is determined from the sum of all check values of the electronic coin data records Cᵢ and Cⱼ divided by the product of the number (here two) of coin data records Cᵢ and Cⱼ with a constant correction value. The correction value is constant for the payment system. Preferably, the correction value is greater than or equal to 1. Preferably, the correction value is dependent on a maximum deviation of the individual check values of the electronic coin data sets Cᵢ and Cⱼ or on a maximum check value of one of the electronic coin data sets Cᵢ and C. Further preferably, the correction value is less than or equal to 2. This new check value is adopted as the check value of the combined electronic coin data set Cₘ.

FIGS. 13 and 14 each show an embodiment example of a method flow diagram of a method 100. FIGS. 13 and 14 are explained together below. In optional steps 101 and 102, a coin data set is requested and provided on the part of the issuing instance 1 to the first participant unit TE1 after the electronic coin data set is created. A signed masked electronic coin data set is sent to the coin register 2 and/or the monitoring register 6 in step 103. In step 103, masking of the obtained electronic coin data set Cᵢ is performed according to equation (3) and signing is performed in step 103p according to equation (3a). Then, in step 104, the masked electronic coin data set Zᵢ is registered in the coin register 2 or the monitoring register 6. Optionally, the participant unit TE1 can switch the obtaining electronic coin data set, in which case a signature Sᵢ would be registered in the coin register 2 or the monitoring register 6. In step 105, transmitting of the coin data set Cᵢ in the direct transaction layer 3 to the second participant unit TE2 takes place. In optional steps 106 and 107, a validity check with prior masking is performed, in which, in the good case, the coin register 2 and/or the monitoring register 6 confirm the validity of the coin data set Zᵢ or Cᵢ.

In the optional step 108, the switching of a obtained coin data set Cₖ (of course, the obtained coin data set Cᵢ could also be switched) to a new coin data set Cᵢ is then carried out, whereby the coin data set Cₖ becomes invalid and double spending is prevented. To do this, the monetary amount νₖ—of the transmitted coin data set Cₖ is used as the “new” monetary amount νₗ. In addition, as already explained with equations (14) to (17), the obfuscation amount rᵢ is created. The additional obfuscation amount r_{add} is used to prove that no new money (in the form of a higher monetary amount) was generated by the second participant unit TE2. Then the masked coin data set is signed and the signed masked coin data set Zᵢ to be switched is sent to the coin register 2 and/or the monitoring register 6 and the switching from Cₖ to Cₗ is instructed. In addition, a signature Sₖ is created by the first participant unit TE1 or the second participant unit TE2 and stored in the coin register 2 and/or the monitoring register 6. In addition or alternatively, a signature Sₗ could also be created and deposited in the coin register 2 and/or monitoring register 6 if sending participant units TE were registered instead of receiving participant units TE.

In step 108′, the corresponding check is made in coin register 2 and/or monitoring register 6, entering Zₖ in column 22a according to the table in FIG. 10 and the coin data set Zₗ to be rewritten in column 23b. A check is then made in coin register 2 and/or monitoring register 6 to see whether Zₖ is (still) valid, i.e. whether the last processing of Zₖ is entered in one of the columns 23a/b (as proof that Zₖ has not been further split or deactivated or connected) and whether a check for the last processing has failed. In addition, Zₗ is entered in column 23b and the flags in columns 25, 26, 27 are initially set to “0”. Now a check is made whether Zₗ is valid, whereby the check according to equations (16) and (17) can be used. In the good case, the flag in column 25 is set to “1”, otherwise to “0”. Now a check is made, the calculation according to equation (10) shows that Zₖ and Zₗ are valid and the flag in column 26 is set accordingly. Furthermore, it is checked whether the ranges are conclusive, then the flag is set in column 27. Then the signature Sₗ is verified with the corresponding public verification key present in the coin register 2 and/or the monitoring register 6 and logged accordingly. If all checks have been successful and this has been recorded accordingly in the coin register 2 and/or the monitoring register 6, the coin data set is considered switched. I.e. the coin data set Cₖ is no longer valid and from now on the coin data set Cₗ is valid. Double-issuing is no longer possible if a third participant unit TE inquires about the validity of the (double-spend) coin data set at the coin register 2 and/or the monitoring register 6. When verifying the signature, it is possible to check in pseudonymous mode whether the second participant unit TE2 has exceeded a monetary amount limit. The check is performed with respect to a time unit, for example a daily limit could be monitored with it. If the limit is exceeded, the coin register 2 and/or the monitoring register 6 first refuses to switch the coin data set Cₗ and requests the second participant unit TE2 to deanonymise. System-dependent deanonymised switching may be permitted.

In optional step 109, connecting two coin data sets Cₖ and Cᵢ to a new coin data set Cₘ is performed, invalidating the coin data sets Cₖ, Cᵢ preventing double spending. For this purpose, the monetary amount νₘ is formed from the two monetary amounts νₖ and νᵢ. For this purpose, the obfuscation amount rₘ is formed from the two obfuscation amounts rₖ and rᵢ. In addition, the masked coin data set Zₘ to be connected is obtained by means of equation (3) and this is sent (together with other information) to the monitoring register 6 and/or the coin register 2 and connecting is requested as processing. In addition, a signature Sₖ and a signature Sᵢ are generated and communicated to the monitoring register 6 and/or the coin register 2.

In step 109′, the corresponding check is made in the coin register 2 and/or the monitoring register 6. In the process, Zₘ is entered in column 23b according to the table in FIG. 10, which also corresponds to a transcription. A check is then made in the coin register 2 and/or the monitoring register 6 as to whether Zₖ and Zᵢ are (still) valid, i.e. whether the last processing of Zₖ or Zᵢ is entered in one of the columns 23a/b (as proof that Zₖ and Zᵢ have not been further split or deactivated or connected) and whether a check for the last processing has failed. In addition, the flags in columns 25, 26, 27 are initially set to “0”. Now a check is made whether Zₘ is valid, whereby the check according to equations (16) and (17) can be used. In the good case, the flag in column 25 is set to “1”, otherwise to “0”. Now a check is made, the calculation according to equation (10) shows that Zᵢ plus Zₖ equals Zₘ and accordingly the flag in column 26 is set. Furthermore, it is checked whether the ranges are conclusive, then the flag is set in column 27. When checking the signature, it can be checked whether the second participant unit TE2 has exceeded a limit value for monetary amounts. The check is made with respect to a time unit, for example, a daily limit could be monitored with it. If the limit is exceeded, the coin register 2 and/or the monitoring register 6 first refuses to connect the coin data set Cₘ and requests the second participant unit TE2 to deanonymise. De-anonymised connecting may then be permitted.

In optional step 110, an asymmetric splitting of a coin data set Cᵢ into two coin data sets Cₖ and is performed, whereby the coin data set Cᵢ is invalidated and the two asymmetrically split coin data sets Cₖ and Cⱼ are to be made valid. In an asymmetric splitting, the monetary amount νᵢ is split into monetary partial amounts νₖ and νⱼ of different sizes. For this purpose, the obfuscation amount rᵢ is split into the two obfuscation amounts rₖ and rⱼ. In addition, the masked coin data sets Zₖ and Zⱼ are obtained by means of equation (3) and sent to the coin register 2 and/or the monitoring register 6 with further information, for example the range checks (zero-knowledge-proofs), and the splitting is requested as processing. In addition, a signature Sᵢ is created and sent to coin register 2 and/or monitoring register 6.

In step 110′, the corresponding check is made in coin register 2 and/or monitoring register 6, with 4 and Zₖ being entered in columns 23a/b according to the table in FIG. 10. A check is then made in the monitoring register 6 and/or the coin register 2 as to whether Zᵢ is (still) valid, i.e. whether the last processing of Zᵢ is entered in one of the columns 23a/b (as proof that Zᵢ has not been further split or deactivated or connected) and whether a check for the last processing has failed. In addition, the flags in columns 25, 26, 27 are initially set to “0”. Now a check is made whether Zⱼ and Zₖ are valid, whereby the check according to equations (16) and (17) can be used. In the good case, the flag in column 25 is set to “1”. Now a check is made, the calculation according to equation (10) shows that Zᵢ is equal to Zₖ plus Zⱼ and accordingly the flag in column 26 is set. Furthermore, it is checked whether the ranges are conclusive, then the flag is set in column 27. When checking the signature, it can be checked whether the second participant unit TE2 has exceeded a limit value for monetary amounts. The check is made with respect to a time unit, for example, a daily limit could be monitored with it. If the limit is exceeded, the coin register 2 and/or the monitoring register 6 first refuses to split the coin data set Cᵢ and requests the second participant unit TE2 to deanonymise. De-anonymised splitting may then be permitted.

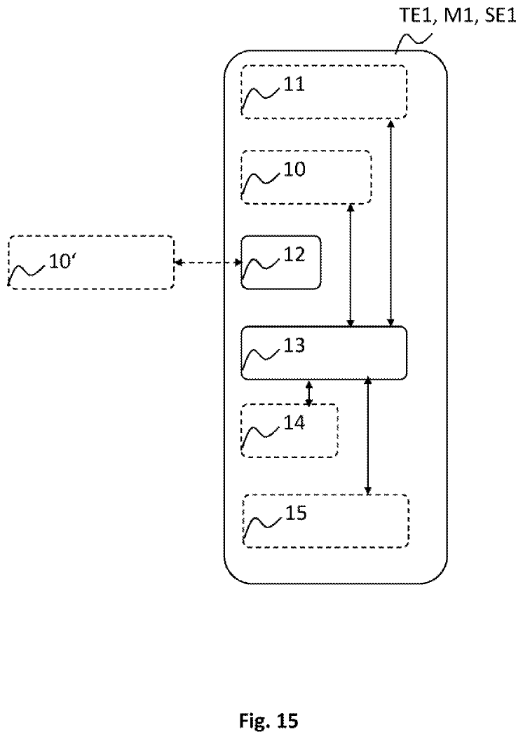

FIG. 15 shows an embodiment example of a first participant unit TE1 according to the invention. The first participant unit TE1 may be a device M1 in which a security element SE1 is inserted. For simplicity, the term device M1 will be used hereinafter. In the device M1, electronic coin data sets Cᵢ can be stored in a data memory 10, 10′. In this case, the electronic coin data sets Cᵢ may be located on the data memory 10 of the device M1 or may be available in an external data memory 10′. When using an external data memory 10′, the electronic coin data sets Cᵢ could be stored in an online memory, for example a data memory 10′ of a digital wallet provider. In addition, private data memory, for example a network-attached-storage, NAS in a private network could also be used.

In one case, the electronic coin data set Cᵢ is shown as a printout on paper. In this case, the electronic coin data set may be represented by a QR code, an image of a QR code, or may be a file or a string of characters (ASCII).

The device M1 has at least one interface 12 available as a communication channel for outputting the coin data set Cᵢ. This interface 12 is for example an optical interface, for example for displaying the coin data set Cᵢ on a display unit (display), or a printer for printing out the electronic coin data set Cᵢ as a paper printout. This interface 12 can also be a digital communication interface, for example for near field communication, such as NFC, Bluetooth, or an internet-enabled interface, such as TCP, IP, UDP, HTTP or accessing a smart card as a security element. For example, this interface 12 is a data interface such that the coin data set Cᵢ is transmitted between devices via an application, such as an instant messenger service, or as a file or string.

In addition, the interface 12 or another interface (not shown) of the device M1 is arranged to interact with the coin register 4. The device M1 is preferably online capable for this purpose.

In addition, the device M1 may also have an interface for receiving electronic coin data sets. This interface is arranged to receive visually presented coin data sets, for example by means of a capture module such as a camera or scanner, or digitally presented coin data sets, received via NFC, Bluetooth, TCP, IP, UDP, HTTP or coin data sets presented by means of an application.

The device M1 also comprises a computing unit 13 capable of performing the coin data set masking method and coin data set processing operations described above.

The device M1 is online capable and can preferably detect when it is connecting to a WLAN by means of a location detection module 15. Optionally, a specific WLAN network can be marked as preferred (=location zone) so that the device M1 executes special functions only if it is logged into this WLAN network. Alternatively, the location detection module 15 detects when the device M1 is in predefined GPS coordinates including a defined radius and performs the special functions according to the location zone thus defined. This location zone can be inserted into the unit M1 either manually or via other units/modules. The special functions that the device M1 performs when the location zone is detected are, in particular, transmitting electronic coin data sets from/to the external data memory 10 from/to a safe module 14 and, if necessary, transmitting masked coin data sets Z to the coin register 4 and/or the monitoring register 6, for example as part of the above-mentioned processing operations on a coin data set. The device M1 is thus arranged to execute the method according to FIG. 6. The device M1 is arranged to create and encrypt a transaction data set TDS. The device M1 is arranged to initiate a communication to a transaction register. The device M1 is arranged to send the encrypted transaction data set TDS to the transaction register. The device M1 is arranged to attach metadata (in plain text) to the transaction data set TDS. The M1 device is arranged to locally (temporarily) store the transaction data set TDS.

In the simplest case, all coin data sets Cᵢ are automatically connected to a coin data set in the device M1 after obtaining (see connecting-processing or connecting-step). That is, as soon as a new electronic coin data set is received, a connecting or switching command is sent to the coin register 4. The device M1 can also prepare electronic coin data sets in algorithmically defined denominations and hold them in the data memory 10, 10′ so that a payment process is possible even without a data connection to the coin register 4 and/or monitoring register 6.

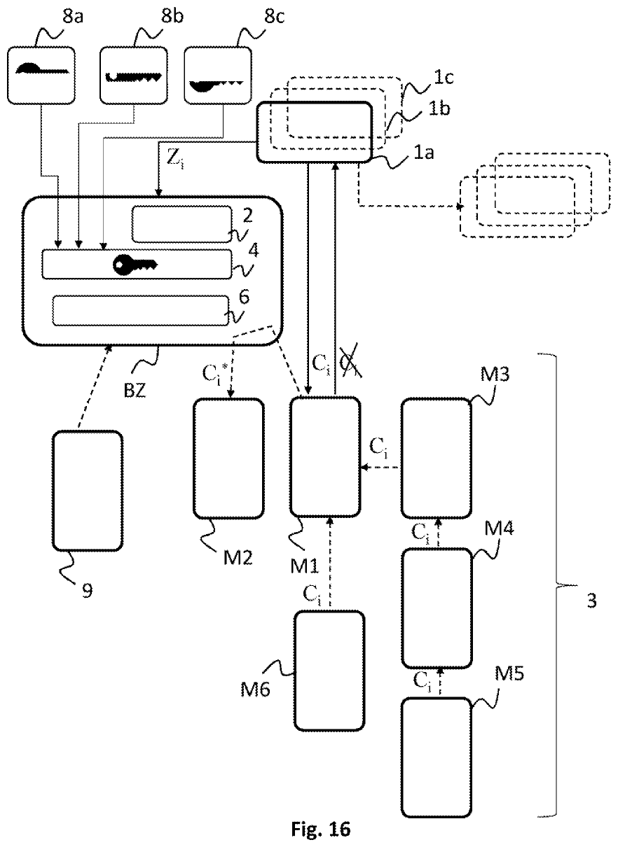

FIG. 16 shows a payment system for better understanding. The overall system according to the invention comprises an issuing instance (central bank) 1a. In addition, further issuing instances 1b, 1c can be provided, which for example issue electronic coin data sets in another currency. Furthermore, at least one payment system BZ is shown in which at least one coin register 2, one monitoring register 6 and one transaction register 4 of the payment system BZ are provided in order to carry out a registration of the coin data sets Cᵢ or Zᵢ and to check and record the modifications to the coin data set Cᵢ. The issuing instance 1a may also be provided as part of the payment system BZ. In addition, banking instance(s) may be located between the issuing instance 1a-c and the payment system BZ. For example, registers 2, 4, 6 are housed together in a server instance where they are logically separated from each other. Alternatively, the registers 2, 4, 6 are also spatially/physically separated from each other. The transaction register 4 can also be arranged as a unit external to the payment system BZ. In addition, a judicial/court authority 9 is shown which, in the event of suspected fraud, requests a judicial request for encrypting encrypted transaction data sets TDS from the payment system BZ (or directly from the transaction register). Remote instances 8a-c with corresponding partial keys are also shown to provide their partial keys to the transaction register 4 in case of a request to obtain a cryptographic key as a decryption key.

In addition, in FIG. 16, a plurality of subscribers, shown as terminals Mx (with respective SEx), is provided. The terminals M1 to M6 can directly exchange coin data sets Cᵢ in the direct transaction layer 3. For example, terminal M5 transmits a coin data set to terminal M4. For example, terminal M4 transmits the coin data set to terminal M3. For example, terminal M6 transmits a coin data set to terminal M1. In each sending terminal Mx or each receiving terminal Mx, the check value pᵢ₁ of the coin data set to be sent or received and, if applicable, the counter value pᵢ₂ are used to check whether the coin data set is displayed at the payment system and/or whether the coin data set is to be returned at the issuing instance 1a. For example, the payment system BZ uses the check value pᵢ₁ or a counter value pᵢ₂ derived from the check value pᵢ₁ to check for each coin data set C whether the coin data set C is to be returned or not. In addition, a check value is provided in each terminal Mx to monitor a number of transaction data sets TDS that have not yet been transmitted despite coin data sets that have been transmitted.

In FIG. 17, a flow chart of a method is shown, by which, for example, compliance with a limit value for monetary amounts per unit of time is made possible.

In the upper part of the figure, the payment system BZ consisting of three terminals M1, M2, M3 is shown. In the lower part of the figure three data structures 910, 920, 930 of the respective registers 2, 4, 6 are shown. The valid masked coin data sets Zᵢ are stored in the data structure 910 of the coin register 2. The data structure 920 of the monitoring register 6 comprises the assignment of pseudonymously sent masked coin data sets to the pseudonym and of can be considered as monitoring register 6 still to be checked pseudonymously sent coin data sets. Based on the data in data structure 920, monitoring register 6 can decide whether a range proof is requested for a pseudonym. Encrypted transaction data sets TDS are stored in the transaction register data structure 930.

The following transactions were performed:

1. The first terminal M1 has split a coin 901. the coin register 2 therefore knows that the coin C is a result of this splitting and stores the masked coin data set Zᵢ in the data structure 910. the first terminal M1 could send the split to the monitoring register 6 anonymously or pseudonymously. In the illustration, it is assumed that terminals M1 and M3 send their masked coin data sets to monitoring register 6 anonymously.

2. The first terminal M1 sends the coin C₁ directly to the second terminal M2 in a direct transmission step 902. Neither the coin register 2 nor the monitoring register 6 obtain any information about this. The first terminal M1 generates a transaction data set TDS₉₀₂ relating to the transmission step 902, encrypts this transaction data set TDS₉₀₂ and sends it to the transaction register 4. The encrypted transaction data set TDS₉₀₂ contains an identifier of the first terminal M1, an identifier of the second terminal M2 and the monetary amount νᵢ of the coin C₁.

3. The second terminal M2 converts (switches) 903 the coin C₁ to the coin C₂. The new masked coin data set Z₂ is stored in the data structure 910 of the coin register 2 and the old masked coin data set Z₁ is deleted (or marked as invalid). The second terminal M2 sends its masked (or at least the represented) coin data sets pseudonymised to the monitoring register 6. Thus, the monitoring register 6 also obtains the information that the second terminal M2 with the pseudonym P_{M2} has received the coin C₁ (and now possesses coin C₂) and accordingly stores in the data structure 920 of the monitoring register 6 the masked coin data set Z₂ (and/or the masked coin data set Z₁) for P_{M2}. In addition, the monitoring register 6 will skip at least one verification step, such as a range proof for the coin data set Z₂ or a sum range proof for the terminal M2.

4. The second terminal M2 sends the coin C₂ to the third terminal M3 in another direct transmission step 905. Neither the coin register 2 nor the monitoring register 6 obtains any information about this. The second terminal M2 generates a transaction data set TDS₉₀₅ relating to the transmission step 905, encrypting this transaction data set TDS₉₀₅ and sending it to the transaction register 4. The encrypted transaction data set TDS₉₀₅ includes an identifier of the second terminal M2, an identifier of the third terminal M3, and the monetary amount ν₂ of the coin C₂.

5. In step 904, the third terminal M3 connects the received coin C₂ to the connected coin C₃ and sends this information with anonymous masked coin data sets to the coin register 2. The coin register 2 executes all verification steps, i.e. in particular all range proofs for the involved masked coin data sets Z₂ . . . and Z₃ or also a sum range proof for the third terminal M3. The coin register 2 only then deletes the masked coin data set Z₂ (as well as the other coin data sets of the operation) from the data structure 910 and stores the new masked coin data set Z₃ as a valid masked coin data set.

6. The third terminal M3 sends the coin C₃ directly to the second terminal M2 in step 906. Neither the coin register 2 nor the monitoring register 6 obtains any information about this. The third terminal M3 generates a transaction data set TDS₉₀₆ relating to the transmitting step 906, encrypting this transaction data set TDS₉₀₆ and sending it to the transaction register 4. The encrypted transaction data set TDS₉₀₆ includes an identifier of the third terminal M3, an identifier of the second terminal M2 and the monetary amount ν₃ of the coin C₃.

7. In a further step 903, the second terminal M2 converts (switches) the coin C₃ to the coin C₄ and sends a masked coin data set Z₄ together with its pseudonym to the monitoring register 6. The monitoring register 6 obtains the information and performs the necessary checks. Using the data structure 920, the monitoring register 6 determines whether one or more checks should now be made up for the pseudonym of the terminal M2. If the criterion for a catching up, such as time lapse or number of transactions for a pseudonym, is not yet fulfilled, only the further masked coin data set Z₄ for the pseudonym is noted in the data structure 920 of the monitoring register 6. The coin register 2 stores the masked coin data set Z₄ in the data structure 910 and deletes the masked coin data set Z₃ there. If, on the other hand, a criterion for catching up on the verification step is fulfilled, it first executes the catching up of the verification step (or its equivalent).

In the concrete example, the monitoring register 6 has the information that the second terminal M2 had the coin C₂ (see step 3). Since the sum of the monetary amounts of coin C₂ and coin C₄ could exceed a coin threshold, monitoring register 6 requests a sum range proof (or sum range confirmation) from the second terminal M2. The sum range proof shows that the sum of the monetary amounts of coins C₂ and C₄ does not yet exceed the—for example daily—limit of transactions for the second terminal M2. The monitoring register 6 can also monitor a limit for a time-independent number of transactions (range proof after Mar. 5, 2010/ . . . transactions). As an alternative or in addition to a cumulative check of several coin data sets, the monitoring register 6 can make up a range check for the individual coin data sets associated with the pseudonym P_{M2} in the data structure 920 of the monitoring register 6 (Is the monetary amount of each coin data set Z₂ and Z₄ less than X?). If checks have been successfully made up, the corresponding records in the data structure 920 of the monitoring register 6 can also be deleted.

The transaction register 4 has the transaction data sets TDS₉₀₂, TDS₉₀₅ and TDS₉₀₆ in encrypted form in its data structure 930.

In an embodiment not shown in FIG. 17, the transaction data sets are decrypted and pseudonymised. During pseudonymisation, the identifiers of the terminals M1 to M3 are replaced by the pseudonyms P and the respective amount is converted into amount categories. The pseudonymised unencrypted transaction data sets are sent to the monitoring register 6. As the sum of the monetary amounts of coin C₂ and coin C₄ could exceed a coin threshold, the monitoring register 6 requests a sum range proof (or sum range confirmation) from the second terminal M2. Alternatively, the amount categories in the pseudonymised transaction data sets TDS* are meaningful such that the monitoring register 6 can perform the sum range proof itself using the pseudonymised transaction data sets TDS*. As an alternative or in addition to a sum check, the monitoring register 6 can now also make up for a range check for the individual coin data sets using the pseudonymised transaction data sets TDS*.

FIG. 18 shows another example of an operation in a payment system BZ with masked coin data sets. A first terminal M1 sends anonymous masked coin data sets to the coin register 2 in steps 151. A second terminal M2, on the other hand, sends pseudonymised masked coin data sets to the monitoring register 6 in steps 161.

The coin register 2 responds to each of the anonymous sending steps 151 of the first terminal M1 (in its anonymous mode) with a (catch-up) check for the masked coin data set or the first terminal M1. The additional necessary checks, if any, are not shown in FIG. 13. In step 152, the coin register 2 requests a range proof for each masked coin data set that the monetary amount of the masked coin data set from step 151 is below a maximum value (or a corresponding range confirmation). Alternatively or additionally, at step 152, the coin register 2 requests a sum range proof (or confirmation) from the first terminal M1. The requested proof (or proofs) shall be generated by the first terminal M1 in step 153 and sent in step 154 in order for the (at least one) masked coin data set of step 151 to be treated as valid in the coin register 2.

The monitoring register 6 responds to the first transmitting step 161 of the second terminal M2 (in its pseudonymous mode) by skipping a (catch-up) check for the masked coin data set or the second terminal M2. The pseudonymously sent masked coin data set is registered as valid. For example, necessary checks not shown here take place, but do not require further communication with the second terminal M2. As previously described in other examples, the monitoring register 6 stores a mapping between the pseudonym and the masked coin data set(s) sent pseudonymously. In the example shown, the monitoring register 6 also responds in an analogous manner to a second (or further) transmission steps 161 of the second terminal M2. In each case, it checks for the pseudonym whether a catch-up criterion is fulfilled.

Only in the third step 161 shown does the monitoring register 6 determine that a check is to be made up for the pseudonym. It sends a request 162 to the second terminal M2 to create, for example, range proofs for multiple coin data sets or a sum range proof. In step 163, the second terminal M2 creates a plurality of range proofs, a sum range proof or a sum range confirmation and sends them to the monitoring register 6 in step 164. In step 163, for example, a plurality of coin data sets of the second terminal M2 are selected and summed over their monetary amounts. These coin data sets concern either only pseudonymised coin data sets or anonymous and pseudonymised coin data sets (in this case, the masked coin data sets that have already been sent are used and the sum is formed from the monetary amounts of the corresponding unmasked coin data sets). The selection can be made on the basis of criteria that are either known to the system or transmitted from the monitoring register 6 in step 162. The criteria are, for example, a period of time, in particular a predefined period of time in which a sum of all monetary amounts should/must not exceed a certain range, for example a monetary amount x euros per time unit y. The criterion can alternatively or additionally be a list in the first terminal M1 or the monitoring register 6. This makes a certain randomisation of the range possible, with which the system is further secured. The sum formed is then matched against the range (and using the criterion if applicable). In step 164, the requested sum range confirmation (or requested sum range proof) is transmitted from the second terminal M2 to the monitoring register 6.

Since a payment transaction (transmitting coin data sets) of a large monetary amount can also be split into several payment transactions of smaller monetary amounts, each of which could be below a range, the method defines the range (=limit), if necessary, on a terminal-specific and time period-dependent basis. The range usually concerns a sum of all transactions within a determining time unit that are received and/or sent by a terminal. A mechanism is therefore provided for determining what the sum of all monetary amounts sent or received by a terminal is within a determined unit of time.

Within the scope of the invention, all elements described and/or drawn and/or claimed may be combined with each other as desired.

1.-45. (canceled)

46. A payment system for payment with electronic coin data sets comprising:
a coin register arranged to register the electronic coin data sets;
participant units arranged for executing payment transactions by transmitting said electronic coin data sets and for sending status and/or registration requests concerning said electronic coin data sets; and
a monitoring register arranged for evaluating monitoring data sets concerning said payment transactions, wherein:
a monitoring data set in the monitoring register is formed from at least one register data set and at least one transaction data set,
wherein the at least one register data set is provided by the coin register and wherein the at least one transaction data set is provided by a transaction data set source and/or the coin register.

47. The payment system according to claim 46, wherein the coin register in a first mode provides only the at least one register data set and in a second mode provides the at least one register data set and the at least one transaction data set.

48. The payment system according to claim 46, wherein the coin register is further arranged to register modified electronic coin data sets and wherein the status and/or register requests of the participant units further concern the modified electronic coin data sets.

49. The payment system according to claim 46, wherein the transaction data set source is a participant unit or a transaction register.

50. The payment system according to claim 46, wherein each participant unit is arranged to provide a transaction data set relating to transmitting an electronic coin data set to another participant unit or relating to an electronic coin data set to be registered at the coin register.

51. The payment system according to claim 46, wherein each electronic coin data set comprises at least a monetary amount as a data element and an obfuscation amount as a data element, the obfuscation amount being secret to the coin register and the monitoring register.

52. The payment system according to claim 51, wherein each electronic coin data set comprises a first check value as a data element which is incremented when transmitting the electronic coin data set directly between two participant units.

53. The payment system according to claim 51, wherein each electronic coin data set comprises a coin identifier as a data element, the coin identifier being used to identify a register data set relating to the electronic coin data set and a transaction data set relating to the electronic coin data set.

54. The payment system according to claim 46, wherein a register data set comprises one or more of the following data elements:
a signature of the electronic coin data set;
a range proof of an electronic coin data set;
a check value of the electronic coin data set;
a check value relating to the electronic coin data set;
a participant identifier of a participant unit transmitting the register data set;
a masked electronic coin data set; and/or
a monetary amount of the electronic coin data set.

55. The payment system according to claim 46, wherein in the coin register a register data set concerning the electronic coin data set is replaced by a registering data set to be registered concerning the electronic coin data set or the modified electronic coin data set.

56. The payment system according to claim 47, wherein the mode in the coin register is set in dependence on a performed authentication of a participant unit at the coin register,
wherein the second mode is set in the coin register only when a participant unit successfully authenticates itself at the coin register.

57. The payment system according to claim 54, wherein a status and registration request concerning an electronic coin data set or a modified electronic coin data set from an anonymous participant unit to the coin register is only processed when a transaction data set concerning the electronic coin data set or the modified electronic coin data set is provided evaluable in the monitoring register.

58. The payment system according to claim 46, wherein the payment system comprises a person register,
wherein in the person register natural persons are assigned to respective participant identifiers of participant units of the payment system and/or to respective pseudonyms of participant units.

59. The payment system according to claim 46, wherein a register data set has one of different anonymity levels and wherein the coin register is arranged to set the anonymity level of the register data set before providing it to the monitoring register.

60. The payment system according to claim 46, wherein a transaction data set has one of different anonymity levels,
wherein the transaction data set source is arranged to set the anonymity level of the transaction data set prior to providing it to the monitoring register.

61. The payment system according to claim 59, wherein for setting the anonymity level a participant identifier of a participant unit is pseudonymised or anonymised.

62. The payment system according to claim 59, wherein for setting the anonymity level a monetary amount of an electronic coin data set is pseudonymised or anonymised.

63. The payment system according to claim 59, wherein in a register data set the anonymity level of a monetary amount of an electronic coin data set is different from the anonymity level of a participant identifier of a participant unit.

64. The payment system according to claim 59, wherein in a transaction data set the anonymity level of a monetary amount of an electronic coin data set is different from the anonymity level of a participant identifier of a participant unit.

65. The payment system according to claim 59, wherein the anonymity level of a monetary amount of an electronic coin data set in a transaction data set is different from the anonymity level of a monetary amount of an electronic coin data set in a register data set.
